(19) United States
(12) Patent Application Publication
(10) Pub. No.: US 2023/0295814 A1
(43) Pub. Date: Sep. 21, 2023

(54) NANOSTRUCTURED ELECTRODES AND METHODS OF MAKING AND USE THEREOF

(71) Applicant: Ohio State Innovation Foundation, Columbus, OH (US)

(72) Inventors: Jonathan Kadowaki, Columbus, OH (US); Travis Jones, Columbus, OH (US); Anindita Sengupta, Columbus, OH (US); Venkat Gopalan, Columbus, OH (US); Vishwanath Subramaniam, Columbus, OH (US)

(21) Appl. No.: 18/018,707

(22) PCT Filed: Jul. 30, 2021
(86) PCT No.: PCT/US21/43962

§ 371 Date: Jan. 30, 2023

Related U.S. Application Data
(60) Provisional application No. 63/059,051, filed on Jul. 30, 2020.

(51) Int. Cl. C25B 9/50; C07H 21/02; C25B 3/25; C25B 3/21; C25B 11/053; C25B 11/061; C25B 11/091; C25D 9/08

(52) U.S. Cl. CPC C25B 9/50; C07H 21/02; C25B 3/25; C25B 3/21; C25B 11/053; C25B 11/061; C25B 11/091; C25D 9/08

(57) ABSTRACT

Disclosed herein are nanostructured electrodes and methods of making and use thereof. The nanostructured precursor electrodes comprising a copper substrate, a nanostructured copper oxide layer disposed on the copper substrate and a nickel layer disposed on the nanostructured copper oxide layer.

### CROSS-REFERENCE TO RELATED APPLICATIONS

This application claims the benefit of priority to U.S. Provisional Application No. 63/059,051 filed Jul. 30, 2020, which is hereby incorporated herein by reference in its entirety.

### BACKGROUND

The nicotinamide adenine dinucleotide redox couple, NAD⁺/NADH, and their phosphorylated counterparts, NADP⁺/NADPH, are ubiquitous cofactors in metabolic processes in all organisms. NAD⁺ and NADH are involved in redox reactions in glycolysis, fermentation, and the tricarboxylic acid (TCA) cycle in animal cells. The phosphorylated forms, NADP⁺ and NADPH, play a key part in photosystem I and the subsequent Calvin cycle for energy production in plant cells. NADP⁺/NADPH is also of great relevance to animal cells in fatty acid biosynthesis, pentose phosphate pathway, and as an antioxidant.

A critical step in most metabolic processes is the regeneration of these NAD(P)H cofactors. Metabolism is often a target of cancer therapies, and interconversion between NAD(P)+ and NAD(P)H is critical in these approaches. In addition to potential applications in artificial photosynthesis, these cofactors are critical in enzymatic biochemical reactions used in the pharmaceutical and chemical industries. For example, the commercial conversion of biomass to biofuels is primarily hampered by the cost of the cofactors (bulk cost in 2011 USD of $3000/mole ($4.52/g) for NADH and $215,000/mole ($288.82/g) for NADPH) and the challenge in recycling or regenerating them from their oxidized forms. Inexpensive production of butanol from lignocellulosic biomass via biofermentation, for instance, would be an economically appealing additive to gasoline were it not for the production cost. Direct regeneration of NADH/NADPH using photoelectrochemistry or photochemistry is also of interest for the development of next-generation biological solar converters, energy-storage devices, and artificial photosynthesis.

Methods for regeneration of NAD(P)H comprise enzymatic, chemical, electrochemical, and biological approaches. However, challenges in the artificial regeneration of NADH/NADPH include (1) the formation of inactive forms, which affect the purity of the product as determined by its utility, (2) need for high overpotentials, which can also lead to other non-useful products, and (3) requirement of expensive catalysts. Consequently, the development of effective cofactor regeneration systems is needed to reduce costs and increase the efficiency of the enzyme turnover in certain biocatalytic processes so that they can be conducted on an industrial scale. The compositions and methods discussed herein address these and other needs.

### SUMMARY

In accordance with the purposes of the disclosed compositions and methods as embodied and broadly described herein, the disclosed subject matter relates to nanostructured electrodes and methods of making and use thereof.

Additional advantages of the disclosed compositions and methods will be set forth in part in the description which follows, and in part will be obvious from the description. The advantages of the disclosed compositions and methods will be realized and attained by means of the elements and combinations particularly pointed out in the appended claims. It is to be understood that both the foregoing general description and the following detailed description are exemplary and explanatory only and are not restrictive of the disclosed systems and methods, as claimed.

The details of one or more embodiments of the invention are set forth in the accompanying drawings and the description below. Other features, objects, and advantages of the invention will be apparent from the description and drawings, and from the claims.

### BRIEF DESCRIPTION OF THE FIGURES

The accompanying figures, which are incorporated in and constitute a part of this specification, illustrate several aspects of the disclosure, and together with the description, serve to explain the principles of the disclosure.

FIG. 1. Qualitative relationship between relative NADPH purity and electrode potential for a given electrode material.

FIG. 2a and FIG. 2b. Energy diagram of p-type semiconductor and electrolyte separated in vacuum a) and semiconductor-electrolyte interface at equilibrium, showing electron-hole pair separation in space charge layer under illumination b).

FIG. 3a and FIG. 3b. a) Measured values for the Conduction Band minimum and Valence Band maximum for Cu₂O and the formal redox potentials for NADP⁺/NADPH and Cu₂O/Cu at pH 8 (Kumar B et al. Annual Review of Physical Chemistry, 2012, 63(1), 541-569; VanLinden M R et al. Biochem. 2015, 37(1), 9-13) and b) photoelectrochemical reaction mechanism showing electron hole pair separation by the built-in electric field. Equilibrium potentials are estimated via the Nernst equation.

FIG. 4. Structural representation of the enzymatic reaction (Plapp B V et al. Yeast alcohol dehydrogenase I, Saccharomyces cerevisiae fermentative enzyme. Protein Data Bank, Rutgers University. 2014).

FIG. 5. Sample absorbance spectra for 1500 μM NADP⁺ and 110 μM NADPH.

FIG. 6. Absorbance-Concentration behavior of NADPH in both phosphate buffers. Error bars represent standard deviation of 30 sequential measurements on the same sample.

FIG. 7. The effect of [ADH] on the calculated NADPH purity.

FIG. 8. The effect of sample dilution on the calculated NADPH purity for an experimental aliquot.

FIG. 9. Absorbance-Concentration behavior of NADP⁺ in potassium phosphate buffer. Error bars are the standard deviation of 30 sequential measurements on the same sample.

FIG. 10. Enzymatic Assay for 1/6 diluted sample with correction factor incorporated.

FIG. 11. Corrected enzymatic assay results from FIG. 7.

FIG. 12. Time study results.

FIG. 13. Initial current trace for curve (b) in FIG. 12.

FIG. 14a-FIG. 14f Current traces from the time-study data in FIG. 12. Letters correspond to those in FIG. 12. Noise is introduced when the cell is aliquoted.

FIG. 15a and FIG. 15b. Photocurrent sweeps performed with a Ni/Cu₂O/Cu electrode. The current is normalized to solution-immersed geometric electrode area. The tail on the right side of the top figure is due to initial capacitive charging.

FIG. 16. Summary of potential photo-assisted surface modification processes and their origin. The hole interactions symbolize electron removal i.e. one can write electrons as a species on the opposite side of the reaction.

FIG. 17. Inversion layer and breakdown at a p-type semiconductor-electrolyte junction (vertical red line, left panel) The bulk Fermi level (or quasi-hole Fermi level) is denoted as Ef,p. Electrons accumulating in the conduction band are indicated by yellow circles (left panel). The right panel shows the relationship to equilibrium potentials. It is assumed that no interface states are forming.

FIG. 18. Tunneling of valence band electrons into the conduction band at the electrolyte interface (red line).

FIG. 19. Energy band diagrams showing the metal semiconductor interface (red line) at thermal equilibrium (left) and under a negative bias sufficient for tunneling (right).

FIG. 20. Absorbance levels showing relative yields following three-hour bulk electrolysis at −0.75 V Ag/AgCl for various electrodes. Oxide samples were illuminated for the entire duration of the experiment.

FIG. 21a-FIG. 21i. EDS spectra of untreated (not reduced) Cu₂O/Cu electrode (FIG. 21a-FIG. 21c), untreated Ni/Cu₂O/Cu (FIG. 21d-FIG. 21f) and treated Ni/Cu₂O/Cu (FIG. 21g-FIG. 21i) with 10 kV beam.

FIG. 22. SEM images of the substrate Cu (top left), electrodeposited Cu₂O/Cu (top right), untreated Ni/Cu₂O/Cu (bottom left) and photoelectrochemically treated Ni/Cu₂O/Cu (bottom right).

FIG. 23. Structural depiction of how Scheme 5 could take place.

FIG. 24. 150 μM NADPH standard assay test; Q=0.9046. The blue line represents the initial absorbance level prior to enzyme addition. The orange line represents the absorbance during the enzymatic reaction.

FIG. 25. 100 μM NADPH standard assay test.

FIG. 26a-FIG. 26b. The effect of cuvette mixing on the enzymatic assay. FIG. 26a shows results without mixing and FIG. 26b shows results with mixing.

FIG. 27. Representation of mesh grid. D is the wire diameter, 0 is the opening size, L is the measured length and W is the measured width.

FIG. 28a-FIG. 28c: SEM of the cathode surface. (FIG. 28a) Bare Cu mesh substrate, (FIG. 28b) Electrodeposited copper oxide on Cu mesh, and (FIG. 28c) Ni nanolayer as sputter-deposited on copper oxide-Cu substrate. Scale bar=1 μm.

FIG. 29a-FIG. 29b: (FIG. 29a) XPS spectra of Ni—Cu₂O—Cu electrode after each step of the fabrication process and after photoelectrochemical surface modification over the range of energies corresponding to copper and its oxides; (FIG. 29b) XPS spectra of Ni—Cu₂O—Cu electrode after each step of the fabrication process and after photoelectrochemical surface modification over the range of energies corresponding to nickel. The peak between 960 eV and 965 eV and structure between 940 eV and 950 eV in the figure on the left is indicative of CuO whereas the other peaks are indicative of Cu₂O (Biesinger M C et al. Applied Surface Science 2010, 257, 887-898). Note that after photoelectrochemical surface modification, only the peaks of Cu (0) are evident (middle curve in red on left figure) and the peaks corresponding to both CuO and Cu₂O are absent.

FIG. 30a-FIG. 30d: Photoelectrochemical modification of the Ni-copper oxide-Cu surface. (FIG. 30a) Schematic of custom quartz H-cell with glass frit separator used for regeneration of NADPH from NADP⁺, (FIG. 30b) Cathodic current versus time in the presence of 532 nm laser irradiation in a 0.5 M pH 8 sodium phosphate buffer with the electrode at −0.75 V with respect to a Ag/AgCl (3M NaCl) reference electrode during the earlier portion of the photoelectrochemical surface modification process, (FIG. 30c) SEM of Ni-copper oxide-Cu surface before photoelectrochemical surface modification (same as FIG. 28c), (FIG. 30d) SEM of Ni/copper-oxide/Cu surface after photoelectrochemical surface modification. Scale bar=1 μm.

FIG. 31: X-ray Diffraction (XRD) spectra of electrochemically deposited copper oxide on the Cu mesh (top panel), XRD spectra of the nanostructured heterolayer electrode before photoelectrochemical surface modification (middle panel), and XRD spectra of the nanostructured heterolayer cathode after photoelectrochemical surface modification (bottom panel). Note the disappearance of the oxide peaks, consistent with EDS and XPS results. The (111), (200), and (220) peaks of Cu at 2q=43.44°, 2q=50.5°, and 2q=74.2° respectively, are clearly evident in all three spectra (Sen P et al. Proc. Indian Acad. of Sci. (Chem. Sci.) 2003, 115(5 & 6), 499-508).

FIG. 32: Band energy diagram. Band energy diagram for Cu₂O indicating redox potentials for NADP⁺ and Cu₂O reduction at pH=8 relative to Ag/AgCl (3M NaCl). The nickel layer, necessary for providing adsorbed hydrogen is not shown.

FIG. 33a-FIG. 33b: Cofactor regeneration with different cathode materials and conditions of illumination. (FIG. 33a) Absorption at 340 nm for NADPH (product) versus time for electrochemical reduction in the presence of illumination for the entire duration of the experiment with the nanostructured heterolayer electrode (black curve), illumination of the nanostructured heterolayer cathode first for 60 min, followed by electrochemical reduction (red), electrochemical reduction with a non-modified nanostructured heterolayer electrode in the absence of illumination (green), electrochemical reduction with the Cu mesh alone and in the absence of illumination (dark blue), and electrochemical reduction with Ni sputtered on the Cu mesh alone and in the absence of illumination (magenta). The time point t=0 represents the instant when electrochemical reduction is initiated. The error bars are indicated at the location of the data markers. Error bars represent the standard deviation of 30 sequential absorbance measurements on the same aliquot. (FIG. 33b) Current trace versus time for the nanostructured heterolayer (as fabricated and not surface modified) electrode in the presence of both 532 nm (10 mW) laser illumination and electrochemical reduction.

FIG. 34a-FIG. 34c: High-resolution FT-ICR MALDI spectra of products of NADPH electrochemically regenerated with photoelectrochemically surface modified Ni—Cu₂O—Cu cathode. (FIG. 34a) mass-to-charge (m/z) ratios corresponding to deprotonated (top) and protonated (bottom) NADP⁺ in the product. (FIG. 34b) m/z ratios corresponding to deprotonated (top) and protonated (bottom) NADPH in the product. (FIG. 34c) m/z ratios corresponding to the inactive and undesirable dimer (NADP)₂ in the product. For each molecule, the top plot represents spectra obtained in negative ion mode and the bottom plot represents spectra obtained in positive ion mode. Presence of singly ionized NADP⁺ and NADPH is indicated in both positive and negative ion modes. No strong peaks were observed for singly ionized dimer in either positive or negative ion mode.

FIG. 35: Possible products from regeneration of NADPH (Wang X et al. Chem, 2017, 2, 621-654). A depicts a general biocatalyzed reaction showing NADPH being oxidized as a product is formed; B shows the desirable pathway for cofactor regeneration; C is the pathway for formation of the inactive dimer; D is the pathway for forming the inactive isomer.

FIG. 36: Schematic of two-compartment cell with an agar bridge used to electrodeposit copper oxide on a Cu mesh electrode. Ten-mL beakers were used for both working and counter-electrode compartments. Cupric lactate solution was used in the working electrode compartment for electrodeposition (right) and potassium phosphate buffer (pH 7) was used in the counter-electrode compartment (left).

FIG. 37: Cross-section FIB-SEM image of Ni—Cu₂O—Cu electrode, after Ni sputter coat and before photoelectrochemical surface modification. The copper oxide layer can be seen to be approximately 4.26 μm thick, with the Ni layer not discernible and likely present under the Pt cap used for SEM imaging. The vertical scale bar is different from the horizontal scale bar because of the tilt of the image. The SEM is capable of accounting for the tilt in measuring distances.

FIG. 38a-FIG. 38d: Cross-section EDS maps of elemental Ni (FIG. 38b), Cu (FIG. 38c), and O (FIG. 38d) on the Ni/Copper Oxide/Cu electrode (FIG. 38a) before photoelectrochemical surface modification. The sample shown here is the same as that in FIG. 37. Scale bars are all 1 Pixel intensity is indicative of greater counts for that element (i.e. darker denotes absence while lighter denotes presence).

FIG. 39a-FIG. 39f: EDS spectra of as-deposited copper oxide (FIG. 39a-FIG. 39c) and the Ni—Cu₂O—Cu electrode (FIG. 39d-FIG. 39f) before photoelectrochemical surface modification.

FIG. 40: HAADF (High-Angle Annular Dark Field) STEM Image, of a Ni—Cu₂O—Cu foil sample prepared exactly as the Ni—Cu₂O—Cu mesh electrode, without any photoelectrochemical surface modification. The thickness of the Cu₂O layer is clearly visible though the Ni nanolayer is not at this scale, despite being present. The top visible layer is the Pt cap used for sample preparation.

FIG. 41: Cross section EDS maps of elemental Ni (top panel), Cu (middle panel), and O (bottom panel) in the Ni—Cu₂O—Cu foil (prepared exactly as the Ni—Cu₂O—Cu mesh electrode) without any photoelectrochemical surface modification, clearly showing the elemental composition and presence of the Ni nanolayer on top, mix of Cu and O in the Cu₂O layer, and Cu in the copper substrate. This figure also shows the approximate thicknesses of the nanostructured heterolayers.

FIG. 42: XPS spectra of Ni—Cu₂O—Cu mesh electrode before photoelectrochemical surface modification. The peak between 960 eV and 965 eV and structure between 940 eV and 950 eV are indicative of the presence of CuO whereas the other peaks are indicative of Cu₂O (Biesinger M C et al. Applied Surface Science 2010, 257, 887-898).

FIG. 43: Steady state cathodic current versus time at later stages (i.e. after the time range shown in FIG. 30b) of the photoelectrochemical surface modification process, showing that the photoelectrochemical surface modification is complete within ˜1 h. The ordered spikes reflect the disturbances in the current measurements that occur at each instance when 350 μL aliquots were withdrawn at regular intervals.

FIG. 44a-FIG. 44f: EDS spectra of the Ni—Cu₂O—Cu electrode before (FIG. 44a-FIG. 44c) and after (FIG. 44d-FIG. 44f) photoelectrochemical surface modification. Figures in the middle and right columns are expanded views of specific ranges of energies in the figures in the left column.

FIG. 45: Cross-section FIB-SEM image of the Ni—Cu₂O—Cu electrode after photoelectrochemical surface modification.

FIG. 46: Cross-section FIB-SEM image of Ni—Cu₂O—Cu electrode after photoelectrochemical surface modification. Point-wise EDS measurement locations are labeled in red and the corresponding elemental O and Ni atomic percentages are given in Table 5.

FIG. 47a-FIG. 47d: Cross-section EDS maps of elemental Ni (top right, FIG. 47b), Cu (bottom left, FIG. 47c), and O (bottom right, FIG. 47d) on the Ni—Cu₂O—Cu electrode after photoelectrochemical surface modification (FIG. 47a), for the sample shown in FIG. 45. Scale bars are all 1 μm. Pixel intensity is indicative of greater counts for that element (i.e. darker denotes absence while lighter denotes presence).

FIG. 48: Elemental composition of Ni (blue, upper trace) and O (red, lower trace) obtained by EDS in the cross section of the surface layers of the Ni—Cu₂O—Cu mesh electrode after photoelectrochemical surface modification showing the oxide layer being depleted of oxygen. The locations correspond to those shown in FIG. 46. An increasing height location index corresponds to a higher physical height, i.e. closer to the top surface, in FIG. 46.

FIG. 49: An illustrative example of an absorption spectrum used to determine the progress of cofactor regeneration using the LbADH-based selective enzymatic assay on samples aliquoted from the cathode side of the apparatus (FIG. 30a).

FIG. 50a: The LbADH enzyme assay applied to a stock (pure, active) NADPH solution;

FIG. 50b: LbADH enzyme assay applied to electrochemically regenerated NADPH using an Ni—Cu₂O—Cu electrode.

FIG. 51: Standard NADPH absorbance-concentration calibration in sodium phosphate buffer solution (pH 8). Only points denoted with circles were fit to yield the calibration equation shown in the box.

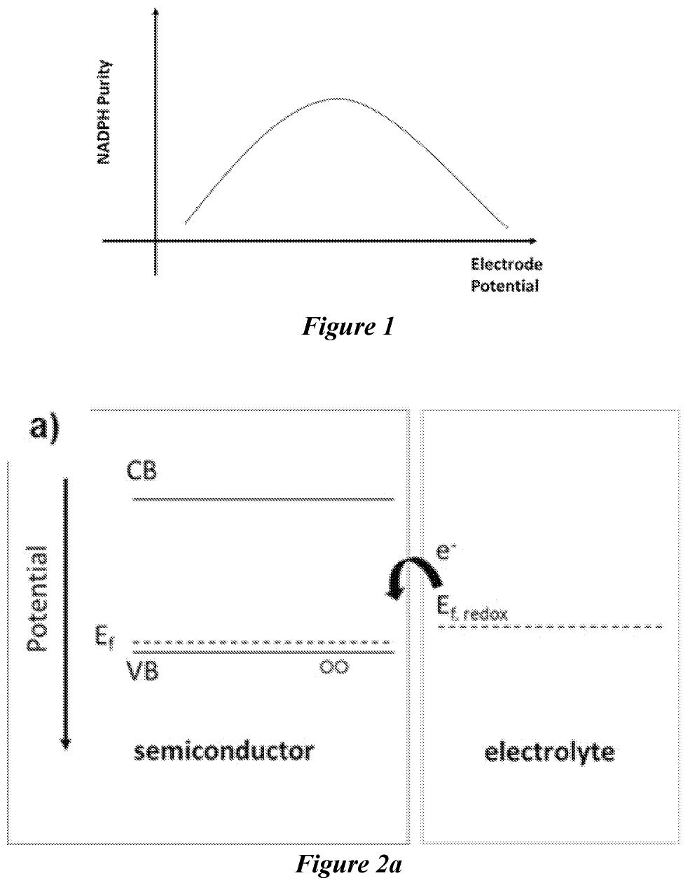

### DETAILED DESCRIPTION

The devices, methods, and systems described herein may be understood more readily by reference to the following detailed description of specific aspects of the disclosed subject matter and the Examples included therein.

Before the present devices, methods, and systems are disclosed and described, it is to be understood that the aspects described below are not limited to specific synthetic methods or specific reagents, as such may, of course, vary. It is also to be understood that the terminology used herein is for the purpose of describing particular aspects only and is not intended to be limiting.

Also, throughout this specification, various publications are referenced. The disclosures of these publications in their entireties are hereby incorporated by reference into this application in order to more fully describe the state of the art to which the disclosed matter pertains. The references disclosed are also individually and specifically incorporated by reference herein for the material contained in them that is discussed in the sentence in which the reference is relied upon.

In this specification and in the claims that follow, reference will be made to a number of terms, which shall be defined to have the following meanings.

Throughout the description and claims of this specification, the word “comprise” and other forms of the word, such as “comprising” and “comprises,” means including but not limited to, and is not intended to exclude, for example, other additives, components, integers, or steps.

As used in the description and the appended claims, the singular forms “a,” “an,” and “the” include plural referents unless the context clearly dictates otherwise. Thus, for example, reference to “a composition” includes mixtures of two or more such compositions, reference to “an agent” includes mixtures of two or more such agents, reference to “the component” includes mixtures of two or more such components, and the like.

“Optional” or “optionally” means that the subsequently described event or circumstance can or cannot occur, and that the description includes instances where the event or circumstance occurs and instances where it does not.

Ranges can be expressed herein as from “about” one particular value, and/or to “about” another particular value. By “about” is meant within 5% of the value, e.g., within 4, 3, 2, or 1% of the value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

“Exemplary” means “an example of” and is not intended to convey an indication of a preferred or ideal embodiment. “Such as” is not used in a restrictive sense, but for explanatory purposes.

It is understood that throughout this specification the identifiers “first” and “second” are used solely to aid in distinguishing the various components and steps of the disclosed subject matter. The identifiers “first” and “second” are not intended to imply any particular order, amount, preference, or importance to the components or steps modified by these terms.

Disclosed herein are nanostructured electrodes and methods of making and use thereof. For example, disclosed herein are nanostructured precursor electrodes comprising a copper substrate, a nanostructured copper oxide layer disposed on the copper substrate, and a nickel layer disposed on the nanostructured copper oxide layer. The term precursor electrode is used herein to refer to an electrode before it has undergone a photoelectrochemical modification process as disclosed herein. It is not meant to imply that the precursor electrode is not yet an electrode. Rather a precursor electrode is meant to refer to an electrode that has features or components that are available for photoelectrochemical reduction.

As used herein, “nanostructured” means any structure with one or more nanoscaled features. A nanoscale feature can be any feature with at least one dimension less than 1 micrometer (μm) in size (e.g., from 1 nm to less than 1 micrometer). For example, a nanoscaled feature can comprise a nanowire, nanotube, nanoparticle, nanopore, and the like, or combinations thereof. As such, the nanostructured copper oxide layer can comprise, for example, a nanowire, nanotube, nanoparticle, nanopore, or a combination thereof comprising copper oxide. In some examples, the nanostructured copper oxide layer can comprise copper oxide that is not nanoscaled but has been modified with a nanowire, nanotube, nanoparticle, nanopore, or a combination thereof. The nanostructured copper oxide layer can, for example, comprise Cu₂O, CuO, CuO₂, Cu₂O₃, or combination thereof.

The nanostructured copper oxide layer can, for example, have an average thickness of 50 nanometers (nm) or more (e.g., 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 350 nm or more, 400 nm or more, 450 nm or more, 500 nm or more, 600 nm or more, 700 nm or more, 800 nm or more, 900 nm or more, 1 micrometer (micron, μm) or more, 1.25 μm or more, 1.5 μm or more, 1.75 μm or more, 2 μm or more, 2.25 μm or more, 2.5 μm or more, 2.75 μm or more, 3 μm or more, 3.5 μm or more, 4 μm or more, 4.5 μm or more, 5 μm or more, 6 μm or more, 7 μm or more, 8 μm or more, 9 μm or more, 10 μm or more, 15 μm or more, 20 μm or more, 25 μm or more, 30 μm or more, 35 μm or more, 40 μm or more, 45 μm or more, 50 μm or more, 60 μm or more, 70 μm or more, 80 μm or more, 90 μm or more, 100 μm or more, 125 μm or more, 150 μm or more, 175 μm or more, 200 μm or more, 225 μm or more, 250 μm or more, 275 μm or more, 300 μm or more, 350 μm or more, 400 μm or more, 450 μm or more, 500 μm or more, 600 μm or more, 700 μm or more, 800 μm or more, or 900 μm or more).

In some examples, the nanostructured copper oxide layer can have an average thickness of 1000 μm or less (e.g., 900 μm or less, 800 μm or less, 700 μm or less, 600 μm or less, 500 μm or less, 450 μm or less, 400 μm or less, 350 μm or less, 300 μm or less, 275 μm or less, 250 μm or less, 225 μm or less, 200 μm or less, 175 μm or less, 150 μm or less, 125 μm or less, 100 μm or less, 90 μm or less, 80 μm or less, 70 μm or less, 60 μm or less, 50 μm or less, 45 μm or less, 40 μm or less, 35 μm or less, 30 μm or less, 25 μm or less, 20 μm or less, 15 μm or less, 10 μm or less, 9 μm or less, 8 μm or less, 7 μm or less, 6 μm or less, 5 μm or less, 4.5 μm or less, 4 μm or less, 3.5 μm or less, 3 μm or less, 2.75 μm or less, 2.5 μm or less, 2.25 μm or less, 2 μm or less, 1.75 μm or less, 1.5 μm or less, 1.25 μm or less, 1 μm or less, 900 nm or less, 800 nm or less, 700 nm or less, 600 nm or less, 500 nm or less, 450 nm or less, 400 nm or less, 350 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, or 60 nm or less).

The average thickness of the nanostructured copper oxide layer can range from any of the minimum values described above to any of the maximum values described above. For example, the nanostructured copper oxide layer can have an average thickness of from 50 nm to 1000 μm (e.g., from 50 nm to 1 μm, from 1 μm to 100 μm, from 100 μm to 1000 μm, from 500 nm to 1000 μm, from 500 nm to 500 μm, from 50 nm to 100 μm, from 500 nm to 100 μm, from 1 μm to 50 μm, or from 1 μm to 10 μm). As used herein, the average thickness of the nanostructured copper oxide layer is determined using electron microscopy.

The copper substrate can, for example, comprise a high surface area substrate. For example, the copper substrate can have an average surface area of 1 μm² or more (e.g., 5 μm² or more; 10 μm² or more; 50 μm² or more; 100 μm² or more; 500 μm² or more; 1,000 μm² or more; 5,000 μm² or more; 10,000 μm² or more; 50,000 μm² or more; 100,000 μm² or more; 500,000 μm² or more; 1 mm² or more; 5 mm² or more; 10 mm² or more; 50 mm² or more; 100 mm² or more; 500 mm² or more; 1,000 mm² or more; 5,000 mm² or more; 10,000 mm² or more; 50,000 mm² or more; 100,000 mm² or more; 500,000 mm² or more; 1 m² or more; 5 m² or more; 10 m² or more; or 50 m² or more). In some examples, the copper substrate can have an average surface area of 100 m² or less (e.g., 50 m² or less; 10 m² or less; 5 m² or less; 1 m² or less; 500,000 mm² or less; 100,000 mm² or less; 50,000 mm² or less; 10,000 mm² or less; 5,000 mm² or less; 1,000 mm² or less; 500 mm² or less; 100 mm² or less; 50 mm² or less; 10 mm² or less; 5 mm² or less; 1 mm² or less; 500,000 μm² or less; 100,000 μm² or less; 50,000 μm² or less; 10,000 μm² or less; 5,000 μm² or less; 1,000 μm² or less; 500 μm² or less; 100 μm² or less; 50 μm² or less; 10 μm² or less; or 5 μm² or less). The average surface area of the copper substrate can range from any of the minimum values described above to any of the maximum values described above. For example, the copper substrate can have an average surface area of from 1 μm² to 100 m² (e.g., from 1 μm² to 1,000 μm²; from 1,000 μm² to 1 mm²; from 1 mm² to 1,000 mm²; from 1,000 mm² to 1 m²; from 1 m² to 100 m²; from 1,000 μm² to 100 m²; or from 1 mm² to 100 m²).

In some examples, the copper substrate can comprise a porous copper substrate, such as a copper mesh. In some examples, the copper substrate can have an average thickness of from 1 micrometer (micron, μm) or more (e.g., 5 μm or more, 10 μm or more, 50 μm or more, 100 μm or more, 500 μm or more, 1 millimeter (mm) or more, 5 mm or more, 10 mm or more, 50 mm or more, 100 mm or more, or 500 mm or more). In some examples, the copper substrate can have an average thickness of 1 meter or less (e.g., 500 mm or less, 100 mm or less, 50 mm or less, 10 mm or less, 5 mm or less, 1 mm or less, 500 μm or less, 100 μm or less, 50 μm or less, 10 μm or less, or 5 μm or less). The average thickness of the copper substrate can range from any of the minimum values described above to any of the maximum values described above. For example, the copper substrate can have an average thickness of from 1 μm to 1 m (e.g., from 1 μm to 1 mm, from 1 mm to 1 m, from 1 μm to 10 μm, from 10 μm to 100 μm, from 100 μm to 1 mm, from 1 mm to 10 mm, from 10 mm to 100 mm, from 100 mm to 1 m, from 10 μm to 1 m, from 100 μm to 1 m, or from 1 μm to 500 mm).

The nickel layer can, for example, comprise metallic nickel. The nickel layer can, for example, have an average thickness of 1 nm or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 325 nm or more, 350 nm or more, 375 nm or more, 400 nm or more, 425 nm or more, 450 nm or more, or 475 nm or more).

In some examples, the nickel layer can have an average thickness of 500 nm or less (e.g., 475 nm or less, 450 nm or less, 425 nm or less, 400 nm or less, 375 nm or less, 350 nm or less, 325 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 5 nm or less, 4 nm or less, 3 nm or less, or 2 nm or less).

The average thickness of the nickel layer can range from any of the minimum values described above to any of the maximum values described above. For example, the nickel layer can have an average thickness of from 1 nm to 500 nm (e.g., from 1 nm to 400 nm, from 1 nm to 300 nm, from 1 nm to 200 nm, from 1 nm to 100 nm, or from 1 nm to 50 nm). As used herein, the average thickness of the nickel layer is determined using electron microscopy.

Also disclosed herein are nanostructured electrodes comprising a copper substrate, a nanostructured copper oxide layer disposed on the copper substrate, and an active layer disposed on the nanostructured copper oxide layer, wherein the active layer comprises copper and nickel.

The copper substrate can, for example, have an average surface area of from 1 μm² to 100 m². In some examples, the copper substrate can comprise a copper mesh. The nanostructured copper oxide layer can, for example, have an average thickness of from 50 nm to 1000 μm (e.g., from 500 nm to 500 μm, or from 1 μm to 10 μm). In some examples, the nanostructured copper oxide layer can comprise Cu₂O, CuO, CuO₂, Cu₂O₃, or combination thereof.

The active layer can, for example, comprise metallic copper and metallic nickel. In some examples, the active layer consists essentially of copper and nickel. In some examples, the active layer consists of copper and nickel. In some examples, the active layer is substantially free of copper oxide.

The active layer can, for example, have an average thickness of 1 nm or more (e.g., 2 nm or more, 3 nm or more, 4 nm or more, 5 nm or more, 6 nm or more, 7 nm or more, 8 nm or more, 9 nm or more, 10 nm or more, 15 nm or more, 20 nm or more, 25 nm or more, 30 nm or more, 35 nm or more, 40 nm or more, 45 nm or more, 50 nm or more, 60 nm or more, 70 nm or more, 80 nm or more, 90 nm or more, 100 nm or more, 125 nm or more, 150 nm or more, 175 nm or more, 200 nm or more, 225 nm or more, 250 nm or more, 275 nm or more, 300 nm or more, 325 nm or more, 350 nm or more, 375 nm or more, 400 nm or more, 425 nm or more, 450 nm or more, or 475 nm or more).

In some examples, the active layer can have an average thickness of 500 nm or less (e.g., 475 nm or less, 450 nm or less, 425 nm or less, 400 nm or less, 375 nm or less, 350 nm or less, 325 nm or less, 300 nm or less, 275 nm or less, 250 nm or less, 225 nm or less, 200 nm or less, 175 nm or less, 150 nm or less, 125 nm or less, 100 nm or less, 90 nm or less, 80 nm or less, 70 nm or less, 60 nm or less, 50 nm or less, 45 nm or less, 40 nm or less, 35 nm or less, 30 nm or less, 25 nm or less, 20 nm or less, 15 nm or less, 10 nm or less, 5 nm or less, 4 nm or less, 3 nm or less, or 2 nm or less).

The average thickness of the active layer can range from any of the minimum values described above to any of the maximum values described above. For example, the active layer can have an average thickness of from 1 nm to 500 nm (e.g., from 1 nm to 400 nm, from 1 nm to 300 nm, from 1 nm to 200 nm, from 1 nm to 100 nm, or from 1 nm to 50 nm). As used herein, the average thickness of the active layer is determined using electron microscopy.

The active layer can, for example, be formed by photoelectrochemically modifying a precursor nanostructured electrode, the nanostructured precursor electrode comprising the copper substrate, the nanostructured copper oxide layer disposed on the copper substrate, and a nickel layer disposed on the nanostructured copper oxide layer. The nickel layer can, for example, comprise metallic nickel. In some example, the nickel layer can have an average thickness of from 1 nm to 500 nm (e.g., from 1 nm to 100 nm, or from 1 nm to 50 nm). The nanostructured electrodes described herein can, for example, comprise a photoelectrochemically modified product of a nanostructured precursor electrode, the nanostructured precursor electrode comprising a copper substrate, a nanostructured copper oxide layer disposed on the copper substrate, and a nickel layer disposed on the nanostructured copper oxide layer. The nanostructured precursor electrode can, for example, comprise any of the nanostructured precursor electrodes described herein.

Also described herein are nanostructured electrodes comprising a photoelectrochemically modified product of a nanostructured precursor electrode, the nanostructured precursor electrode comprising a copper substrate, a nanostructured copper oxide layer disposed on the copper substrate, and a nickel layer disposed on the nanostructured copper oxide layer. The nanostructured precursor electrode can, for example, comprise any of the nanostructured precursor electrodes described herein.

For example, the copper substrate can have an average surface area of from 1 μm² to 100 m². In some examples, the copper substrate can comprise a copper mesh. The nanostructured copper oxide layer can, for example comprise Cu₂O, CuO, CuO₂, Cu₂O₃, or combination thereof. In some examples, the nanostructured copper oxide layer can have an average thickness of from 50 nanometers (nm) to 1000 micrometers (microns, μm) (e.g., from 500 nm to 500 μm, or from 1 μm to 10 μm). The nickel layer can, for example comprise metallic nickel. In some examples, the nickel layer can have an average thickness of from 1 nm to 500 nm (e.g., from 1 nm to 100 nm, or from 1 nm to 50 nm).

Also described herein are nanostructured electrodes for the direct regeneration of NADH, NADPH, or combination thereof using photoelectrochemistry or photochemistry with a low overpotential, wherein the nanostructured electrode comprises a high surface area substrate, a nanostructured layer comprising a p-type semiconductor disposed on the high surface area substrate, and an active layer comprising a hydrogen capture material disposed on the nanostructured layer. The high surface area substrate, the nanostructured layer, the active layer, or a combination thereof can, for example, comprise an inexpensive and/or abundant material. The nanostructured electrode for the direct regeneration of NADH, NADPH, or combination thereof can, for example, comprise any of the nanostructured precursor electrodes described herein or any of the nanostructured electrodes described herein.

Also described herein are methods of making the nanostructured precursor electrodes and nanostructured electrodes described herein. For example, also disclosed herein are methods of making the nanostructured precursor electrodes described herein, the methods comprising depositing the nanostructured copper oxide layer on the copper mesh and subsequently depositing the nickel layer on the nanostructured copper oxide layer. The nanostructured copper oxide layer can, for example, be deposited by electrodeposition, chemical bath deposition, physical vapor deposition, atomic layer deposition, spray pyrolysis, chemical vapor deposition, or a combination thereof.

In some examples, the methods comprise electrodepositing the nanostructured copper oxide layer on the copper mesh. In some examples, the electrodeposition is performed at room temperature.

Electrodepositing the nanostructured copper oxide layer can, for example, comprise submersing the copper mesh in a solution comprising copper and applying a potential to the copper mesh. In some examples, the potential is −0.1 V vs. Ag/AgCl or less (e.g., −0.2 V or less, −0.3 V or less, −0.4 V or less, or −0.5 V or less). In some examples, the potential is −0.6 V vs. Ag/AgCl or more (e.g., −0.5 V or more, −0.4 V or more, −0.3 V or more, or −0.2 V or more). The potential can range from any of the minimum values described above to any of the maximum values described above. For example, the potential can be from −0.1 Volts (V) vs. Ag/AgCl to −0.6 V vs. Ag/AgCl (e.g., from −0.1 V to −0.4 V, from −0.4 V to −0.6 V, from −0.1 V to −0.5 V, from −0.2 V to −0.6 V, or from −0.2 V to −0.5 V). The potential can, for example, be −0.5 V vs. Ag/AgCl.

In some examples, the potential is applied for an amount of time of 1 minute or more (e.g., 2 minutes or more, 3 minutes or more, 4 minutes or more, 5 minutes or more, 10 minutes or more, 15 minutes or more, 20 minutes or more, 30 minutes or more, 45 minutes or more, 1 hour or more, 1.5 hour or more, 2 hours or more, 2.5 hours or more, 3 hours or more, 4 hours or more, 5 hours or more, 6 hours or more, 8 hours or more, or 10 hours or more). In some examples, the potential is applied for an amount of time of 12 hours or less (e.g., 10 hours or less, 8 hours or less, 6 hours or less, 5 hours or less, 4 hours or less, 3 hours or less, 2.5 hours or less, 2 hours or less, 1.5 hours or less, 1 hour or less, 45 minutes or less, 30 minutes or less, 20 minutes or less, 15 minutes or less, 10 minutes or less, or 5 minutes or less). The amount of time the potential is applied can range from any of the minimum values described above to any of the maximum values described above. For example, the potential can be applied for an amount of time of from 1 minute to 12 hours (e.g., from 1 minute to 10 minutes, from 10 minutes to 1 hour, from 1 hour to 12 hours, from 10 minutes to 12 hours, or from 1 minute to 4 hours). The potential can, for example, be applied for 2 hours.

The solution comprising copper can comprise a solution of a copper compound, such as CuSO₄. In some examples, he solution comprising copper can comprise a solution of a copper compound such as that described by Zhu et al. “Seed layer-assisted chemical bath deposition of CuO films on ITO-coated glass substrates with tunable crystallinity and morphology”, Chemistry of Materials, 2014, 26, 2960-2966. The solution comprising copper can, for example, have a concentration of copper of 0.1 molar (M) or more (e.g., 0.15 M or more, 0.2 M or more, 0.25 M or more, 0.3 M or more, 0.35 M or more, 0.4 M or more, 0.45 M or more, 0.5 M or more, 0.6 M or more, 0.7 M or more, 0.8 M or more, or 0.9 M or more). In some examples, the solution comprising copper can have a concentration of copper of 1 M or less (e.g., 0.9 M or less, 0.8 M or less, 0.7 M or less, 0.6 M or less, 0.5 M or less, 0.45 M or less, 0.4 M or less, 0.35 M or less, 0.3 M or less, 0.25 M or less, or 0.2 M or less). The concentration of copper in the solution comprising copper can range from any of the minimum values described above to any of the maximum values described above. For example, the solution comprising copper can have a concentration of copper of from 0.1 M to 1 M (e.g., from 0.1 M to 0.5 M, from 0.5 M to 1 M, from 0.1 M to 0.3 M, from 0.3 M to 0.6 M, from 0.6 M to 1 M, or from 0.4 M to 0.5 M).

In some examples, the solution comprising copper can have a pH of 9 or more (e.g., 9.5 or more, 10 or more, 10.5 or more, or 11 or more). In some examples, the solution comprising copper can have a pH or 12 or less (e.g., 11.5 or less, 11 or less, 10.5 or less, or 10 or less). The pH of the solution comprising copper can range from any of the minimum values described above to any of the maximum values described above. For example, the solution comprising copper can have a pH of from 9 to 12 (e.g., from 9 to 10.5, from 10.5 to 12, from 9 to 10, from 10 to 11, from 11 to 12, from 10 to 12, from 9 to 11, or from 9.5 to 11.5).

The nickel layer can be deposited, for example, by thin film processing techniques, such as sputtering, pulsed layer deposition, molecular beam epitaxy, evaporation, atomic layer deposition, or combinations thereof. In some examples, depositing the nickel layer comprises sputtering, such as DC sputtering. In some examples, depositing the nickel layer is performed under vacuum and/or an inert atmosphere (e.g., Ar, N₂, etc.).

The nickel layer can, for example, be deposited for an amount of time of 1 hour or more (e.g., 2 hours or more, 3 hours or more, 4 hours or more, 5 hours or more, 6 hours or more, 8 hours or more, 10 hours or more, 12 hours or more, 14 hours or more, 16 hours or more, 18 hours or more, 20 hours or more, 22 hours or more, 24 hours or more, 30 hours or more, 36 hours or more, 42 hours or more, 48 hours or more, 60 hours or more, 72 hours or more, 84 hours or more, or 96 hours or more). In some examples, the nickel layer can be deposited for 100 hours or less (e.g., 96 hours or less, 84 hours or less, 72 hours or less, 60 hours or less, 48 hours or less, 42 hours or less, 36 hours or less, 30 hours or less, 24 hours or less, 22 hours or less, 20 hours or less, 18 hours or less, 16 hours or less, 14 hours or less, 12 hours or less, 10 hours or less, 8 hours or less, 6 hours or less, 5 hours or less, 4 hours or less, or 3 hours or less). The amount of time the nickel layer is deposited for can range from any of the minimum values described above to any of the maximum values described above. For example, the nickel layer can be deposited for an amount of time of from 1 hour to 100 hours (e.g., from 1 hour to 48 hours, from 48 hours to 100 hours, from 1 hour to 24 hours, from 24 hours to 60 hours, from 60 hours to 100 hours, from 6 hours to 100 hours, from 1 hour to 96 hours, from 6 hours to 96 hours, or from 10 hours to 100 hours). In some examples, the nickel layer can be deposited for 96 hours.

The methods can, in some examples, further comprise cleaning the copper mesh prior to depositing the nanostructured copper oxide layer thereon. Cleaning the copper mesh can, for example, comprise submersing the copper mesh in a first solvent and sonicating for a first amount of time, and subsequently removing the copper mesh from the first solvent and rinsing the copper mesh with deionized water.

The first solvent can, for example, comprise tetrahydrofuran (THF), N-methyl-2-pyrrolidone (NMP), dimethylformamide (DMF), N-methylformamide, formamide, dichloromethane (CH₂Cl₂), ethylene glycol, polyethylene glycol, glycerol, alkane diol, ethanol, methanol, propanol, isopropanol, water, acetonitrile, chloroform, toluene, methyl acetate, ethyl acetate, acetone, hexane, heptane, tetraglyme, propylene carbonate, diglyme, dimethyl sulfoxide (DMSO), dimethoxyethane, xylene, dimethylacetamide, or combinations thereof. In some examples, the first solvent comprises ethanol.

The first amount of time can, for example, be 1 minute or more (e.g., 2 minutes or more, 3 minutes or more, 4 minutes or more, 5 minutes or more, 10 minutes or more, 15 minutes or more, 20 minutes or more, 30 minutes or more, 40 minutes or more, 45 minutes or more, 50 minutes or more, or 55 minutes or more). In some examples, the first amount of time can be 1 hour or less (e.g., 55 minutes or less, 50 minutes or less, 45 minutes or less, 40 minutes or less, 35 minutes or less, 30 minutes or less, 25 minutes or less, 20 minutes or less, 15 minutes or less, 10 minutes or less, or 5 minutes or less). The first amount of time can range from any of the minimum values described above to any of the maximum values described above. For example, the first amount of time can be from 1 minute to 1 hour (e.g., from 1 minute to 30 minutes, from 30 minutes to 1 hour, from 1 minute to 20 minutes, from 20 minutes to 40 minutes, from 40 minutes to 1 hour, from 5 minutes to 1 hour, from 1 minute to 50 minutes, or from 5 minutes to 50 minutes). In some examples, the first amount of time is 10 minutes.

In some examples, cleaning the copper mesh can further comprise, after rinsing the copper mesh with deionized water, submersing the copper mesh in a second solvent and sonicating for a second amount of time, and subsequently removing the copper mesh from the first solvent and rinsing the copper mesh with deionized water. The second solvent can be the same as or different than the first solvent. In some examples, second solvent is the same as the first solvent. In some examples, the second solvent comprises ethanol. The second amount of time can, for example, be from 1 minute to 1 hour. In some examples, the second amount of time can be the same as the first amount of time. In some examples, the second amount of time is 10 minutes.

In some examples, cleaning the copper mesh can further comprise, after rinsing the copper mesh with deionized water, submersing the copper mesh in a third solvent and sonicating for a third amount of time, and subsequently removing the copper mesh from the first solvent and rinsing the copper mesh with deionized water. The third solvent can be the same as or different than the first solvent and/or the second solvent. In some examples, the third solvent is different than the first solvent and the second solvent. In some examples, the third solvent comprises deionized water. The third amount of time can, for example, be from 1 minute to 1 hour. In some examples, the third amount of time is the same as the first amount of time and/or the second amount of time. In some examples, the third amount of time is 10 minutes.

In some examples, cleaning the copper mesh can further comprise, after rinsing the copper mesh with deionized water, drying the copper mesh.

Also disclosed herein are methods of making any of the nanostructured electrodes described herein, the methods comprising photoelectrochemically modifying any of the nanostructured precursor electrodes described herein. In some examples, the methods can further comprise making the nanostructured precursor electrode, for example using any of the methods described herein.

Photoelectrochemically modifying the nanostructured precursor electrode can, for example, comprise irradiating the nanostructured precursor electrode in conjunction with (e.g., concurrently with) performing potentiostatic electrolysis on the nanostructured precursor electrode. In some examples, the photoelectrochemical modification is performed while the nanostructured precursor substrate is submersed in a sodium phosphate buffer.

Irradiating the nanostructured precursor electrode can, for example, comprise exposing the nanostructured precursor electrode to electromagnetic radiation, wherein the nanostructured precursor electrode has a bandgap energy and at least a portion of the electromagnetic radiation has an energy greater than or equal to the bandgap energy.

The electromagnetic radiation can, for example, be provided by a light source. The light source can be any type of light source. Examples of suitable light sources include natural light sources (e.g., sunlight) and artificial light sources (e.g., incandescent light bulbs, light emitting diodes, gas discharge lamps, arc lamps, lasers, etc.). In some examples, the electromagnetic radiation comprises sunlight. In some examples, the light source can comprise a laser. In some examples, irradiating the nanostructured precursor electrode can comprise exposing the nanostructured precursor electrode to a coherent light source, such as a 10 mW, 532 nm laser.

The nanostructured precursor electrode can, for example, be irradiated for an amount of time of 1 minute or more (e.g., 2 minutes or more, 3 minutes or more, 4 minutes or more, 5 minutes or more, 10 minutes or more, 15 minutes or more, 20 minutes or more, 30 minutes or more, 45 minutes or more, 1 hour or more, 1.5 hour or more, 2 hours or more, 2.5 hours or more, 3 hours or more, 4 hours or more, 5 hours or more, 6 hours or more, 8 hours or more, or 10 hours or more). In some examples, the nanostructured precursor electrode can be irradiated for an amount of time of 12 hours or less (e.g., 10 hours or less, 8 hours or less, 6 hours or less, 5 hours or less, 4 hours or less, 3 hours or less, 2.5 hours or less, 2 hours or less, 1.5 hours or less, 1 hour or less, 45 minutes or less, 30 minutes or less, 20 minutes or less, 15 minutes or less, 10 minutes or less, or 5 minutes or less). The amount of time the nanostructured precursor electrode is irradiated can range from any of the minimum values described above to any of the maximum values described above. For example, the nanostructured precursor electrode can be irradiated for an amount of time of from 1 minute to 12 hours (e.g., from 1 minute to 10 minutes, from 10 minutes to 1 hour, from 1 hour to 12 hours, from 10 minutes to 12 hours, or from 1 minute to 4 hours). In some example, the nanostructured precursor electrode is irradiated for an hour.

Performing potentiostatic electrolysis on the precursor electrode can, for example, comprise applying a potential of −0.75 V vs. Ag/AgCl or less (e.g., −0.8 V or less, −0.9 V or less, −1 V or less, −1.1 V or less, −1.2 V or less, −1.3 V or less, or −1.4 V or less). In some examples, the potential can be −1.5 V vs. Ag/AgCl or more (e.g., −1.4 V or less, −1.3 V or less, −1.2 V or less, −1.1 V or less, −1 V or less, −0.9 V or less, or −0.8 V or less). The potential can range from any of the minimum values described above to any of the maximum values described above. For example, the potential can be from −0.75 V to −1.5 V vs. Ag/AgCl (e.g., from −0.75 V to −1.1 V, from −1.1 V to −1.5 V, from −0.75 V to −1 V, from −1 V to −1.25 V, from −1.25 V to −1.5 V, from −0.75 V to −1.25 V, or from −0.9 V to −1.2 V). In some examples, the potential is −0.75 V vs. Ag/AgCl.

The potential can, for example, be applied for an amount of time of 1 minute or more (e.g., 2 minutes or more, 3 minutes or more, 4 minutes or more, 5 minutes or more, 10 minutes or more, 15 minutes or more, 20 minutes or more, 30 minutes or more, 45 minutes or more, 1 hour or more, 1.5 hour or more, 2 hours or more, 2.5 hours or more, 3 hours or more, 4 hours or more, 5 hours or more, 6 hours or more, 8 hours or more, or 10 hours or more). In some examples, the potential is applied for an amount of time of 12 hours or less (e.g., 10 hours or less, 8 hours or less, 6 hours or less, 5 hours or less, 4 hours or less, 3 hours or less, 2.5 hours or less, 2 hours or less, 1.5 hours or less, 1 hour or less, 45 minutes or less, 30 minutes or less, 20 minutes or less, 15 minutes or less, 10 minutes or less, or 5 minutes or less). The amount of time the potential is applied can range from any of the minimum values described above to any of the maximum values described above. For example, the potential can be applied for an amount of time of from 1 minute to 12 hours (e.g., from 1 minute to 10 minutes, from 10 minutes to 1 hour, from 1 hour to 12 hours, from 10 minutes to 12 hours, or from 1 minute to 4 hours). In some examples, the potential is applied for 1 hour.

Also disclosed herein are methods of making any of the nanostructured electrodes described herein, the methods comprising making a nanostructured electrode precursor electrode (e.g., using any of the methods described herein) and photoelectrochemically modifying the nanostructured precursor electrode to form the nanostructured electrode (e.g., using any of the methods described herein), wherein the nanostructured precursor electrode comprises the copper substrate, the nanostructured copper oxide layer disposed on the copper substrate, and a nickel layer disposed on the nanostructured copper oxide layer.

Also described herein are methods of use of any of the nanostructured precursor electrodes described herein and/or any of the nanostructured electrodes described herein. For example, also described herein are methods of use of any of the nanostructured precursor electrodes described herein or any of the nanostructured electrodes described herein, the method comprising using the nanostructured precursor electrode or the nanostructured electrode to directly regenerate NADH, NADPH, or a combination thereof photochemically or photoelectrochemically.

In some examples, the method can comprise directly regenerating NADH, NADPH, or a combination thereof photoelectrochemically using a low overpotential. The methods can, for example, comprise applying an overpotential to the nanostructured precursor electrode or the nanostructured electrode in the presence of a solution comprising NAD(P)⁺ to electrochemically regenerate NAD(P)H. As used herein, the term NAD(P)H includes NADH, NADPH, and combinations thereof. Similarly, as used herein, the term NAD(P)⁺ includes NAD⁺, NADP⁺, and combinations thereof.

The overpotential applied can, for example, be −0.75 V vs. Ag/AgCl or less (e.g., −0.8 V or less, −0.9 V or less, −1 V or less, −1.1 V or less, −1.2 V or less, −1.3 V or less, or −1.4 V or less). In some examples, the overpotential can be −1.5 V vs. Ag/AgCl or more (e.g., −1.4 V or less, −1.3 V or less, −1.2 V or less, −1.1 V or less, −1 V or less, −0.9 V or less, or −0.8 V or less). The overpotential can range from any of the minimum values described above to any of the maximum values described above. For example, the overpotential can be from −0.75 V to −1.5 V vs. Ag/AgCl (e.g., from −0.75 V to −1.1 V, from −1.1 V to −1.5 V, from −0.75 V to −1 V, from −1 V to −1.25 V, from −1.25 V to −1.5 V, from −0.75 V to −1.25 V, or from −0.9 V to −1.2 V). In some examples, the overpotential is −0.75 V vs. Ag/AgCl.

The overpotential can, for example, be applied for an amount of time of 1 minute or more (e.g., 2 minutes or more, 3 minutes or more, 4 minutes or more, 5 minutes or more, 10 minutes or more, 15 minutes or more, 20 minutes or more, 30 minutes or more, 45 minutes or more, 1 hour or more, 1.5 hour or more, 2 hours or more, 2.5 hours or more, 3 hours or more, 4 hours or more, 5 hours or more, 6 hours or more, 8 hours or more, or 10 hours or more). In some examples, the overpotential is applied for an amount of time of 12 hours or less (e.g., 10 hours or less, 8 hours or less, 6 hours or less, 5 hours or less, 4 hours or less, 3 hours or less, 2.5 hours or less, 2 hours or less, 1.5 hours or less, 1 hour or less, 45 minutes or less, 30 minutes or less, 20 minutes or less, 15 minutes or less, 10 minutes or less, or 5 minutes or less). The amount of time the overpotential is applied can range from any of the minimum values described above to any of the maximum values described above. For example, the overpotential can be applied for an amount of time of from 1 minute to 12 hours (e.g., from 1 minute to 10 minutes, from 10 minutes to 1 hour, from 1 hour to 12 hours, from 10 minutes to 12 hours, or from 1 minute to 4 hours).

In some examples, the methods can further comprise irradiating the nanostructured precursor electrode or the nanostructured electrode concurrently with applying the overpotential. In some examples, the methods can comprise irradiating any of the nanostructured precursor electrodes described herein concurrently with applying the overpotential which converts the nanostructured precursor electrode to any of the nanostructured electrodes described herein in situ.

Irradiating the nanostructured precursor electrode or the nanostructured electrode can, for example, comprise exposing the nanostructured precursor electrode or the nanostructured electrode to electromagnetic radiation, wherein the nanostructured precursor electrode or the nanostructured electrode has a bandgap energy and at least a portion of the electromagnetic radiation has an energy greater than or equal to the bandgap energy.

The electromagnetic radiation can, for example, be provided by a light source. The light source can be any type of light source. Examples of suitable light sources include natural light sources (e.g., sunlight) and artificial light sources (e.g., incandescent light bulbs, light emitting diodes, gas discharge lamps, arc lamps, lasers, etc.). In some examples, the electromagnetic radiation comprises sunlight. In some examples, the light source can comprise a laser. In some examples, irradiating the nanostructured precursor electrode can comprise exposing the nanostructured precursor electrode to a 10 mW, 532 nm laser.

The nanostructured precursor electrode or the nanostructured electrode can, for example, be irradiated for an amount of time of 1 minute or more (e.g., 2 minutes or more, 3 minutes or more, 4 minutes or more, 5 minutes or more, 10 minutes or more, 15 minutes or more, 20 minutes or more, 30 minutes or more, 45 minutes or more, 1 hour or more, 1.5 hour or more, 2 hours or more, 2.5 hours or more, 3 hours or more, 4 hours or more, 5 hours or more, 6 hours or more, 8 hours or more, or 10 hours or more). In some examples, the nanostructured precursor electrode or the nanostructured electrode can be irradiated for an amount of time of 12 hours or less (e.g., 10 hours or less, 8 hours or less, 6 hours or less, 5 hours or less, 4 hours or less, 3 hours or less, 2.5 hours or less, 2 hours or less, 1.5 hours or less, 1 hour or less, 45 minutes or less, 30 minutes or less, 20 minutes or less, 15 minutes or less, 10 minutes or less, or 5 minutes or less). The amount of time the nanostructured precursor electrode or the nanostructured electrode is irradiated can range from any of the minimum values described above to any of the maximum values described above. For example, the nanostructured precursor electrode or the nanostructured electrode can be irradiated for an amount of time of from 1 minute to 12 hours (e.g., from 1 minute to 10 minutes, from 10 minutes to 1 hour, from 1 hour to 12 hours, from 10 minutes to 12 hours, or from 1 minute to 4 hours).

The methods can, for example, provide 1,4-NAD(P)H with a purity of 66% or more (e.g., 67% or more, 68% or more, 69% or more, 70% or more, 75% or more, 80% or more, 85% or more, 90% or more, 95% or more, or 99% or more). As used herein, the purity is determined as the percentage of the product of the method that comprises 1,4-NAD(P)H produced relative to the sum of the amounts of inactive forms of NAD(P)H, such as dimers (e.g., (NAD(P)H)₂), inactive isomers (e.g. 1,6-NAD(P)H), and the like, or combinations thereof.

The composition of the nanostructured precursor electrode (e.g., composition of layers, thickness of layers), the composition of the nanostructured electrode (e.g., composition of layers, thickness of layers), the irradiation conditions (e.g., electromagnetic radiation source, irradiation time and/or power), the overpotential conditions (e.g., overpotential applied, time overpotential is applied), or a combination thereof can be selected to minimize the production of inactive forms of NAD(P)H using the methods, e.g., to increase the selective production of 1,4-NAD(P)H over the inactive forms of NAD(P)H and thereby increase the purity.

In some examples, the method produces a product that is substantially free of (NAD(P)H)₂, 1,6-NAD(P)H, or a combination thereof. In some examples, the method produces a product that consists essentially of 1,4-NADP(H). In some examples, the method produces a product that consists of 1,4-NAD(P)H.

Also disclosed herein are methods of making biofuels, the methods comprising synthesizing the biofuel via biofermentation of a biomass concurrently with regeneration of NAD(P)H, wherein the NAD(P)H is regenerated using any of the methods described herein using any of the nanostructured precursor electrodes described herein and/or any of the nanostructured electrodes described herein.

The term “biomass,” as used herein, refers to living or dead biological material that can be used in one or more of the disclosed methods. In the disclosed methods the “biomass” can comprise any cellulosic and/or lignocellulosic biomass and can include materials comprising cellulose, and optionally hemicellulose, lignin, starch, oligosaccharides and/or monosaccharides, their mixtures, and breakdown products (e.g., metabolites). Biomass can also comprise additional components, such as protein and/or lipid. Biomass can be derived from a single source, or biomass can comprise a mixture derived from more than one source. Some specific examples of suitable biomasses that can be used in the disclosed methods include, but are not limited to, bioenergy crops, agricultural residues, municipal solid waste, industrial solid waste, sludge from paper manufacture, yard waste, wood, and forestry waste. Additional examples of suitable types of biomass include, but are not limited to, corn grain, corn cobs, crop residues such as corn husks, corn stover, grasses, wheat, wheat straw, hay, rice straw, switchgrass, waste paper, sugar cane bagasse, sorghum, soy, components obtained from milling of grains, trees (e.g., pine), branches, roots, leaves, wood chips, wood pulp, sawdust, shrubs and bushes, vegetables, fruits, flowers, animal manure, and multi-component feed. In some examples, the biomass can comprise a lignocellulosic biomass.

Lignocellulosic biomass typically comprises three major components: cellulose, hemicellulose, and lignin, along with some extractive materials (Sjostorm, E. Wood Chemistry: Fundamentals and Applications, 2nd ed., 1993, New York.). Depending on the source, their relative compositions usually vary to certain extent. Cellulose is the most abundant polymer on Earth and enormous effort has been put into understanding its structure, biosynthesis, function, and degradation (Stick, R. V. Carbohydrates—The Sweet Molecules of Life, 2001, Academic Press, New York.). Cellulose is a polysaccharide comprising a linear chain of several hundred to over ten thousand β(1→4) linked D-glucose units. The chains are hydrogen bonded either in parallel or anti-parallel manner which imparts more rigidity to the structure, and a subsequent packaging of bound-chains into microfibrils forms the ultimate building material of the nature.

Hemicellulose is the principal non-cellulosic polysaccharide in lignocellulosic biomass. Hemicellulose is a branched heteropolymer, consisting of different sugar monomers with 500-3000 units. Hemicellulose is usually amorphous.

Lignin is the most complex naturally occurring high-molecular weight polymer (Hon, D. N. S.; Shiraishi, N., Eds., Wood and Cellulosic Chemistry, 2^{nd} ed., 2001, Marcel Dekker, Inc., New York.). Lignin is relatively hydrophobic and aromatic in nature, but lacks a defined primary structure. Softwood lignin primarily comprises guaiacyl units, and hardwood lignin comprises both guaiacyl and syringyl units. Cellulose content in both hardwood and softwood is about 43±2%. Typical hemicellulose content in wood is about 28-35 wt %, depending on type of wood. Lignin content in hardwood is about 18-25% while softwood may contain about 25-35% of lignin.

Examples of biofuels include, but are not limited to, methane, ethanol, propanol, methanol, butanol, and biodiesel. In some examples, the biofuel comprises butanol.

Also disclosed herein are methods of use of any of the nanostructured precursor electrodes described herein and/or any of the nanostructured electrodes described herein, the methods comprising using the nanostructured precursor electrode and/or the nanostructured electrode for artificial photosynthesis, conversion of a biomass to a biofuel, solar energy conversion, energy storage, or a combination thereof. Also disclosed herein are methods of use of any of the nanostructured precursor electrodes described herein and/or any of the nanostructured electrodes described herein, the methods comprising using the nanostructured precursor electrode and/or the nanostructured electrode in a pharmaceutical application, a chemical application, an energy storage device, of a combination thereof.

A number of embodiments of the invention have been described. Nevertheless, it will be understood that various modifications may be made without departing from the spirit and scope of the invention. Accordingly, other embodiments are within the scope of the following claims.

The examples below are intended to further illustrate certain aspects of the systems and methods described herein, and are not intended to limit the scope of the claims.

### EXAMPLES

The following examples are set forth below to illustrate the methods and results according to the disclosed subject matter. These examples are not intended to be inclusive of all aspects of the subject matter disclosed herein, but rather to illustrate representative methods and results. These examples are not intended to exclude equivalents and variations of the present invention which are apparent to one skilled in the art.

Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of measurement conditions, e.g., component concentrations, temperatures, pressures and other measurement ranges and conditions that can be used to optimize the described process.

### Example 1

The direct electrochemical regeneration of the cofactor 1,4-NADPH at a Ni coated Cu₂₀ derived cathode is demonstrated. Enzymatic assay reveals the purity of electrolysis products at a low overpotential (−0.75 V vs. Ag/AgCl) to be 74.1±1.0% and 89.1±2.8% 1,4-NADPH for two separate electrodes. Temporal kinetic studies suggest that an initial light-assisted surface restructuring process, in which the semiconducting Cu₂O is converted back to a catalytic form of Cu, is necessary to observe NADP⁺ reduction. Material analysis indicates that the Ni-sputtering step used to prepare the electrode results in significant surface morphology changes that undergird the catalytic capabilities of the electrode.

BACKGROUND The nicotinamide adenine dinucleotide redox couple, NAD⁺/NADH, and their phosphorylated counterparts, NADP⁺/NADPH, are ubiquitous cofactors in metabolic processes in all organisms. In animal cells, NAD⁺ and NADH are cofactors involved in the redox reactions in glycolysis as well as in the TriCarboxylic Acid (TCA) cycle (also commonly known as the citric acid cycle) (Van Linden M R et al. The Biochemist, 2015, 37(1), 9-13). The corresponding phosphorylated forms, NADP⁺ and NADPH, play a key part in photosynthesis, particularly in photosystem I and the subsequent Calvin cycle for energy production in plant cells (Blankenship R. Molecular Mechanisms of Photosynthesis. Hoboken: Wiley. 2014). From an industrial standpoint, nicotinamides are of interest due to their relevancy to biocatalysis. Biocatalysis, the usage of enzymes isolated from biological material, is commonly applied in the chemical and pharmaceutical industry to synthesize drugs, biofuels, and other marketable chemical compounds (Bornscheuer U T et al. Nature, 2012, 485(7397), 185-194). Oxidoreductases, a large class of enzymes, typically require NAD(P)⁺/NAD(P)H as cofactors to facilitate the transfer of both electrons and hydrogen to and from substrate molecules in biocatalytic processes (Uppada V et al. Current Science, 2014, 106(7), 946-957; Wilson J et al. Molecular biology of the cell. 5th ed. New York: Garland. 2015, 159). For example, NADH is commonly used as a cofactor with various alcohol dehydrogenases to convert aldehydes to alcohol, a key step in the production of biofuels. In the process, NADH is converted to NAD⁺ and the reaction stops until more NADH is supplied. The current high cost of the reduced forms of the cofactors, NADH and NADPH, however, makes it economically unfeasible to use stoichiometric amounts of cofactor in biocatalysis. The bulk (not retail) cost of a single mole of NADH in 2011 dollars was approximately $3,000 ($4.52 per gram) and $215,000 ($288.82 per gram) for NADPH (Faber K. Biotransformations in Organic Chemistry. Springer Berlin Heidelberg. 2011. pp. 31-313). Consequently, the development of effective cofactor regeneration systems is needed to reduce costs and increase the efficiency of the enzyme turnover in certain biocatalytic processes so that they can be conducted on an industrial scale.

Electrochemical Cofactor Regeneration Techniques. Of the studied techniques for NAD(P)H regeneration (enzymatic, chemical, electrochemical, biological) (Chenault H K et al. Applied Biochemistry and Biotechnology, 2007, 14(2), 147-197), electrochemical methods have shown promise due to the economic availability of electricity and the direct supply of electrons without the addition of co-substrates (Wang X et al. Chem, 2017, 2(5), 621-654; Weckbecker A et al. Biosystems Engineering I. Springer Berlin Heidelberg. 2010. pp. 195-242). In the direct electrochemical reduction of NAD(P)⁺ to NAD(P)H, the reaction generally proceeds in two steps. First, the NAD(P)⁺ accepts a single electron and is reduced to the intermediate radical form, NAD(P)* with an unpaired electron in the valence shell of the carbon-4 atom. The radical is then further reduced by the addition of another electron and protonated by H⁺ to form NAD(P)H, as seen in Scheme 1 (Ali I et al. International Journal of Electrochemical Science, 2013, 8(3), 4283-4304). Unfortunately, the intermediate radical formed following the first reduction step can quickly dimerize with another C4 radical and thereby prevent generation of NAD(P)H that could subsequently be used by an enzyme (Ali I et al. International Journal of Electrochemical Science, 2013, 8(3), 4283-4304). Additionally, protonation of the intermediate could lead to 1,6-NAD(P)H (Moiroux J et al. Journal of Electroanalytical Chemistry, 1985, 194(1), 99-108), which is also not a substrate for subsequent biocatalytic transformations. Very high cathodic overpotentials (negative biases ca.<−1.00 V vs. Ag/AgCl) are typically required for the reduction and protonation of the intermediate radical NADP* and the overall purity (the relative amount of enzymatically active 1,4-NADPH formed vs. inactive products) can be dependent on the electrode material in addition to the electrode potential (Damian A et al. Chemical and Biochemical Engineering Quarterly, 2007, 21(1), 21-32; Ali I et al. Electrochemistry Communications, 2011, 13(6), 562-565; Ali I et al. Chemical Engineering Journal, 2012, 188, 173-180; Ali I et al. Journal of Molecular Catalysis A: Chemical, 2014, 387, 86-91; Ullah N et al. Materials Chemistry and Physics, 2015, 149, 413-417; Ali I et al. The Canadian Journal of Chemical Engineering, 2017, 9999, 1-6; Burnett J N et al. Biochemistry, 1965, 4(10), 2060-2064). For example, Omanovich et al. have shown that the purity of NADH formed at bare Au and Cu electrodes is 32% and 52% respectively at a high overpotential of −1.1 V vs. saturated calomel electrode (−1.06 V vs. Ag/AgCl) (Damian A et al. Chemical and Biochemical Engineering Quarterly, 2007, 21(1), 21-32). The purity, however, tends to maximize at some optimal overpotential; purity of products tends to be low at low overpotential and extreme overpotential for a given electrode material (Damian A et al. Chemical and Biochemical Engineering Quarterly, 2007, 21(1), 21-32; Ali I et al. Journal of Molecular Catalysis A: Chemical, 2014, 387, 86-91). Therefore, reaction product selectivity is a key issue in electrochemical regeneration of NAD(P)H.

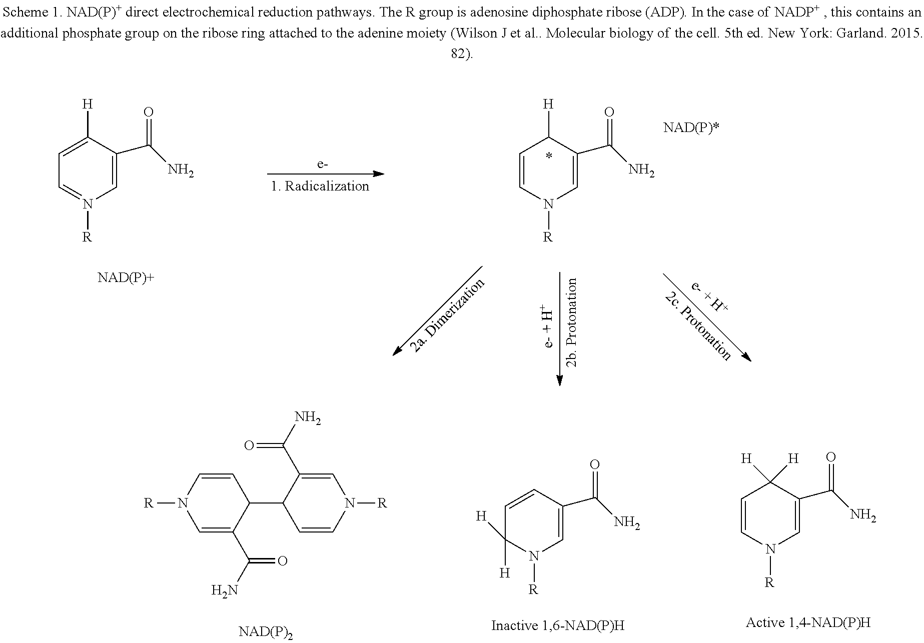

Improvements in selectivity at bare electrodes can be made by modifying electrode surfaces with materials capable of catalyzing the protonation step in the reduction of the nicotinamide radical. For instance, Omanovich et al. have demonstrated that precious metals including Pt and Ru as well as the transition metal Ni can increase the 1,4-NAD(P)H selectivity toward 100%; they hypothesized that this was the result of the catalyst material adsorbing hydrogen atoms at the electrode surface to assist in the protonation and physically blocking dimerization (Damian A et al. Chemical and Biochemical Engineering Quarterly, 2007, 21(1), 21-32; Ali I et al. The Canadian Journal of Chemical Engineering, 2017, 9999, 1-6; Azem A et al. Journal of Molecular Catalysis A: Chemical, 2004, 219(2), 283-299).

In addition, organic materials such as L-histidine and cholesterol have also been shown to increase purity when attached to bare metallic electrodes (Baik S H et al. Biotechnology Techniques, 1999, 13(1), 1-5; Long Y T et al. Journal of Electroanalytical Chemistry, 1997, 440(1-2), 239-242). These synthetic organic materials, however, lack the robustness that is offered by metallic catalysts in solid, inorganic cofactor regeneration systems (Ali I et al. International Journal of Electrochemical Science, 2013, 8(3), 4283-4304). Indirect electrochemical methods, which involve the use of a redox mediator to reduce NAD(P)⁺ in a single step, can also block the formation of inactive dimers (Kohlmann C et al. Journal of Molecular Catalysis B: Enzymatic, 2008, 51(3-4), 57-72). Although these indirect systems operate at lower overpotentials, they typically require complicated organometallic Rh³⁺ complexes capable of direct hydride transfer as redox mediators (Wienkamp V R. Angewandte Chemie, 1982, 94(10), 8249; Ruppert R et al. Tetrahedron Letters, 1987, 28(52), 6583-6586; Hildebrand F et al. Advanced Synthesis and Catalysis, 2008, 350(6), 909-918; Tan B et al. Journal of the Electrochemical Society, 2014, 162(3), H102-H107; Vuorilehto K et al. Bioelectrochemistry, 2004, 65(1), 1-7). Less complicated redox mediators, such as methyl viologen or flavin adenine dinucleotide (FAD) can be used, but only in a coupled enzymatic reaction with NAD(P)⁺ (Kim M H et al. Biotechnology Letters, 2004, 26(1), 21-26; Jayabalan R et al. Bioresource Technology, 2012, 123, 686-689). Thus, there is merit in developing simple and effective, inorganic electrochemical systems capable of direct NAD(P)H regeneration.

Despite the improvements to ‘all-solid’, direct electrochemical systems, high overpotentials, and thus more electrical energy, are still required to drive the cofactor regeneration process. The unique energy band structure of semiconducting electrodes can provide an avenue for lowering the overpotential and replacing electrical energy with light energy in a direct photoelectrochemical cofactor regeneration system. Before embarking on this topic, the basic physics of semiconductor-electrolyte interface is described first.

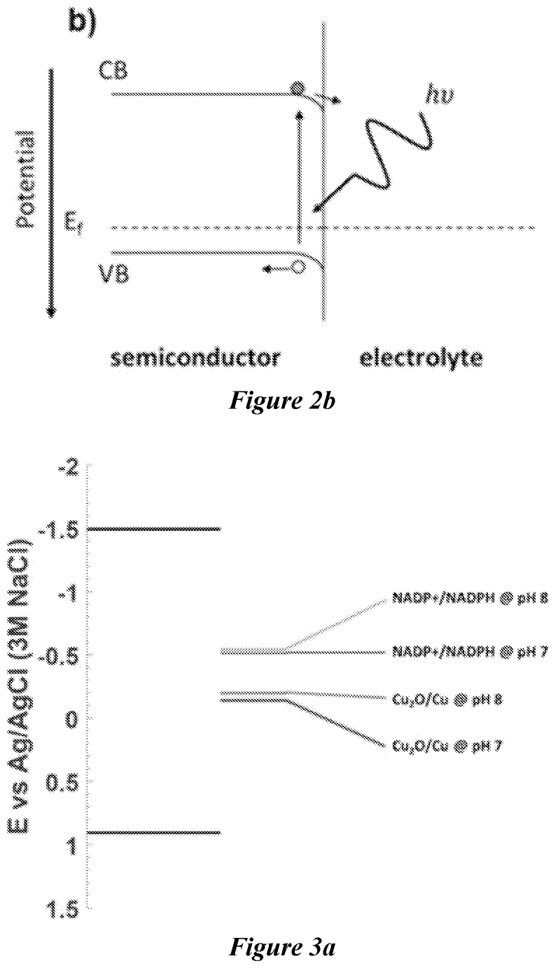

Semiconductor-Electrolyte Interfaces. When a semiconductor is placed in contact with an electrolyte solution, the system establishes electrochemical equilibrium following a temporary current flow as the Fermi levels of the semiconductor and the electrolyte align (FIG. 2a and FIG. 2b). Due to the low carrier density, this produces a region with a net electrical charge, known as the space charge region, extending into the semiconductor from the interface. The new charge distribution in the space charge region deforms the conduction and valence bands of the semiconductor to generate an internal electric field. When a photon with energy exceeding that of the band gap (the energy difference between the conduction and valence band) strikes the semiconductor, an electron is promoted to the conduction band leaving a positively-charged hole behind in the lower energy valence band. The internal electric field can separate the charges and produce a photocurrent, exemplifying the photogalvanic nature of semiconductor electrodes first discovered by Edmund Becquerel in 1839 (Bequerel E. Comptes rendus de l'Académie des Sciences, 1839, 9, 145-149). For a p-type semiconductor whose Fermi level lies closer to the valence band, the equilibration process typically results in downward band bending at the interface to create an electric field that drives electrons toward the electrolyte. Thus, a p-type semiconductor, whose conduction band lies at a more negative potential than the redox potential of the electroactive couple in solution, can generate cathodic photocurrents under reverse bias conditions.

SCOPE. The majority of the research into photoelectrochemistry has been restricted to cells used for the electrolysis of water into H₂ and O₂ or for power generation (Gratzel M. Nature, 2001, 4/4(6861), 338). The usage of semiconducting photocathodes for the direct reduction of NAD(P)⁺ has largely been unexplored. There is only one example of direct photoelectrochemical NAD(P)H regeneration at a semiconducting surface in literature. Stufano et. al. utilized p doped GaAs (p-GaAs) and p-GaP photocathodes for direct NADH regeneration (Stufano P et al. ChemElectroChem, 2017, (614), 1-9). They reported that the illuminated p-GaAs surface produced only dimeric species, while the p-GaP generated no reaction products whatsoever during electrolysis (Stufano P et al. ChemElectroChem, 2017, (614), 1-9). The authors speculated that the UV light used to excite the band-gap of p-GaP caused any reaction products to dissociate back to NAD⁺ (Stufano P et al. ChemElectroChem, 2017, (614), 1-9). Only after modification of the surface with the precious metals Ru and Pt, was enzymatically active NADH formed at the p-GaAs electrode (Stufano P et al. ChemElectroChem, 2017, (614), 1-9). The authors reported moderately high purity of 75% utilizing a Pt coated-p-GaAs electrode at a low overpotential of −0.75 V vs. Ag/AgCl (Stufano P et al. ChemElectroChem, 2017, (614), 1-9). The authors did not investigate the corrosion behavior of the electrodes.

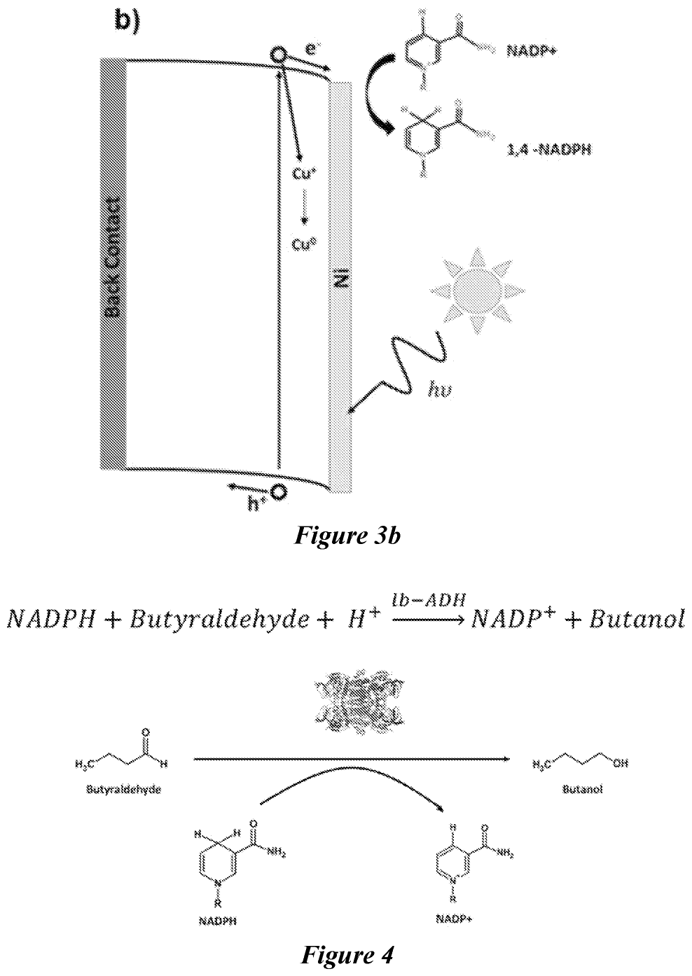

Another potential candidate for a photocathode is the inexpensive and earth-abundant material, cuprous oxide. Cuprous oxide possesses a direct band gap in the visible light region (1.9-2.4 eV) and a conduction band that lies negative of the NAD(P)⁺/NAD(P)H formal potential (FIG. 3a and FIG. 3b) (Kumar B et al. Annual Review of Physical Chemistry, 2012, 63(1), 541-569; Paracchino A et al. Nature Materials, 2011, 10(6), 456-461). Herein, the enzymatic assay used for determining NADPH purity is evaluated and the p-type semiconductor, Cu₂O, is investigated as a potential photocathode material for the direct photoelectrochemical regeneration of the phosphorylated nicotinamide, NADPH. It is shown herein that, with proper surface modification by the addition of Ni, Cu₂O electrodes are capable of producing high yields of enzymatically active 1,4-NADPH at low overpotentials. The effect of the light, however, will be shown to result solely in the photoelectrochemical reduction of the copper oxide layer, owing to the copper oxide reduction potential also being straddled by the band gap. The photoelectrochemical reduction process results in enhanced surface restructuring to a catalytic Ni/Cu nanoheterostructure capable of direct electrochemical regeneration of NADPH.

Materials and Methods

Electrode Preparation. The cuprous oxide photocathodes were prepared by a single step electrochemical process. A solution containing 0.48 M CuSO₄ 3 M Lactic Acid was prepared using copper sulfate pentahydrate (Sigma-209198), concentrated lactic acid (Ricca RABL0010-500A) and deionized water (18.2 MΩ·cm, Milli-Q). The pH of the solution was then adjusted to 11 with the addition of concentrated NaOH. The electrodeposition process was carried out potentiostatically at −0.5 V vs. Ag/AgCl (3 M NaCl, Basi MF-2052) and room temperature (20-25° C.) in a two-compartment cell separated by an agarose bridge (2% agar, Invitrogen 15110-019) and a coiled Pt wire counter electrode. The cathode chamber was filled with cupric lactate solution and the anode solution was filled with potassium phosphate buffer solution to prevent any Pt degradation or Cu adsorption. The Cu₂O electrodeposition reaction is given in equation 1.1, where L represents the lactate anion.

2CuL₂+2OH⁻+2e⁻→Cu₂O+H₂O+4L⁻ 1.1

Cu 100 mesh substrates (Alfa Aesar 45186) were chosen as the working electrodes as they are less expensive and provide a higher surface area to volume ratio than planar foils. Prior to deposition, Cu substrates were cleaned by sonication in 200 proof ethanol for 10 minutes followed by sonication in deionized water for 10 minutes. The substrates were dump rinsed in deionized water in between each sonication step. Finally, substrates were dried with compressed clean air. Ni modified Cu₂O electrodes were prepared by DC sputtering (Ebtec) a Ni target with Ar gas. The sputtering chamber height and inner diameter are 15 cm and 11.3 cm, respectively. The cathode (Ni target) and anode have diameters of 5.1 cm and 6.6 cm, respectively. Sputtering was conducted at 340 V at a working distance of approximately 3 cm between the sample and Ni target. Electrodes were sputtered for 96 hours on one side and 24 hours on the other. The Ni target was polished with 100 grit sandpaper before each sputtering session. Wires were attached to the Ni sputtered Cu₂O electrodes with conductive silver epoxy (MG Chemicals 8331) before being used in electrolysis experiments to reduce any uncompensated contact resistances (IR drops) in electrode potential measurements.

NADPH Regeneration. Bulk electrolysis of NADP⁺ solutions was carried out in a custom quartz H-cell with glass frit separator to mitigate light attenuation through the walls of the cell. Starting solutions of 1.5 mM NADP⁺ (Sigma-10128031001) were prepared in either a 0.5 M potassium-phosphate buffer (pH 7) or a 0.5 M sodium-phosphate buffer (pH 8). Phosphate buffers at pH 7 and 8 were selected due to their electrochemical conductivity and their supporting NADPH stability 9 Vuorilehto K et al. Bioelectrochemistry, 2004, 65(1), 1-7). The potentiostatic electrolysis was performed in 3-electrode setup with an Ag/AgCl (3 M NaCl) reference and Pt mesh (Alfa Aesar 10283) counter electrode. The Cu₂O photocathode was illuminated with a 10 mW (532 nm, frequency doubled YAG) laser light source. All photocathodes had approximately a 1 cm² illuminated geometric surface area and were illuminated on the side on which Ni was sputtered for 96 hours. To discern the purity and activity of the reaction products, enzymatic assay (see Description of Enzymatic Assay) was performed using Lactobacillus brevis alcohol dehydrogenase (Lb-ADH). All experiments were carried out by holding the Cu₂O cathode at a fixed electrode potential of −0.75 V (Ag/AgCl). Any geometric electrode areas are calculated assuming a grid of perfectly cylindrical wire.

The geometric surface area of meshes were calculated by assuming that the Cu wires in the mesh form a perfect orthogonal grid of cylinders (FIG. 27).

Assuming that the open space on the edges of the mesh has width O, the number of wires running horizontally and vertically can be estimated as follows in equations A.C.1 and A.C.2. Here, vertical running wires are denoted N_{W} and horizontal running wires are denoted N_{L}.

$${N}_{W} = \frac{W - 20 - D}{D + 0} + 1 = \frac{W - 0}{D + 0} \qquad A . C \text{.1}$$

$${N}_{L} = \frac{L - 20 - D}{D + 0} + 1 = \frac{L - 0}{D + 0} \qquad A . C \text{.2}$$

Now that the number of vertical and horizontal wires is estimated, the surface area of these wires is now calculated assuming perfectly cylindrical geometry. The surface area of vertical wires and horizontal wires is denoted as S_{L} and S_{W}, respectively. Only half of the circular end caps on the vertical wires are solution-immersed, hence the factor of ¼ present in equation A.C.3.

$${S}_{W} = π {N}_{W} D L + \frac{1}{4} π {N}_{W} {D}^{2} \qquad A . C \text{.3}$$

$${S}_{L} = π {N}_{L} D W + \frac{1}{2} π {N}_{L} {D}^{2} \qquad A . C \text{.4}$$

Finally, the wire crossings are assumed to cover up approximately D² on both cylindrical wires forming the intersection. Thus, the total, solution immersed geometric surface area (Sₜₒₜ) can be estimated in equation A.C.5.

Sₜₒₜ=S_{W}+S_{L}−2N_{W}N_{L}D² A.C.5

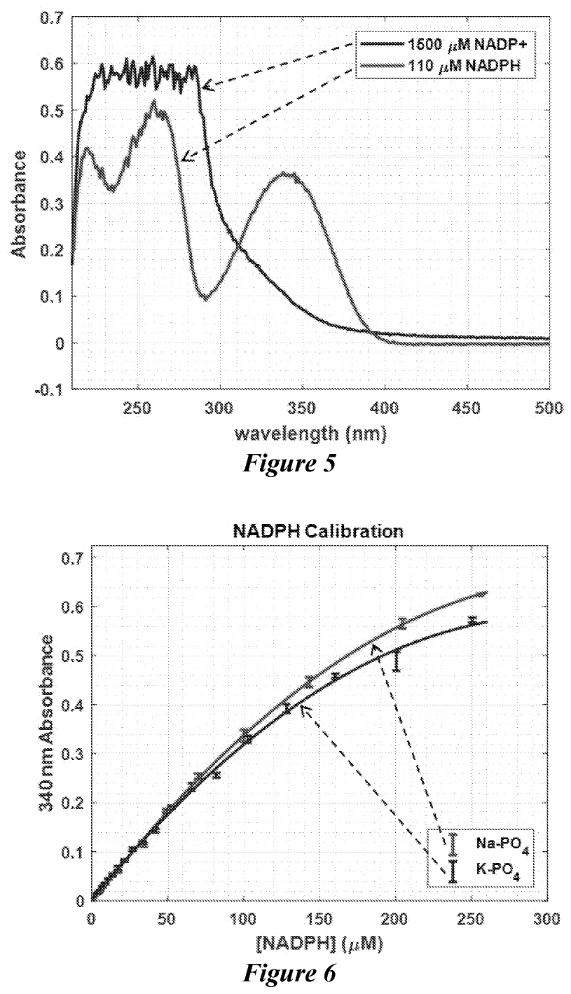

Description of Enzymatic Assay. The purity of electrolysis products was determined based on enzymatic assay. Here Lb-ADH was employed as the enzyme to catalyze the reduction of butyraldehyde to butanol with the concomitant oxidation of NADPH to NADP⁺ (FIG. 4). The working principle of the assay relies on the fact that the enzyme will only accept 1,4-NADPH as a cofactor along with the aldehyde substrate, rejecting any 1,6-NADPH or (NADP)₂ dimer present in solution. Thus, as the reaction proceeds, the characteristic absorbance of NADPH at 340 nm can be monitored to determine the presence of any enzymatically inactive products. The decrease in absorbance is only attributed to the consumption of 1,4-NADPH; any residual absorbance at 340 nm after the reaction stops is assumed to be due to enzymatically inactive products (1,6-NADPH, (NADP)₂, or any other potential isomers). Example absorbance spectra of NADPH and NADP⁺ is shown in FIG. 5.

After measuring the decrease in absorbance, the purity can be estimated by the method developed by Omanovich et al. applied to NADPH (Damian A et al. Chemical and Biochemical Engineering Quarterly, 2007, 21(1), 21-32; Ali I et al. The Canadian Journal of Chemical Engineering, 2017, 9999, 1-6; Azem A et al. Journal of Molecular Catalysis A: Chemical, 2004, 219(2), 283-299). The purity, Q, is calculated according to equation 2.1. The ratio between the initial and final 340 nm absorbance determines the fraction of total products that are enzymatically active. The initial absorbance of electrolysis products prior to initiating the reaction is denoted as A₀ and the absorbance after the reaction is completed (i.e. at a steady state) is denoted as A^{f}. The difference between the initial and final absorbance in the assay is just A_{1,4-NADPH} and the initial absorbance is A_{1,4-NADPH}+A_{1,6-NADPH}+A_{(NADP)}_{₂}. Using this, equation 2.1 is re-written in terms of each species equation 2.2. By invoking the Beer-Lambert Law, the absorbance can be related linearly to the concentrations by introducing the extinction coefficient, ε, yielding equation 2.3. Here, the extinction coefficients are assumed to be very similar for NADPH and its inactive forms, allowing ε to be dropped from equation 2.3. The extinction coefficients at 340 nm for non-phosphorylated nicotinamides are similar; they have been measured to be ε_{1,4-NADH}=6200 M⁻¹ cm⁻¹, ε_{NAD}_{₂}=7217 M⁻¹ cm⁻¹ and ε_{1,6-NADH}=6500 M⁻¹ cm⁻¹ (Leuchs S et al. Chemical and Biochemical Engineering Quarterly, 2011, 25(2), 267-281). The cuvette path length, 1, is also fixed and can be cancelled out. These assumptions allow the measured 340 nm absorbance to be correlated with concentrations. The NADPH concentration level, however, should be in the approximately linear absorbance regime in this analysis (see FIG. 6).

$$Q = 1 - \frac{{A}_{f}}{{A}_{0}} \qquad 2.1$$

$$Q = \frac{{A}_{1 , 4 - N A D P H}}{{A}_{1 , 4 - N A D P H} + {A}_{1 , 6 - N A D P H} + {A}_{{( N A D P )}_{2}}} \qquad 2.2$$

$$\approx \frac{{ε}_{1 , 4 - N A D P H} l [ 1 , 4 - N A DPH ]}{{ε}_{1 , 6 - N A D P H} l [ 1 , 6 - N A D P H ] + {ε}_{{( N A D P )}_{2}} l [ N A D {P}_{2} ] + {ε}_{1 , 4 - N A D P H} l [ 1 , 4 - NADPH ]} \qquad 2.3$$

$$\approx \frac{[ 1 , 4 - N A D P H ]}{[ 1 , 6 - N A D P H ] + [ {( N A D P )}_{2} ] + [ 1 , 4 - N A D P H ]} \qquad 2.4$$

The assay entails withdrawing an aliquot of electrolysis products and adding it to butyraldehyde. The initial absorbance at 340 nm is recorded. ADH is then added to the cuvette and mixed by inversion. The absorbance is continuously measured over time until a steady state is reached. The absorbance at steady state is then recorded and Q is calculated. The initial absorbance is adjusted according to the dilution upon adding the ADH. All absorbances are normalized (blanked) to a time zero aliquot that is made prior to beginning electrolysis. All spectrophotometric measurements were performed using a Thermo Scientific Evolution 300 UV-Vis spectrophotometer in quartz cuvettes. The enzymatic assay was first evaluated on an NADPH standard (MP Biomedicals 02101167) before being used to quantitate the purity of any electrolysis products.

Validation of Absorbance Measurement. Before testing on electrolysis products, the enzymatic assay was first evaluated on a prepared NADPH standard (MP Biomedicals 02101167). The first NADPH standard was prepared at a concentration of 150 μM in a 0.5 M potassium phosphate buffer (pH 7). An initial 340 nm absorbance measurement is made on a reference (blank) sample containing only phosphate buffer and 10 mM butyraldehyde (substrate) (FIG. 24). The reference solution is then discarded, and the buffer is replaced with 150 μM NADPH standard (also in 0.5 M potassium phosphate buffer). Ten mM butyraldehyde solution is also added to the cuvette and the initial absorbance is measured and recorded. The ADH enzyme is then added resulting in a final concentration of 0.83 μM ADH. The absorbance is continuously measured until a steady state is reached (FIG. 24). Since the reaction is initiated immediately upon manual addition of ADH, the absorbance measurements necessarily exclude some of the early time points in the assay. The resulting assay data is shown in FIG. 24. The purity (Q) value is calculated according to equation (2.1).

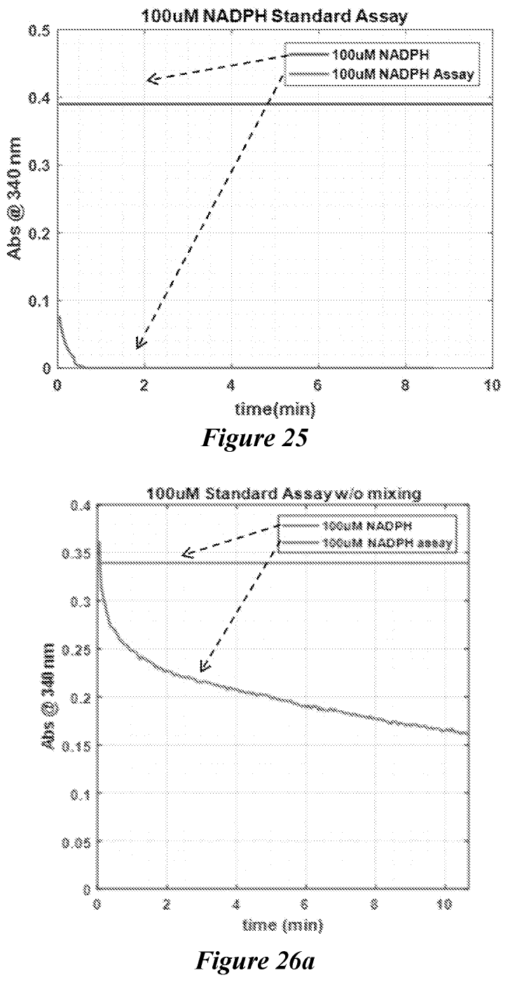

Reference to FIG. 24 shows that not all the absorbance was depleted during the experiment, implying that not all of the NADPH was converted back to NADP⁺ (Scheme 1). This disagrees with the manufacturer's published purity of the NADPH standard (99.7%). This can be due to the fact that the enzyme (Lb-ADH), may only be able to tolerate, or turnover, a certain amount of NADPH before losing its activity. To test this hypothesis, another experiment was performed with a 100 μM NADPH standard (FIG. 25). Here, the initial amount of NADPH was lowered, leading to a decreased initial absorbance. Upon addition of the 0.83 μM ADH and 10 mM butyraldehyde, the absorbance plummets and approaches the background level in less than 1 minute (FIG. 25). Thus, it was determined that the assay can only tolerate a certain amount of NADPH at a 0.83 μM ADH concentration before the enzyme ceases turning over.

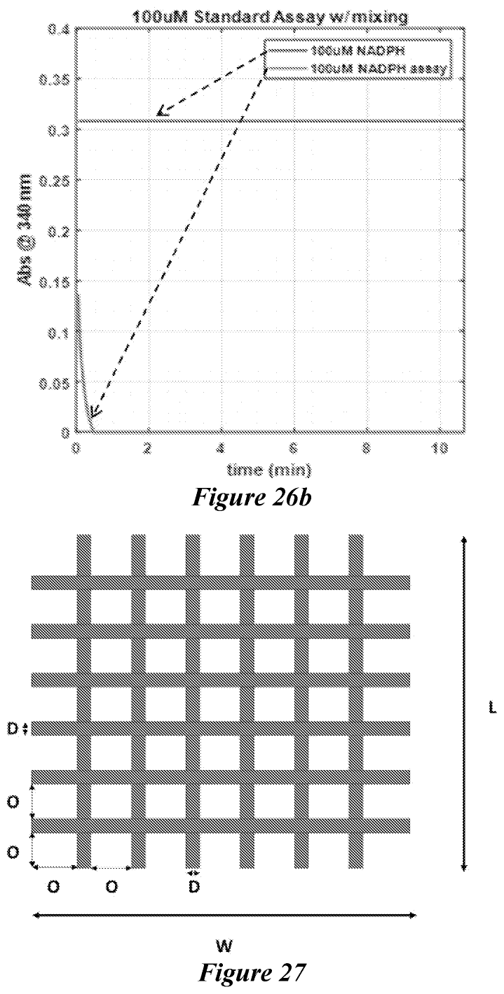

Effects of Cuvette Mixing. The effects of the cuvette mixing technique used in the assay were also explored on a standard. It was hypothesized that, since the enzyme must bind both to NADPH and butyraldehyde for reaction progression, the cuvette mixing technique could be important to optimize the duration of the reaction. To explore this notion, two additional 100 μM NADPH standards were prepared and assayed as described earlier. One standard was left unmixed after addition of ADH and the other was inverted 3 times prior to absorbance measurement. In FIG. 26a-FIG. 26b, it is apparent that cuvette mixing has a dramatic effect on the reaction. With no mixing, roughly half of the absorbance is depleted in 10 minutes. If the cuvette is mixed by inversion three times, the reaction proceeds significantly faster; the background absorbance level is reached in less than a minute. These results show that proper mixing is important to maximize the probability for both NADPH and butyraldehyde to interact with the enzyme in its active conformation.

### Experimental Results

Results Using the Enzymatic Assay

ADH Concentration Dependence of Assay. The enzymatic assay which was previously evaluated with NADPH standards was then tested on bulk NADP⁺ electrolysis products. Since electrolysis products will contain a mixture of NADP⁺ and NADPH in solution, an ADH concentration study was performed to determine if the presence of NADP⁺ would inhibit the enzyme performance. Electrolysis was performed at illuminated Ni/Cu₂O electrodes in 0.5 M potassium phosphate buffer until a measurable absorbance signal (0.1-0.3) in the approximately linear regime (FIG. 6) was obtained. The enzymatic assay was then carried out at varying concentrations of ADH. To better illustrate the assay procedure, Table 1 and Table 2 below shows the reactant volumes and concentrations for ADH concentrations of 0.83 μM and 2.00 μM, respectively. The column marked ‘ref.’ is the baseline which is subtracted in subsequent measurements.

TABLE 1
Volumes and concentrations of reactant species in an enzymatic assay
with an initial ADH concentration of 0.83 μM. A dash indicates that it
is not present in the measurement. An X indicates a variable amount.
The concentrations here are after all species are added to the cuvette.
This results in a dilution of the NADP⁺ in the t₀ sample from 1500 μM
to 1440 μM.

| | Ref. | | Initial | | Assay | |
|---|---|---|---|---|---|---|
| Species | V (μL) | [ ] (μM) | V (μL) | [ ] (μM) | V (μL) | [ ] (μM) |
| t₀ Sample | 336 | 1440 | — | — | — | — |
| (NADP⁺) | | | | | | |
| End Point | — | — | 331 | X | 331 | X |
| Sample | | | | | | |
| CH₃(CH₂)₂CHO | 14 | 10000 | 14 | 10145 | 14 | 10 |
| ADH | — | — | — | — | 5 | 0.83 |

TABLE 2
Volumes and concentrations of reactant species in an enzymatic assay
with an initial ADH concentration of 1.99 μM. A dash indicates that it
is not present in the measurement. An X indicates a variable amount.
cuvette. The concentrations here are after all species are added to the
This results in a dilution of the NADP⁺ in the t₀ sample from 1500 μM
to 1440 μM

| | Ref. | | Initial | | Assay | |
|---|---|---|---|---|---|---|
| Species | V (μL) | [ ] (μM) | V (μL) | [ ] (μM) | V (μL) | [ ] (μM) |
| t₀ Sample | 336 | 1440 | — | — | — | — |
| (NADP⁺) | | | | | | |
| End Point | — | — | 324 | X | 324 | X |
| Sample | | | | | | |
| CH₃(CH₂)₂CHO | 14 | 10000 | 14 | 10355 | 14 | 10 |
| ADH | — | — | — | — | 12 | 2.00 |

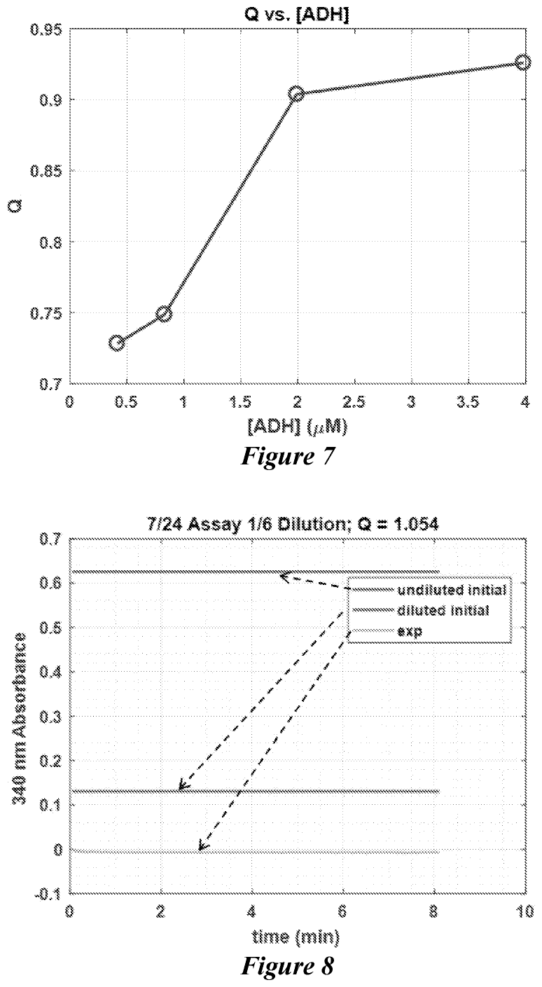

A total of four enzymatic assays were carried out at ADH concentrations of 0.415 μM, 0.83 μM, 1.99 μM and 3.98 μM. For each ADH concentration, the purity Q was calculated for the same electrolysis products (i.e. the same sample) and plotted as a function of ADH concentration. From FIG. 7, it can be seen that the calculated purity is indeed affected by the concentration of ADH used in the assay. Not surprisingly, as the ADH concentration increases, the calculated purity also increases reaching a maximum of 92.6%. These results suggest that the enzyme is inhibited by the presence of unreacted NADP⁺ and ADH should be used in excess to counteract these effects. Thermodynamically, this result is understandable as addition of NADP⁺ should result in a higher equilibrium concentration of NADPH in order to maintain the equilibrium constant of the reaction at a given temperature.

Effects of Dilution in Assay. The effects of sample dilution on the assay were also explored. Electrolysis was performed at a Ni/Cu₂O electrode in potassium phosphate buffer solution until the 340 nm absorbance reached the non-linear region (Abs>0.3). The sample was then diluted by a factor 1/6 in the final step of the enzymatic assay; the dilution factor is 1/6 accounting for all species in the cuvette in the final step of the assay. An enzyme concentration of 1.99 μM was utilized. The reactant volumes and assay results for this experiment are given in Table 3 and FIG. 8, respectively.

TABLE 3
Volumes and concentrations of reactant species in the diluted sample
assay. A dash indicates that it is not present in the measurement or
not reacting. An X indicates a variable amount. The concentrations
here are after all species are added to the cuvette
Assay with ⅙ Dilution

| | Ref. | | Initial | | Assay | |
|---|---|---|---|---|---|---|
| Species | V (μL) | [ ] (μM) | V (μL) | [ ] (μM) | V (μL) | [ ] (μM) |
| t₀ Sample | 336 | 1440 | — | — | — | — |
| (NADP⁺) | | | | | | |
| End Point | — | — | 58 | X | 58 | X |
| Sample | | | | | | |
| CH₃(CH₂)₂CHO | 14 | 10000 | 14 | 10000 | 14 | 10000 |
| ADH | — | — | — | — | 12 | 2.00 |
| buffer | — | — | 266 | — | 266 | — |

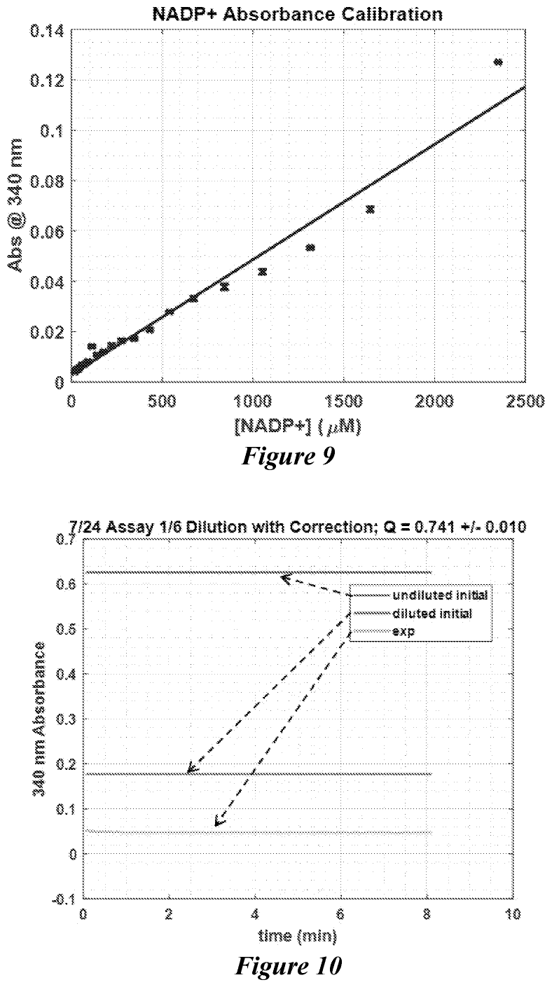

The fact that a purity value over 100% was obtained in FIG. 8 implies that the measurements may have been over-corrected, meaning that the reference solution has a higher than expected absorbance. In each of the measurements, the background absorbance (blank sample) is taken to be a to aliquot containing NADP⁺ along with the substrate butyraldehyde. NADP⁺ exhibits a 260 nm absorbance peak, thus it was hypothesized that the descending tail from the 260 nm peak (see FIG. 5) could be introducing some concentration dependence in the measurements. To further explore this idea, a calibration curve showing the absorbance-concentration behavior of NADP⁺ was collected (FIG. 9). Clearly, a concentration dependence in the 340 nm absorbance of NADP⁺ resulting from the tail of the 260 nm peak is seen. Since the to aliquot contains 1500 μM NADP⁺, these results show that too much absorbance was being subtracted out once the dilution was performed. For any aliquot directly taken from the electrolysis, the sum of the concentrations of NADP⁺ and NADPH can equal 1500 μM at most as it is a 1:1 stoichiometric ratio between the two. In the case of inactive products, the total can be less than 1500 μM. Consequently, when an aliquot is diluted and assayed, the maximum final NADP⁺ concentration can no longer be 1500 assuming the enzyme consumes every NADPH molecule. Since the to aliquot contains 1500 μM NADP⁺ (the actual reference sample contains 1440 μM after butyraldehyde addition), too much absorbance is subtracted from the sample. For instance, if a sample is diluted by a factor of 1/6, the maximum NADP⁺ concentration after assay is 250 μM.

Correcting the Purity Values. By performing a least-squares linear fit to the NADP⁺ calibration (FIG. 9), a correction factor for the Q calculation can be developed. This correction can be done by forming a prediction interval for the least squares fit and taking this to be the uncertainty at each [NADP⁺] (see below for uncertainty propagation). Using this information, the error in the correction factor can be estimated. The corrected expression for Q was developed by noting that the absorbance was over-subtracted in the assay. Thus, every measured absorbance needs to be shifted up by some fixed correction factor. Therefore, Q can be calculated as follows in equation 3.1, where C_{f} is the correction factor.

$$Q = 1 - \frac{{A}_{f} + {C}_{f}}{{A}_{0} + {C}_{f}} \qquad 3.1$$

The actual value of the correction factor will depend on the magnitude of the dilution used as well as the linear fit. For this assay, the sample was diluted by 1/6 and its initial maximum combined NADP⁺ and NADPH concentration was 1500 μM prior to dilution. The concentration of the reference sample is diluted from 1500 μM to 1440 μM after addition of butyraldehyde. If the predicted absorbance value from the least squares fit is denoted as A′([NADP⁺]) and the measured data is denoted as A([NADP⁺]), then the correction factor for this experiment will be C_{f}=A′(1440 μM)−A′(248.6 μM). The final concentration is 248.6 μM to account for the fact that a dilution exactly by 1/6 cannot be achieved when pipetting to whole microliter amounts (see Table 3).

A new Q value can now be calculated and compared to that of FIG. 8. Here it was found that the correction factor leads to a smaller overall Q value; from over 100% down to 74.1% (see FIG. 10). The estimated uncertainty in Q is δQ≈±1.0%. Clearly, the concentration dependence of the NADP⁺ has a strong effect on the assay result. This implies that, in addition to assaying at low NADPH concentrations, dilution must be avoided. Additionally, it can be beneficial to use less NADP⁺ as well to lower its overall background signal at 340 nm.

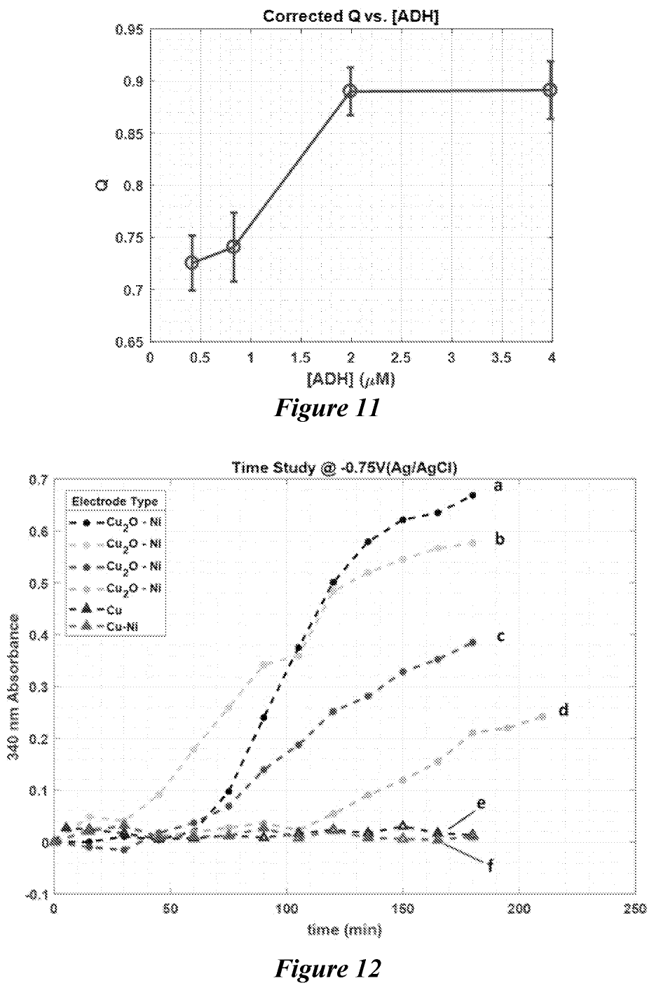

Referring back to Table 1 and Table 2, it can be seen that the end point sample is also slightly diluted compared to the to sample in obtaining the Q vs. [ADH] data in FIG. 7. The same method can be applied to correct and replot the data. With the correction factor applied, the maximum Q value is reduced from 92.6% to 89.1±2.8% when accounting for sample dilution in the last step of the assay. The correction in Q is largest at high ADH concentration where more volume must be added to the cuvette. At low concentration the effect is smaller; Q shifts from 72.8% to 72.5±2.6% at an ADH concentration of 0.415 μM. The corrected purity values are plotted in FIG. 11. These results suggest equating the to volume and end-point sample volume in the assay by addition of buffer solution to avoid diluting the sample and using the correction factor.

Uncertainty Propagation for Dilution Correction Factor in Enzymatic Assay

To calculate an error for the corrected purity values described above, the uncertainty in the correction factor must first be propagated. As a concrete example, the 1/6 dilution is considered where C_{f}=A′(1440 μM)−A′(248.6 μM). To start, the uncertainties in A′(1440 μM) and A′(248.6 μM) are added in quadrature. This gives the uncertainty in C_{f} as δC_{f}={square root over ((δA′(1440 uM))²+(δA′(248.6 uM))²)}. Before this quantity can be calculated, the uncertainties in the predicted absorbances must be known. These can be estimated by forming the 95% (α=0.05) prediction interval at the two absorbances (concentrations) of interest. This can be calculated as follows in equation A.B.1.

$$δ {A}^{′} = \pm {t}_{α / {2}^{, n - 2}} * S * \sqrt{1 + \frac{1}{n} + \frac{( [ {NADP}^{+} ] - {\overline{[ {NADP}^{+} ] )}}^{2}}{{SS}_{[ {NADP}^{+} ]}}} \qquad A . B . 1$$

In the above equation, t_{α/}_{₂}_{,n-2} is the critical t value, S is the mean square error, SS_{[NADP}_{^{+]}} is the sum of squares for the independent variable, and n is just the number of data points. The over-bar represents the arithmetic mean of the discrete data set. Mathematically, these can be expressed in the following equations (Hirsch R M et al. Technometrics, 2002, 36(3), 323). With δC_{f} now known, the uncertainty in Q, δQ, can finally be calculated as δQ=(∂Q/∂C_{f})δC_{f}.

$$S = \sqrt{{\sum }_{i = 1}^{n} \frac{{( {A}_{i} - {A}_{i}^{′} )}^{2}}{n - 2}} \qquad A . B \text{.1}$$

$$S {S}_{[ {NADP}^{+} ]} = {\sum }_{i = 1}^{n} {( {[ {NADP}^{+} ]}_{i} - \overline{[ {NADP}^{+} ]} )}^{2} \qquad A . B \text{.2}$$

NADP⁺ Reduction Kinetics

Temporal Studies of NADP Reduction. Time-course studies were employed to qualitatively elucidate the effects of light (532 nm laser irradiation) in the reduction of the NADP⁺. The progress of the reaction was monitored spectrophotometrically by measuring absorbance at 340 nm as a function of time. The experiments were conducted by performing bulk electrolysis and sampling small-volume aliquots from the electrochemical cell and measuring their absorbance at regular 15-minute intervals. To avoid reactant depletion, the aliquots were returned to the cell prior to the next measurement. Additionally, care was taken to aliquot from the same location and the solution was stirred to avoid concentration gradient effects in the measurement. Electrolysis experiments were performed potentiostatically at −0.75 V (Ag/AgCl) in 0.5 M sodium phosphate buffer solution. For experiments conducted in the dark, i.e. in the absence of laser irradiation, a heavy black sheet was placed over the experimental apparatus.

The first time-course study utilized a Ni/Cu₂O/Cu electrode, which was under illumination for the entire duration of the experiment (FIG. 12, curve (a)). Interestingly, the reaction showed almost no progress for the first hour. After 60 minutes, increasing amounts of NADP⁺ reduction products began to be detected. Even though no reaction products are detected in the first hour, a significant amount of cathodic current is passed during this time frame. Therefore, it is hypothesized that the role of the light can be to prepare or modify the electrode surface via photo-reduction of the oxide layer back to elemental Cu. To investigate this idea further, a time-course study experiment was performed in which there was no laser illumination for the first hour, then the electrode was illuminated with the 532 nm laser irradiation for the remaining two hours at a Ni/Cu₂O/Cu electrode (FIG. 12, curve (c)). The result for this case was quite similar to that of curve (a) in FIG. 12; approximately no reaction products for the first hour, after which NADP⁺ reduction begins to set in. This result is, however, subject to different interpretations. One conclusion that can be drawn is that the light is still needed for NADP⁺ reduction as the reaction proceeds approximately when the light is turned on. Another possible conclusion is that the reduction of the oxide layer can take place in the dark, thus it would not have mattered if the laser irradiation were turned on at 60 minutes or not.

The second possibility was explored by performing electrolysis at a Ni/Cu₂O/Cu electrode entirely in the dark (curve (d), FIG. 12). Thus, it can be seen that purely electrochemical NADP⁺ reduction can occur at a non-illuminated Ni/Cu₂O/Cu electrode. The initial dead period, however, was extended to approximately 110 minutes versus 60 minutes. This finding implies that the 532 nm laser irradiation can be accelerating the reduction of the oxide layer, and not participating in the Faradaic reduction of NADP⁺. This idea was tested by performing an experiment in which the Ni/Cu₂O/Cu was irradiated by 532 nm laser radiation and potentiostatically held at −0.75 V (Ag/AgCl) for 1 hour in sodium phosphate buffer solution only (curve (b) in FIG. 12). After 1 hour, the laser was shut off and NADP⁺ was added to the solution. The NADP⁺ reduction reaction proceeds immediately after 1 hour of light-mediated surface modification, showing no dead period that pristine electrodes show initially t=0. These results suggest that the role of the light is solely to enhance the reduction of the oxide layer or other modification of the surface; the photogenerated electrons show a preference to reduce the oxide layer in the electrode rather than reduce nearby NADP⁺ molecules in solution. This can be explained by examining the equilibrium potentials for both reactions (FIG. 3a)). The Cu⁺¹ cation offers a more favorable energy transition for the electrons in the conduction band of the material. After the oxide material has been depleted, direct electrochemical reduction of NADP⁺ occurs.

The kinetics of the cofactor regeneration using the electro-reduced Ni/Cu₂O/Cu electrode were then compared to the bare substrate Cu mesh and Ni coated Cu mesh. Surprisingly, both the bare substrate mesh as well as the Ni coated Cu mesh show no activity for electrochemical NADP⁺ reduction at −0.75 V (Ag/AgCl) (FIG. 12, curves e and f). The reduction of NADP⁺ has previously been confirmed to occur at a plane Cu surface, although this was at greater cathodic overpotentials (<−0.95 V (Ag/AgCl)) (Weckbecker A et al. Biosystems Engineering I. Springer Berlin Heidelberg. 2010. pp. 195-242). The low-overpotential NADP⁺ reduction at Ni/Cu₂O/Cu electrode suggests that the initial surface modification process creates a catalytic nanoheterostructure, owing to nanoscale Cu structuring from the reduction of the oxide layer. Previous attempts in preliminary experiments to reduce NADP⁺ at Cu₂O/Cu electrodes (no Ni) also showed no activity.

TABLE 4
Electrode and experiment descriptions for FIG.
12. Cu denotes mesh substrate material.

| | Electrode | |
|---|---|---|
| Curve | Description | Experiment Description |
| a | Ni/Cu₂O/Cu | Light on t ≥ 0 hr |
| b | Ni/Cu₂O/Cu | Light on −1 hr ≤ t < 0 hr; Light off t ≥ 0 hr |
| c | Ni/Cu₂O/Cu | Light off 0 hr ≤ t < 1 hr; Light on t ≥ 1 hr |
| d | Ni/Cu₂O/Cu | Light off t ≥ 0 hr |
| e | Cu | Light off t ≥ 0 hr |
| f | Ni/Cu | Light off t ≥ 0 hr |

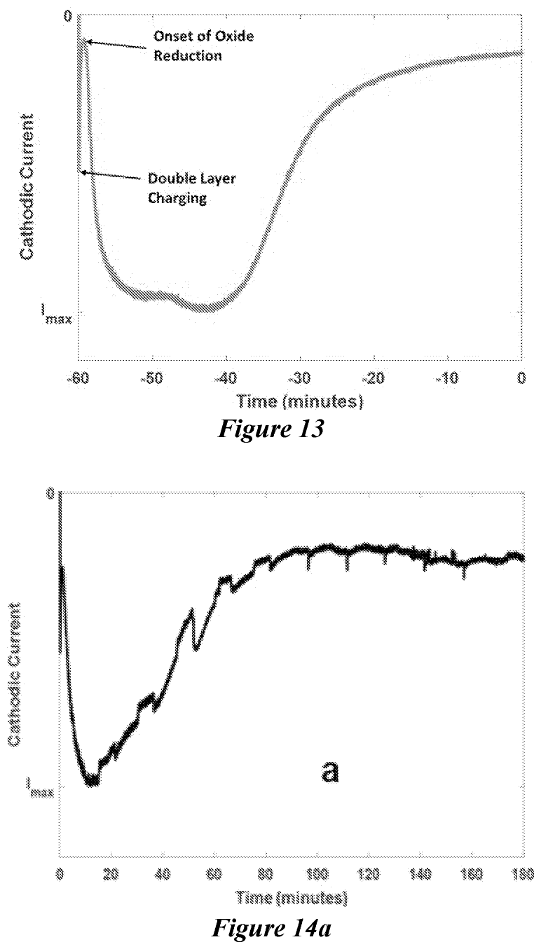

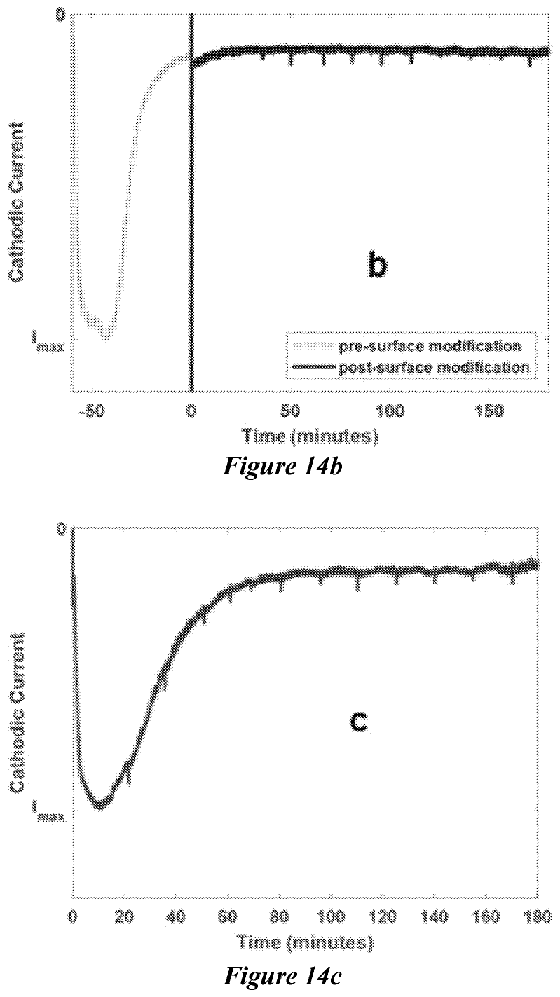

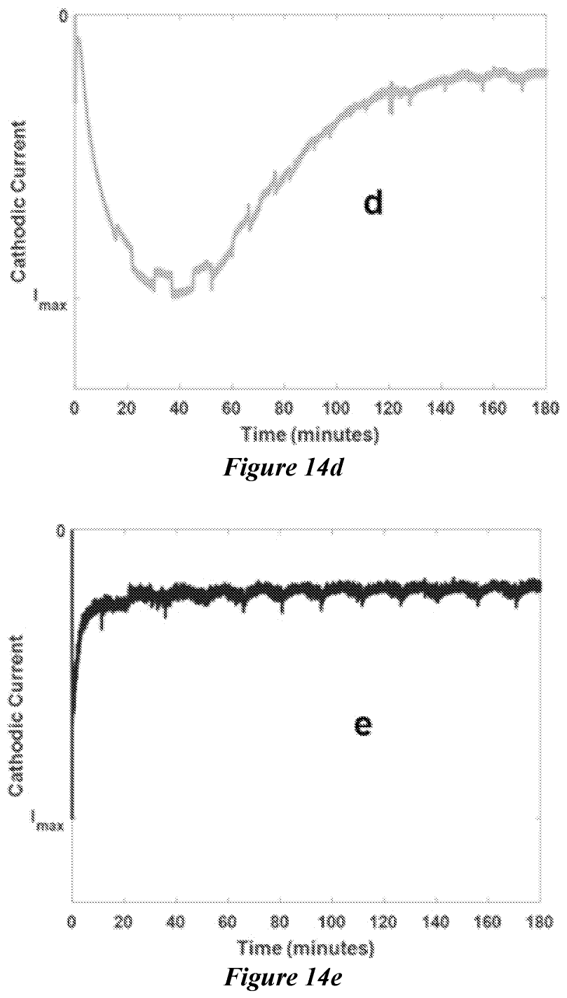

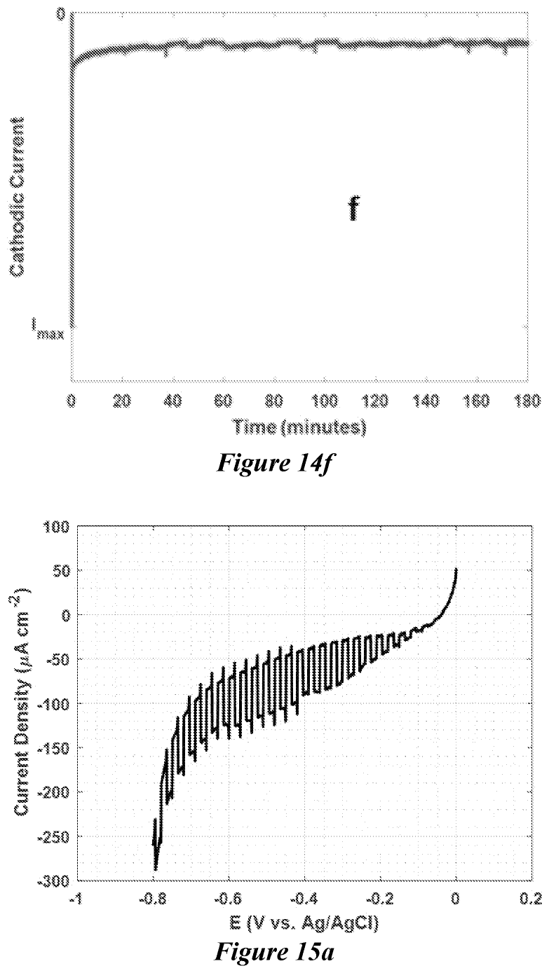

Investigation of the Role of Irradiation. The role of the light in the reduction reaction was further corroborated by examining the chronoamperometric current traces, one of which is shown in FIG. 13, in each of the time studies depicted in FIG. 12. The curves which utilize the Ni/Cu₂O/Cu electrodes all show very similar behavior. During approximately the first hour, the current increases to a maximum before tapering off and showing quasi-steady behavior. Despite the fact that a significant amount of current is passed in that time frame, no NADP⁺ is reduced. Since no bubbling is observed during the experiment, evolution of H₂ gas is most likely not occurring. Thus, this current is attributed to the reduction of the copper oxide layer, after which, NADP⁺ begins to be reduced. Zooming in on this region reveals a few other interesting attributes, as can be seen in FIG. 13. The electrode is initially polarized from open circuit conditions leading to an initial sharp increase in current used to charge up the double layer. The capacitive portion of the current decays before the reduction of the oxide sets in, causing an even sharper increase in the current. This current eventually decays as well, as the oxide is consumed. This trend is present with or without NADP⁺ present in the electrolyte as shown in FIG. 14a-FIG. 14f. Examination of the Cu and Ni/Cu current traces show markedly different behavior. There is an initial capacitive polarization current which then decays and shows quasi steady behavior. It is assumed that the noise in the signal is introduced by disturbing the system when taking and returning samples for absorbance measurements in the time study.

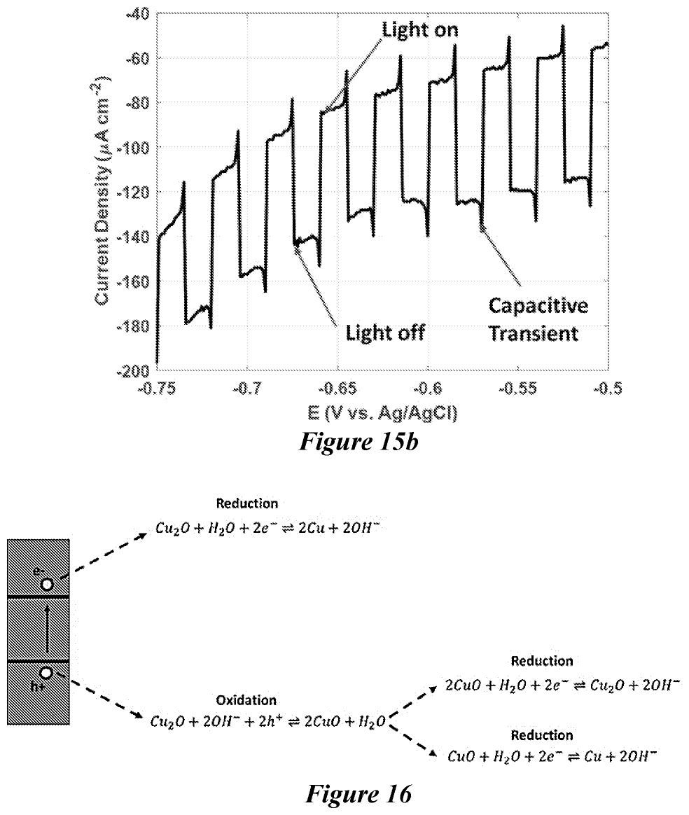

Photocurrent measurements were also performed to further investigate the role of laser irradiation in the NADP⁺ reduction process (FIG. 15a and FIG. 15b). These measurements were done in a single compartment electrochemical cell with sodium phosphate buffer solution only as the electrolyte. The Ni/Cu₂O/Cu electrode was scanned linearly from 0 V to −0.80 V (Ag/AgCl) at a rate of 5 mV/s and the resulting current through the cell was recorded. As the electrode potential was swept, the light source (532 nm laser) was mechanically chopped at the electrode surface at a frequency of 1/6 Hz (3 seconds on, 3 seconds off) with a programmable shutter.

From the data in FIG. 15a and FIG. 15b, it is evident that light elicits a clear response in the current through the electrode. As the light source is switched on, a sudden increase in cathodic current is measured, followed by another drastic decrease as the light is switched off. The difference in currents with the light on and off is the photocurrent driven by drift due to the band bending within the semiconducting Cu₂O layer. Transient capacitive behavior is present in the current trace and the photocurrent shows a quick decay as the light is switched on. This is a result of the separated electron hole pairs tending to positively polarize the electrode. It can be seen that the sample yields photocurrent densities of approximately −60 μA cm⁻² (normalized to solution-immersed electrode area) under 10 mW green (532 nm) irradiation with an onset potential around −0.10 V (Ag/AgCl).

Chemically, since the experiment is carried out in inert buffer, the photo-generated electrons could potentially split the H₂O solvent or reduce Cu₂O (assuming negligible amounts of other redox species, such as dissolved O₂ gas) if there is no recombination. Once again, no bubbling is observed, so the measured photocurrent is attributed to reduction of the oxide layer. Furthermore, it can be seen that the dark trace (the top portion of the current oscillations) does not show purely capacitive charging behavior (neglecting the transient portions). Ideal semiconductors should act as capacitors and show a constant charging current depending on the scan rate since I_{C}=C dV/dt in the absence of faradaic reactions (Bott A W et al. Current Separations, 1998, 17(3), 87-91). With the electrode described herein, this current steadily increases as electrode potential decreases and then sharply increases beyond −0.7 V (Ag/AgCl). The presence of this current corroborates the dark reduction observed in FIG. 12 curve d. Thus, reduction of the oxide is possible in the dark, with the presence of light apparently enhancing the reaction by lowering its overpotential.

### Discussion of Results

Enzymatic Assay

Improved Quantification with the Enzymatic Assay. The enzymatic assay employed here, originally developed by Omanovich et al for NADH, is what is commonly applied in the literature for the determination of nicotinamide purity (Damian A et al. Chemical and Biochemical Engineering Quarterly, 2007, 21(1), 21-32; Ali I et al. The Canadian Journal of Chemical Engineering, 2017, 9999, 1-6; Azem A et al. Journal of Molecular Catalysis A: Chemical, 2004, 219(2), 283-299). The work here has demonstrated a host of issues with this purity quantification scheme. The primary concern is the fact that NADP⁺, the oxidized nicotinamide, also absorbs at 340 nm along with NADPH. Consequently, the absorbance measurement in the assay primarily includes contributions from NADPH, NADP⁺ and any inactive forms such as the (NADP)₂ dimer. This ultimately will lead to errors in the calculation of Q in the event of impure electrolysis products. This expectation is illustrated mathematically assuming the inactive products consist of (NADP)₂ dimer, no dilutions are performed in the assay and the enzyme turns over all NADPH molecules supplied to it. Each measurement includes background subtraction of the reference sample.

$$Absorbance Measurement Step 0 ( Ref . Sample )$$

$${A}^{0} = {A}_{{NADP}^{+}}^{0} \qquad 4.1$$

$$Absorbance Measurement Step 1$$

$${A}^{1} = ( {A}_{NADPH}^{1} + {A}_{{NADP}_{2}}^{1} + {A}_{{NADP}^{+}}^{1} ) - {A}_{{NADP}^{+}}^{0} \qquad 4.2$$

$${ϵ}_{1} ≡ {A}_{{NADP}^{+}}^{0} - {A}_{{NADP}^{+}}^{1} > 0 \qquad 4.3$$

$${A}^{1} = ( {A}_{NADPH}^{1} + {A}_{{( NADP )}_{2}}^{1} ) - {ϵ}_{1} \qquad 4.4$$

$$Absorbance Measurement Step 2 ( After Enzymatic Reaction Complete )$$

$${A}^{2} = ( {A}_{{( NADP )}_{2}}^{1} + {A}_{{NADP}^{+}}^{2} ) - {A}_{{NADP}^{+}}^{0} \qquad 4.5$$

$${ϵ}_{2} ≡ {A}_{NADP +}^{0} - {A}_{NADP +}^{2} \geq 0 \qquad 4.6$$

$${A}^{2} = {A}_{{( NADP )}_{2}}^{1} - {ϵ}_{2} \qquad 4.7$$

$$Q = 1 - \frac{{A}_{{( NADP )}_{2}}^{1} - {ϵ}_{2}}{( {A}_{NADPH}^{1} + {A}_{{( NADP )}_{2}}^{1} ) - {ϵ}_{1}} \qquad 4.8$$

In this notation, A represents the absorbance with the superscript denoting the step in the enzymatic assay and the subscript denoting the species contributing the absorbance. In measurement step 2, an aliquot is being measured directly from the electrochemical cell which contains a mixture of NADP⁺, NADPH including potentially some dimer. The signal attributed to any residual NADP⁺ is then lumped into an error term denoted by ∈. The enzyme is then added in measurement 3 and the reaction is run to completion. It is presumed that all NADPH is converted back to NADP⁺, leaving only NADP⁺ and dimer contributions in the measurement. Once again, the NADP⁺ signal is lumped into an error term. This leads to the more physically realizable definition of Q in equation 4.8. The initial and final absorbances in equation 2.1, which were assumed to be only inactive species and NADPH, now include additional error terms. It is clear in equation 4.8 that if the electrolysis products are pure then Q=1 since A_{NADP+}⁰=A_{NADP+}² and A_{NADP}_{₂}¹=0 is still obtained and if no inactive products are formed. In the event of impure electrolysis products, the error terms become relevant leading to deviations in Q. These deviations in Q can potentially be reduced by lowering the initial amount of NADP⁺ added to the electrochemical cell. In this work, 1.5 mM NADP⁺ was utilized for all electrolysis experiments, which contributes a significant absorbance. Lowering this amount while holding A¹ in the experiment constant reduces both error terms in equation 4.8. The discussion here is only relevant for undiluted aliquots; if the sample (measurement 1) is diluted, A_{NADP+}² can never be equal to A_{NADP+}⁰ as less NADPH is available to be converted back to NADP⁺. If a pure sample is produced, i.e. A_{NADP}_{₂}¹=0, and diluted, the right hand side of equation 4.8 also becomes negative. This leads to the over-blanking phenomenon observed earlier which yields Q values greater than 1.

The more experimentally accurate definition of Q in equation 4.8 can be compared to the idealized definition in equation 2.1 by analyzing it as an inequality. Since ∈₂≤∈₁ (equality in the case of totally impure electrolysis products), the experimentally accurate definition is expected to yield smaller values than the idealized definition. An inequality can now be set up with equation 4.8 and equation 2.1.

$$1 - \frac{{A}_{{NADP}_{2}}^{1} - {ϵ}_{2}}{( {A}_{NADPH}^{1} + {A}_{{( NADP )}_{2}}^{1} ) - {ϵ}_{1}} \leq 1 - \frac{{A}_{{NADP}_{2}}^{1}}{( {A}_{NADPH}^{1} + {A}_{{( NADP )}_{2}}^{1} )} \qquad 4.9$$

The inequality in equation 4.9 can then be multiplied by (A_{NADPH}¹+A_{(NADP)}_{₂}¹)[(A_{NADPH}¹+A_{(NADP)}_{₂}¹)−∈₁] and simplified to yield ∈₂≤∈₁. Since it is true that ∈₂≤∈₁, it is confirmed that the definition of Q in equation 4.8 yields smaller values than the definition in equation 2.1. Therefore, the assay, as performed experimentally, will underestimate the purity of the electrolysis products if no dilution is performed and the enzyme turns over all NADPH molecules. Of course, the values should match in the case of 100% pure electrolysis products as both numerators in equation 4.8 and equation 2.1 vanish.

Enzyme Stability and Thermodynamics

Another assumption in the enzymatic assay is that the enzyme can utilize all NADPH molecules in the reaction. In evaluating the assay on even just a standard NADPH solution, it was found that if the NADPH concentration were too high for a given ADH concentration, the reaction would cease with residual absorbance at 340 nm, implying that some NADPH remains even when the standard is pure. This problem was exacerbated by introducing NADP⁺, causing Q to depend on ADH concentration. Two potential causes are enzyme deactivation and thermodynamic equilibrium.

Lb-ADH has been demonstrated to be active in potassium phosphate buffer, however, the concentration of the buffer and pH can have adverse effects on its stability. Higher K-PBS buffer concentrations and higher pH tends to reduce the half-life of Lb-ADH. The optimum conditions have been shown to be [K-PBS]<0.5 M and 6.5<pH<7, showing that the tests here were operating at the limits of these ranges (Kohlmann C et al. Green Chemistry, 2011, 13(6), 1430-1436; Leuchs S et al. Green Chemistry, 2013, 15(1), 167-176). The reversibility of the enzymatic reaction raises a roadblock. Lb-ADH can be used to both oxidize NADPH and reduce NADP⁺, thus the final nicotinamide concentrations in the assay should be governed by the equilibrium constant, K, of the reaction, given in equation 4.10. This implies that the reaction should not convert all NADPH molecules into NADP⁺ molecules, only to the degree in which K can be satisfied at a given temperature.

$$K ( T ) = \frac{[ {NADP}^{+} ] [ {CH}_{3} {( {CH}_{2} )}_{3} OH ]}{[ NADPH ] [ {H}^{+} ] [ {{CH}_{3} ( {CH}_{2} )}_{2} CHO ]} \qquad 4.1$$

If the reaction is in equilibrium at a given temperature, a few strategies can be used to help drive the reaction to the right-hand side, i.e. favoring production of NADP⁺. Examining the reaction in FIG. 4, suggests that a more acidic pH, increasing proton concentration, will help drive the reaction toward the right-hand side by Le Chatelier's Principle. The same argument holds for reducing the initial concentration of NADP⁺, which works to alleviate some of the uncertainties in the assay quantification scheme as well. A more acidic pH also reduces Cu₂O stability in favor of Cu, which can help enhance or accelerate the initial restructuring of the electrode (Beverskog B et al. Journal of the Electrochemical Society, 1997, 144(10), 3476-3483). The only drawback of a more acidic pH is slightly reduced NADPH stability (Wu J T et al. Clinical Chemistry, 1986, 32(2), 314-319). These findings suggest that it may be worthwhile to investigate pH dependence in the enzymatic assay in addition to lowering the starting NADP⁺ concentration.

At present, separate experiments (two different electrodes) have yielded purity values of 89.1% and 74.1% in the enzymatic assay, confirming that the electrodes are capable of producing enzymatically active NADPH. These results are impressive compared to what is reported in the literature.

NADP⁺ Reduction Kinetics

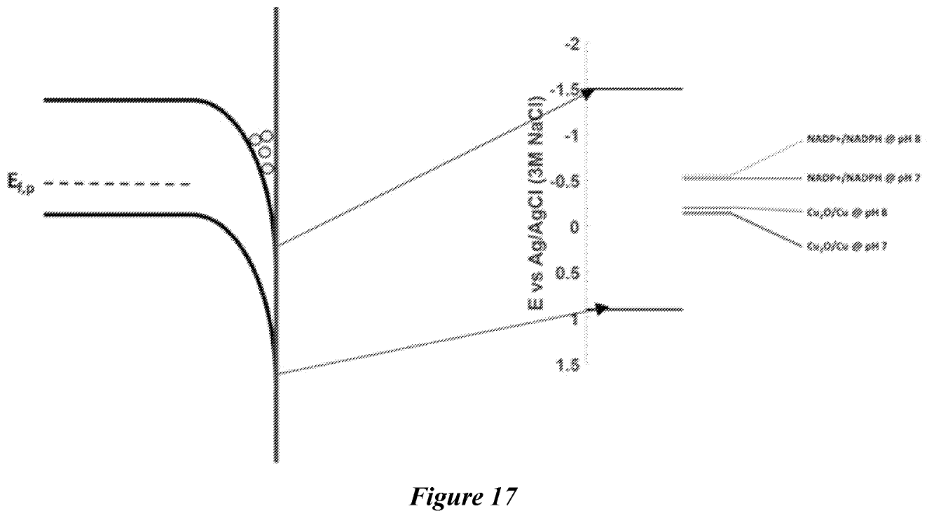

Photoelectrochemistry of Cu₂O. The time studies collected in FIG. 12 have been useful for distinguishing the effects of laser illumination on the reduction of NADP⁺ at Ni/Cu₂O/Cu electrodes. It is apparent that light induces measurable effects on current flow, however, the usefulness of these photogenerated carriers appears to be in the restructuring of the electrode rather than in reducing NADP⁺ to NADPH. Aside from potentially reducing NADP⁺ on the solution side, there are several competing reactions at play in which the photogenerated carriers can participate. The conduction band electron can, together with a water molecule (or proton) from the solution side, reduce the oxide. Holes left in the valence band can potentially oxidize Cu₂O present in the electrode to CuO, which can then be reduced back to Cu₂O or Cu (Leuchs S et al. Chemical and Biochemical Engineering Quarterly, 2011, 25(2), 267-281; Nakayama S et al. Journal of The Electrochemical Society, 2007, 154(1), C1; Su Y Y. Journal of The Electrochemical Society, 1994, 141(4), 940). Under the influence of a cathodic (i.e. negative) bias, the electrode is continuously injected with electrons from the external circuit which increases the tendency to ultimately form pure Cu from the Cu⁺¹ cation. The equilibrium potentials and band positions in FIG. 17 show Cu formation from Cu₂O is preferred compared to NADPH formation as the Cu₂O/Cu redox potential lies positive relative to the NADP⁺/NADPH potential. Considering this, it is reasonable to ascribe the large cathodic currents passed during bulk electrolysis to be due to surface modification of the electrodeposited Cu₂O layer back into pure Cu.

Carrier Transport Mechanisms for Cu₂O Reduction. Examination of the time studies in FIG. 12 also show that NADP⁺ reduction can occur under purely dark conditions, albeit with a longer incubation period. This suggests that the oxide reduction can occur purely by virtue of the bias applied by the potentiostat during electrolysis. One physical explanation for this observation is that the semiconducting material is forming an inversion layer at the electrolyte interface under dark conditions. Here, the potentiostat maintains a reverse bias to the semiconducting material by injecting electrons, raising the bulk Fermi level (or quasi-hole Fermi level) of the semiconductor. The conduction and valence band edges at the solution interface remain pinned. As the bulk Fermi level is continuously raised, electrons can begin to accumulate in the conduction band at the interface. As the electron concentration is increased, the semiconductor begins to exhibit local n-type behavior. Thus, at the interface, the semiconductor behaves as a metal and the electrons in the conduction band can participate in reduction of Cu₂O. The band diagram for this situation is depicted in FIG. 17. The population of the conduction band by electrons can occur via tunneling breakdown. As the reverse bias is increased, the energy level of the valence band maximum increases relative to the band edges at the electrolyte interface. Once the bias is sufficient, valence band electrons can tunnel through the band gap and reach the conduction band near the interface. The strong electric field in the space charge layer separates the resulting electron-hole pair and impels electrons to the electrolyte interface. Conduction band electrons at the interface can then attack the oxide layer. Similarly, valence band electrons can tunnel directly for available Cu⁺ states near the interface.

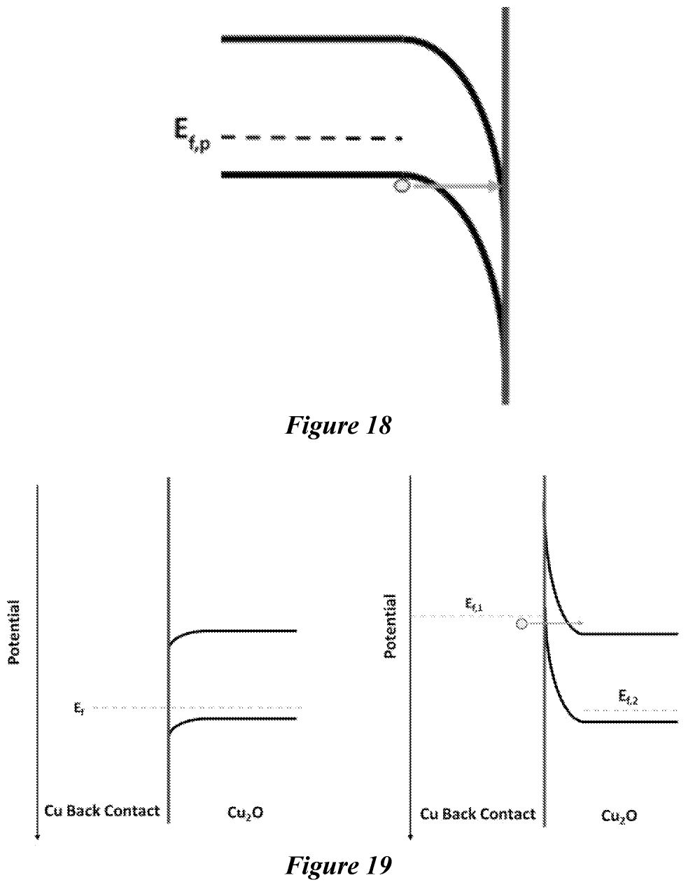

In addition to the possibility of inversion layer formation at the semiconductor electrolyte interface, the dark behavior could also be explained by examining the metal (Cu back contact) semiconductor interface. In this view, the semiconductor forms a depletion layer at the metal contact initially at thermal equilibrium. The potentiostat then applies a large negative bias to the metal contact. If the bias is sufficient enough, the Fermi level of the Cu back contact can rise above that of the conduction band of the semiconductor in the bulk. Electrons residing in Cu can then tunnel through the band gap and into a lower energy state in the conduction band of the Cu₂O. Once there, the electron can diffuse into the space-charge region near the electrolyte interface and potentially reduce the oxide layer. The tunneling effect is similar to the operation of a Zener diode. This is illustrated in the band diagram in FIG. 18 and FIG. 19.

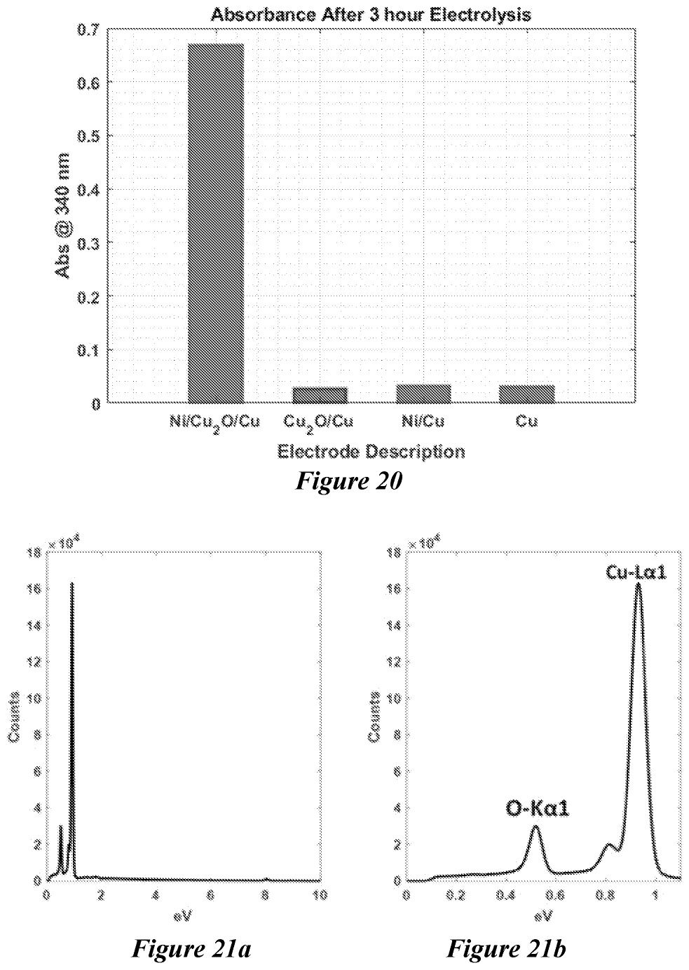

One other finding in the time study data presented in this work is that, while it appears the electrode is being reduced back to Cu, the substrate Cu is unable to reduce NADP⁺. This is the case with or without a sputtered Ni coating. Other preliminary experiments have shown negligible activity at a Cu₂O electrode with no Ni coating (see FIG. 20). This suggests two possibilities: the oxide-derived Cu is morphologically different than the substrate Cu and that the oxide-derived Cu (OD-Cu) and sputtered Ni behave synergistically to reduce NADP⁺. Li et al. have previously demonstrated that Cu prepared by electrochemically reducing micron thick copper oxides shows strong catalytic activity for CO₂ reduction when compared to native Cu (i.e. not prepared by electrochemical reduction of copper oxide) (Li C W et al. Journal of the American Chemical Society, 2012, 134(17), 7231-7234; Li C W et al. Nature, 2014, 508(7497), 504-507). The authors ascribed these results to the formation of nanocrystalline Cu from the oxide lattice. Ni has also previously been used as a catalyst to aid in reducing NADP⁺ to enzymatically active NADPH by providing a strong metal-hydrogen bond at the electrode surface to allow for protonation (Ali I et al. The Canadian Journal of Chemical Engineering, 2017, 9999, 1-6; Nørskov J K et al. Journal of The Electrochemical Society, 2005, 152(3), J23; Gong M et al. Nano Research, 2016, 9(1), 28-46). To further investigate the catalytic properties of the electrode, a materials study was carried out next.

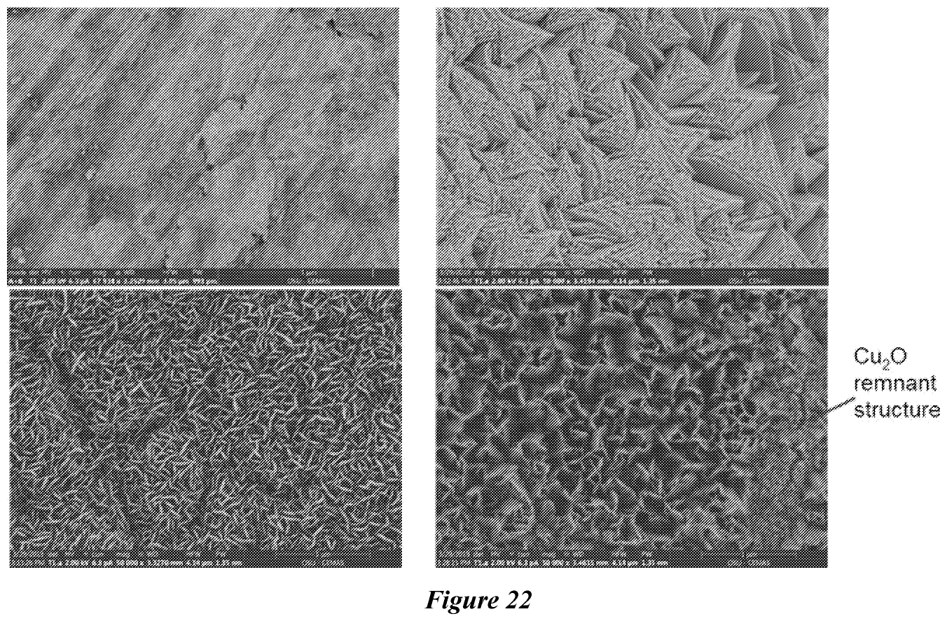

Characterization of Electrode Material. Analysis by SEM imaging and EDS on the electrodes reveals some interesting information. Four separate conditions were imaged by SEM: bare substrate Cu, bare Cu₂O/Cu (electrodeposited Cu₂O only, no Ni sputtered), untreated Ni/Cu₂O/Cu (sputtered Ni on electrodeposited Cu₂O), and treated Ni/Cu₂O/Cu (photoelectrochemically reduced Ni/Cu₂O/Cu). The bare Cu₂O/Cu, untreated Ni/Cu₂O/Cu, and treated Ni/Cu₂O/Cu samples were each collected from the same electrode during the electrode preparation. The corresponding SEM images are displayed in FIG. 22. Examination of the SEM images show a relatively smooth substrate Cu surface. After electrodeposition, the as-is Cu₂O (no Ni coat) tends to form triangular crystalline columns. The surface morphology then changes after the sputtering procedure. The regular crystalline structure transforms to finger-like projections weaving across the electrode surface. This surface morphology is altered after the photoelectrochemical reduction process, resulting in a more flaky appearance. Interestingly, it appears that some of the triangular crystalline structure of the bare Cu₂O is retained following sputtering and photoelectrochemical reduction upon examining the right side of the SEM image of treated Ni/Cu₂O/Cu electrode.

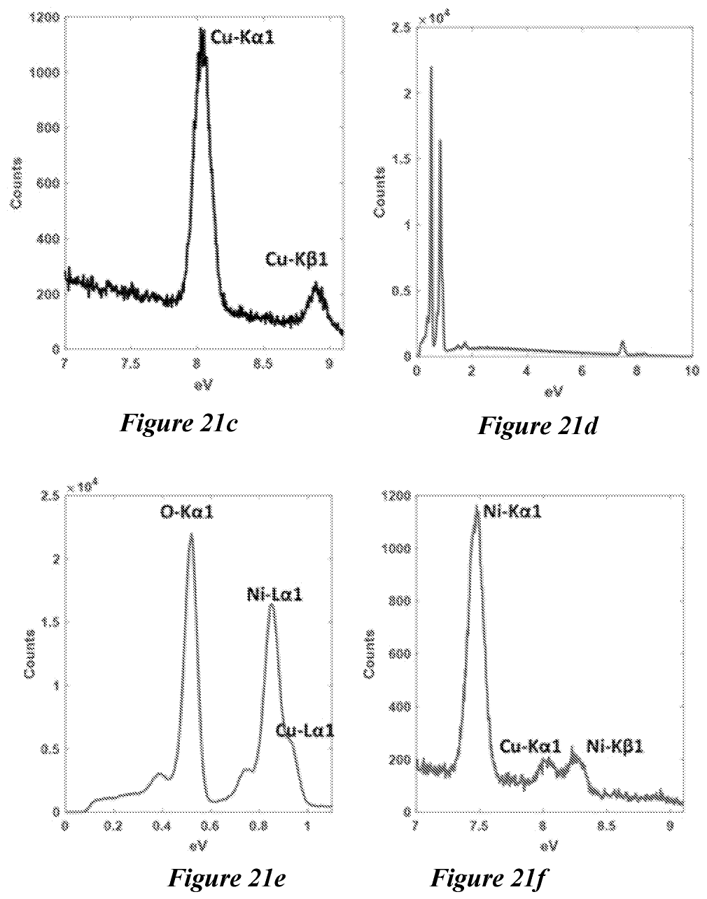

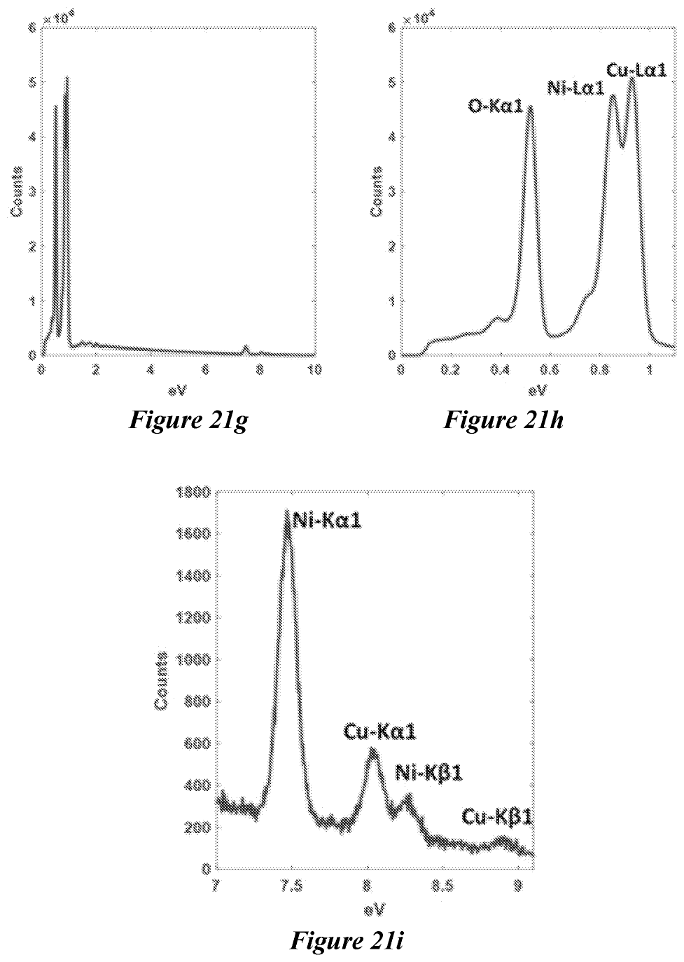

The overall elemental compositions of the treated and untreated electrodes were confirmed through the use of energy dispersive X-ray electron spectroscopy (EDS). Here, for the untreated and treated Ni/Cu₂O/Cu electrodes, the emitted X-rays confirmed the presence of Ni along with Cu and O comprising the oxide layer. The 10 kV high energy electron beam (FIG. 21a-FIG. 21i) was able to show clear peak separations for Ni and Cu at ˜7.5 keV˜8 keV (Kα1 transitions) respectively. Examining the relative peak heights for the treated and untreated Ni/Cu₂O/Cu, it can be seen that the photoelectrochemical reduction process results in an increased Cu peak relative to Ni. Additionally, the Kβ1 transition for Cu becomes evident. Thus, the reduction process may have removed some of the deposited Ni.

The SEM images and EDS results presented here show that sputtering process is an important step in nano-structuring the electrode surface. After sputtering, a significant amount of surface roughness is introduced. Therefore, the catalytic NADP⁺ reduction properties can be the combined results of creating additional electrochemical surface area through the sputtering process and providing a strong Ni-Hydrogen bond for the eventual protonation of the NADP⁺ molecule. Next, potential mechanisms for the observed changes in surface morphologies are explored.

The contrast in morphology between the Cu₂O/Cu sample and the Ni/Cu₂O/Cu sample suggests that Ni bombardment of the surface could be responsible for destroying the crystalline structure of as-is Cu₂O. One potential explanation is that the sputtered Ni is ionized to Ni^{z-} on impact (where z is the number of excess electrons). The electric field in the chamber then accelerates the negatively charged Ni ion toward the anode, where it eventually strikes the sample and locally modifies the surface. Considering the degree to which the surface is modified and the EDS spectra, a substantial amount of Ni likely exists on the surface of the Ni/Cu₂O/Cu a electrodes. If a complete and contiguous Ni layer is forming, the Cu₂O layer may not be directly interacting with an aqueous species in its reduction. The Cu₂O could potentially donate its oxygen atom to the Ni, forming an intermediate NiO layer which is then further reduced back to Ni. This chemical mechanism is depicted in Scheme 3.

Step 1: Cu₂O+2e⁻⇄2Cu+O²⁻

Step 2: Ni+O²⁻⇄NiO+2e⁻

Step 3: NiO+H₂O+2e⁻⇄Ni+2OH⁻

Net Reaction: Cu₂O+H₂O+2e⁻⇄2Cu+2OH⁻

Scheme 3. Chemical mechanism for the reduction of Cu₂O forming an NiO intermediate.

Transmission electron microscopy (TEM) and cross-section EDS can provide insight on the nature of each surface layer in the electrode. Additionally, electron energy-loss spectroscopy (EELS) can provide information about the oxidation states of the electrode's constituent elements before and after electro-reduction. A complete materials characterization can clarify the origin of the electrode's catalytic properties upon sputtering and photoelectrochemical reduction.

NADP⁺ Reduction Mechanism. Two potential mechanisms are proposed to describe the overall catalytic NADP⁺ reduction mechanism at the electro-reduced Ni/Cu₂O/Cu electrodes (denoted as OD-Cu—Ni in the mechanism). In the first (Scheme 4), the commonly observed Volmer type mechanism is proposed for the adsorption of hydrogen onto Ni coated locations on the electrode (Gong M et al. Nano Research, 2016, 9(1), 28-46). An NADP⁺ molecule then adsorbs onto a neighboring site on the electrode. The adsorbed NADP⁺ is radicalized upon accepting an electron from the electrode. The nearby adsorbed hydrogen is then transferred chemically to the nearby NADP⁺ to generate NADPH, which then desorbs back into the electrolyte. This can be described as hydrogenation of the radical. Structurally, the reaction would proceed in step 1 followed by 2c) in Scheme 1 where the electron and proton transfer happen simultaneously via the hydrogenation. The first electron transfer neutralizes the positively charged nitrogen atom and the second fills the valence shell of the carbon-4 atom.

Step 1: OD-Cu-Ni+H₂O+e⁻⇄OD-Cu—Ni-H_{ads}+OH⁻

Step 2: OD-Cu—Ni NADP⁺⇄OD-Cu—Ni-NADP_{ads}⁺

Step 3: OD-Cu—Ni-NADP_{ads}⁺+e⁻⇄OD-Cu—Ni-NADP_{ads}⁺

Step 4: OD-Cu—Ni-NADP_{ads}⁺+OD-Cu—Ni-H_{ads}⇄OD-Cu—Ni-NADPH_{ads}+OD-Cu—Ni

Step 5: OD-Cu—Ni-NADPH_{ads}⇄OD-Cu-Ni+NADPH

Scheme 4. Potential mechanism for the reduction of NADP⁺ observed at the Ni/Cu₂O/Cu electrode after reduction of the oxide layer. OD-Cu—Ni denotes an available site for surface adsorption on the electrode.

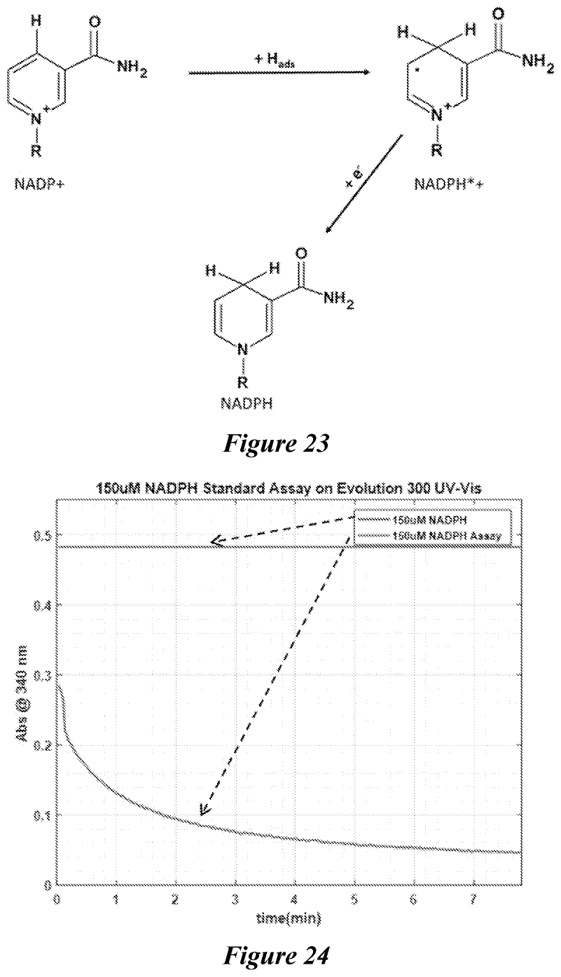

The second mechanism (steps labeled 3b and 4b in Scheme 5) proceeds in a similar fashion as the first, with the hydrogen and electron transfer order reversed. The adsorbed NADP⁺ molecule accepts the adsorbed hydrogen to form NADPH*⁺, and then receives an additional electron from the electrode before desorption (FIG. 23). For this reaction to occur, however, the NADPH*⁺ that is formed must be another radical cation similar to NADP*. In order to maintain the valency (double bond) on the Nitrogen atom, the carbon atom holding the lone electron must move one position compared to the NADP* radical of Scheme 1. As a result, this intermediate could also potentially form a dimer to fill the valence shell of the carbon-3 atom as opposed to 1,4-NADPH. Similar reaction mechanisms also apply where the nicotinamide species do not form adsorbed intermediates on the electrode surface and lie in the outer Helmholtz plane, where they can still interact with the electrons and accept electrons. The basis of these mechanisms is that the surface adsorbed hydrogen is more effective in protonation compared to protons (hydronium ions) present only in solution, resulting in increased NADPH yield. Of course, the reaction can also take place at electrode locations with no surface adsorbed hydrogen, but this would involve an aqueous species transferring a proton to the nicotinamide.

Step 3b: OD-Cu—Ni-NADP_{ads}⁺+OD-Cu—Ni—H_{ads} ⇄OD-Cu—Ni-NADP_{ads}*⁺+OD-Cu—Ni

Step 4b: OD-Cu—Ni-NADP_{ads}*⁺+e⁻⇄OD-Cu—Ni-NADPH_{ads}

Scheme 5. Alternate steps 3 and 4 for NADP+ reduction.

CONCLUSIONS. Several results regarding electrochemical cofactor regeneration at electro-reduced Ni/Cu₂O/Cu electrodes have been presented in this work. It was found that laser irradiation of the Ni/Cu₂O/Cu photocathode assists in developing an electrocatalyst for NADP⁺ reduction by photoelectrochemically reducing the oxide layer in the Ni/Cu₂O/Cu electrode. The activity of the electrochemically-produced reaction products was confirmed via the spectrophotometric enzymatic assay. The exact purity of the reaction products, however, is not clear. Using the method of Omanovich et al., the enzymatic assay gave values of 74.1±1.0% and 89.1±2.8% (where the error bar arises due to dilution correction) for two different electrodes. When examining the procedure in a more rigorous mathematical manner, it was seen that there is additional uncompensated uncertainty that arises due to the NADP⁺ absorbance at 340 nm. Basic thermodynamic consideration of the assay also suggests that the ADH should not turn over all the 1,4-NADPH, just enough to satisfy its equilibrium constant. Analytical methods such as mass spectrometry or nuclear magnetic resonance spectroscopy can accurately characterize the purity of reaction products and confirm or deny the presence of dimer/inactive isomer.

Temporal studies monitoring progress of NADP⁺ reduction at Ni/Cu₂O/Cu electrodes showed that the reaction proceeded with or without light, with an initial dormant period with no product formation. Meanwhile, a substantial cathodic current is passed during the dormant period, indicating that the oxide layer must be reduced to a certain degree before the NADP⁺ reduction can proceed. The dead period was mitigated by turning on the light source (532 nm laser irradiation) or pre-electro-reducing the electrode in buffer prior to adding NADP⁺. This implies that any photoelectrochemistry is reserved for reducing the oxide layer rather than conversion of the NADP⁺. Interestingly, the electro-reduced Ni/Cu₂O/Cu electrode shows significantly stronger activity for reducing NADP⁺ at low overpotential compared to the Cu substrate (with and without Ni coat) and uncoated Cu₂O. Preliminary materials characterization suggests this catalytic behavior is due to the combined effects of sputtered Ni generating an increased electrode surface area and creating a favorable metal-hydrogen bond on the solution side. A more detailed materials characterization can more fully elucidate the catalytic properties of the nanoheterostructure, especially after being electro-reduced. Fundamental physical differences exist between the native substrate Ni/Cu and the oxide-derived Ni/Cu electrodes and understanding these can assist in fine tuning of the catalytic properties of the electrode for cofactor regeneration or other potential electrochemical processes.

A Ni/Cu₂O/Cu nanoheterostructure electrode has been developed for the direct electrochemical reduction of NADP⁺ to enzymatically active NADPH. This electrode offers strong advantages in its low material cost and two-step manufacturing process compared to other precious metal decorated electrodes. The capability of low overpotential and direct NADPH regeneration reduces the electrical energy input cost compared to other high-overpotential systems and provides a simple experimental setup for regenerating NADPH in solution. Understanding of the sources of the catalytic nature of the electrode demonstrated here can allow for the electrochemical regeneration of cofactors to be optimized and potentially become viable as an electrode for industrial scale cofactor regeneration.

### Example 2—Copper Oxide Based Cathode for Direct NADPH Regeneration

Nearly a fourth of the proteome consists of oxidoreductases, and the redox reactions supported by this vast catalytic repertoire sustain cellular metabolism. In the majority of biological processes, reduction depends on hydride transfer from either reduced nicotinamide adenine dinucleotide (NADH) or its phosphorylated derivative (NADPH). Despite longstanding efforts to regenerate NADPH by various methods and harness it to support chemoenzymatic synthesis strategies, lack of product purity has been a major deterrent. Herein, a nanostructured heterolayer Ni—Cu₂O—Cu cathode formed by a photoelectrochemical process is shown to have unexpected efficacy in direct electrochemical regeneration of NADPH from NADP⁺. Remarkably, two-thirds of NADP⁺ was converted to NADPH with no measurable production of the inactive (NADP)₂ dimer and at the lowest reported overpotential [−0.75 V versus Ag/AgCl (3 M NaCl) reference]. The remainder of the inactive product is likely an isomer (e.g., 1,6-NADPH) arising from the electrode-adjacent layers. Sputtering of nickel on the copper-oxide electrode nucleated an unexpected surface morphology (as uncovered by SEM and XPS studies) that contributed to high product selectivity. These results can motivate design of integrated electrolyzer platforms that deploy this heterogeneous catalyst for direct electrochemical regeneration of NADH/NADPH, which is central to next-generation biofuel fermentation strategies, biological solar converters, energy-storage devices, and artificial photosynthesis.

INTRODUCTION. Electron transfer is key to all cellular metabolism as redox reactions undergird the work performed by all living organisms (VanLinden M R et al. Biochem. 2015, 37(1), 9-13; Johnson M P. Essays in Biochemistry, 2016, 60, 255-273). During the exergonic oxidation of nutrients and foods, catabolic processes first capture electrons in the form of coenzymes (e.g., reduced form of nicotinamide adenine dinucleotide, NADH) and then generate cellular energy currencies by harnessing the electromotive force during electron transport from these reduced coenzymes to oxygen. In contrast, specialized coenzymes (e.g., reduced form of nicotinamide adenine dinucleotide phosphate, NADPH) are used to support reductive syntheses during anabolism. Metabolism is often a target of cancer therapies (Liberti M V et al. Trends Biochem Sci. 2016, 41(3), 211-218).

Reduced coenzymes also have potential application in bioinorganic artificial photosynthesis (Zhang T. Science, 2016, 350(6262), 738-739; Wu Y A et al. Nature Energy, 2019, 4, 957-968), and are important for biocatalyst-centered synthetic efforts in the pharmaceutical and (bio)chemical industries (Faber K. Biotransformations in Organic Chemistry. Springer Berlin Heidelberg, 2011. pp. 31-313; Uppada V et al. Current Science, 2014, 106(7), 946-957; Bornscheuer U T et al. Nature, 2012, 485, 185-193; Robinson P K. Essays in Biochemistry, 2015, 59, 1-41; Wang X et al. Chem, 2017, 2, 621-654; Hofler G T et al. ChemBioChem Comm. 2018, 19, 2344-2347). However, economic viability of these approaches depends on lowering the cost of reduced coenzymes. Inexpensive production of butanol from lignocellulosic biomass via biofermentation, for instance, would be an economically appealing additive to gasoline were it not for the cost (Zhang Y et al. J. Ind. Microbiol. Biotechnol. 2014, 41, 1505-1516). This roadblock is address herein by exploiting a nanostructured Ni—Cu₂O—Cu heterolayer material for photoelectrochemical regeneration of NADPH.

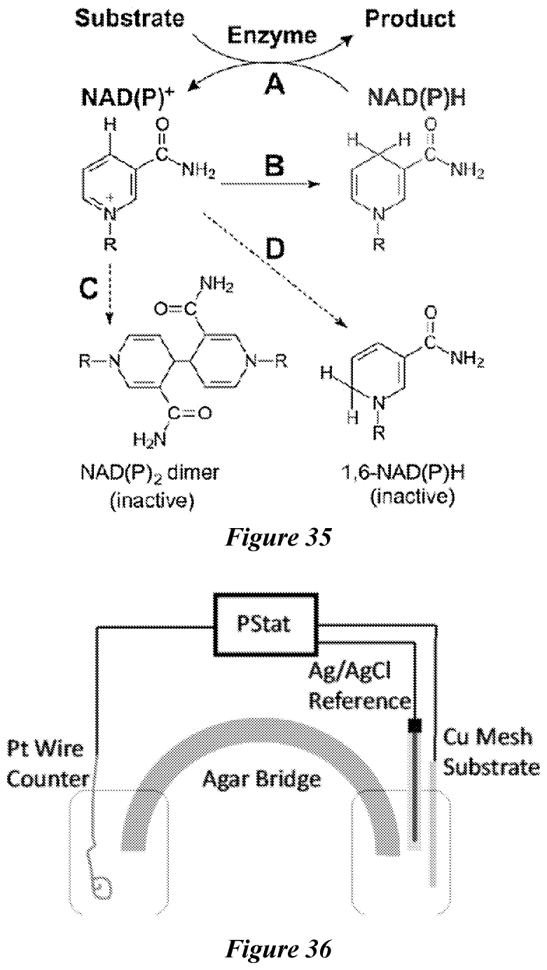

NAD(P)H has been regenerated by enzymatic, chemical, electrochemical, and biological approaches (Faber K. Biotransformations in Organic Chemistry. Springer Berlin Heidelberg, 2011. pp. 31-313; Wang X et al. Chem, 2017, 2, 621-654; Hofler G T et al. ChemBioChem Comm. 2018, 19, 2344-2347). Among these methods, electrochemical regeneration is the most direct, requiring few to no intermediate steps (Faber K. Biotransformations in Organic Chemistry. Springer Berlin Heidelberg, 2011. pp. 31-313; Wang X et al. Chem, 2017, 2, 621-654). However, challenges in the artificial regeneration of NADH/NADPH include: (i) the formation of inactive forms such as the (NADP)₂ dimer and the inactive isomer 1,6-NAD(P)H, which affect the purity of the product as determined by its utility (FIG. 35); (ii) the need for high overpotentials which can also lead to unwanted products, corrosion and degradation of electrodes; and (iii) the requirement of expensive catalysts such as Rh, Ru, Ir, and Pt (Faber K. Biotransformations in Organic Chemistry. Springer Berlin Heidelberg, 2011. pp. 31-313; Wang X et al. Chem, 2017, 2, 621-654; Damian A et al. Chem. Biochem. Eng. Q. 2007, 21, 21-32). Bare metallic materials favor production of the inactive (NADP)₂ dimer during direct electrochemical regeneration of NAD(P)H and precious metals such as Pt, Ir, and Ru can increase selectivity toward 1,4 NAD(P)H (Damian A et al. Chem. Biochem. Eng. Q. 2007, 21, 21-32). Herein, it is shown that (1) nanostructured, heterolayer, inexpensive electrodes made from widely available materials can be used to electrochemically regenerate active NADPH from NADP⁺ with a mild overpotential (−0.75 V versus Ag/AgCl (3 M NaCl) reference), (2) reduced cofactors can be produced directly without the need for an expensive catalyst, and (3) the directly regenerated co-factor product is devoid of the inactive dimer. The activity of the regenerated NADPH was evaluated using an alcohol dehydrogenase assay, a choice that was inspired by the desire to showcase the utility of this method for generation of biofuels from biomass.

### Results

Material and characterization. CuO and Cu₂O are both p-type semiconductors (1.3 eV 1.7 eV and 2.0-2.5 eV) (Paracchino A et al. Nature Materials, 2011, 10, 456-461; Yang Y et al. Scientific Reports, 2016, 6, 35158). The photo-galvanic properties of interfaces between semiconductors and electrolytes have been extensively studied since Edmond Becquerel's first report in 1839 (Becquerel E. Compte Rendu des Seances de L'Academie des Sciences, 1839, IX(3), 145-149; Garrison A. Journal of Physical Chemistry, 1924, 28(3), 279-284; Gratzel M. Nature, 2001, 414, 338-344). Copper-oxide based electrodes have since been used for hydrogen production (Paracchino A et al. Nature Materials, 2011, 10, 456-461; Dubale A A et al. Journal of Materials A, 2015, 3, 12482-12499; Pan L et al. Nature Catalysis, 2018, 1, 412-420), photoelectrocatalytic conversion of CO to liquid fuels (ethanol, acetate, and n-propanol) (Li C W et al. Nature, 2014, 508, 504-507), and solar energy conversion (Zhu C et al. Chemistry of Materials, 2014, 26, 2960-2966; Zhang T. Science, 2015, 350(6262), 738; Garcia-Esparza A T et al. Journal of Materials Chemistry A, 2014, 2, 7389-7401). The Becquerel effect has been used in photoelectrocatalytic regeneration of the cofactor NADH, but with exotic and expensive materials (Pt-modified p-GaAs semiconductor electrodes) (Stufano P et al. ChemElectroChem. 2017, 4, 1066-1073). Herein, a photoelectrochemically surface-modified Ni—Cu₂O—Cu electrode was used to regenerate NADPH from NADP⁺ using inexpensive materials and a facile process. The choice of this cofactor was in part due to the availability of an enzymatic assay based on Lactobacillus brevis alcohol dehydrogenase (LbADH) to evaluate the efficacy of the process based on the activity of the product, NADPH (Halloum I et al. Fermentation, 2015, 1, 24-37).

Copper oxide-based cathodes were prepared by a single-step electrochemical process on copper 100 mesh substrates (Alfa Aesar 45186, woven from 0.11 mm dia. Wire, 1 cm²). Copper mesh was selected as a working electrode because it is inexpensive and provides a higher surface area to volume ratio compared to planar foils. Prior to electrodeposition, the meshes were cleaned by two 10-min sequential sets of sonication in absolute ethanol and de-ionized water for another 10 min. The meshes were dump rinsed in de-ionized water between each sonication step. Finally, the meshes were dried with clean, compressed air. The copper oxide layer was electrodeposited using a solution containing 0.48 M CuSO₄ and 3 M lactic acid. This solution was prepared using copper sulfate pentahydrate (Sigma-209198), concentrated lactic acid (Ricca RABL0010-500A) and deionized water (18.2 Me-cm, Milli-Q) (Yang Y et al. Scientific Reports 2016, 6(1), 35158). The pH of the solution was then adjusted to 11 by adding pure NaOH. The electrodeposition process was carried out potentiostatically (Gamry Interface 1000) at −0.5 V vs Ag/AgCl (3 M NaCl, Basi MF-2052) for 2 h at room temperature (20-25° C.) in a two-compartment cell (FIG. 36) built using an agarose bridge (2% agar, Invitrogen 15110-019) and a coiled (˜3 turns, 0.404 mm diameter) Pt-wire (Alfa Aesar 45058) counter electrode. The cathode chamber was filled with cupric lactate solution and the anode chamber was filled with a 0.5 M potassium phosphate (pH 7) solution to prevent both degradation of the Pt wire and adsorption of Cu. Details of the copper oxide electrodeposition reaction are provided in the supplementary information provided below (Equation Si).

The electrodeposited material was reddish in appearance, a characteristic typical of Cu₂O. This nanostructured heterolayer cathode was then further modified by DC sputter deposition (EBTEC Co.). A thin nickel coating was deposited onto the Cu₂O—Cu heterostructure by sputtering a Ni target (5.1 cm diameter, polished with 100 grit sandpaper before deposition) in Ar gas (˜600 mTorr) at 340 V, 12.5 mA at a working distance of 3 cm between the sample and Ni target. Since the reduction of NADP⁺ to NADPH was desired, Ni was selected because of its well documented ability to adsorb hydrogen (Gong M et al. Nano Research! 2016, 9(1), 28-46). The sputtering process was carried out for 96 h after which the sample was overturned, and the sputtering process repeated for 24 h. Wires (22 AWG tinned Cu) were then attached to the Ni—Cu₂O—Cu electrode with conductive silver epoxy (MG Chemicals 8331) in order to decrease any uncompensated contact resistance (i.e. IR drops) in subsequent measurements of the electrode potential.

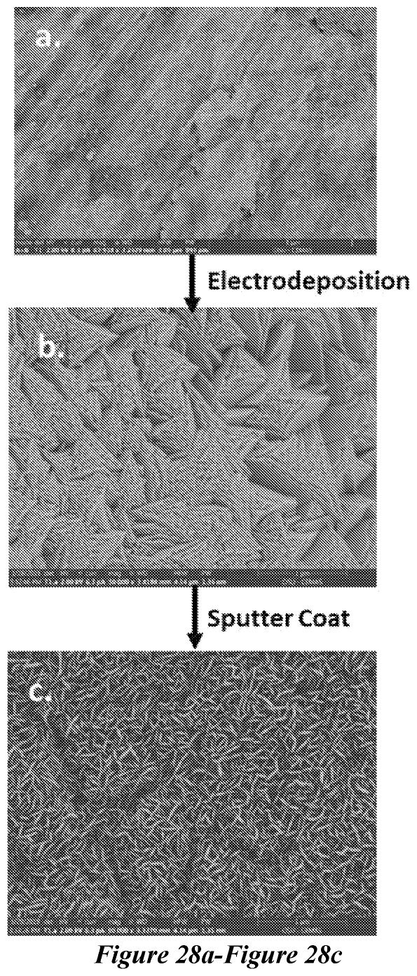

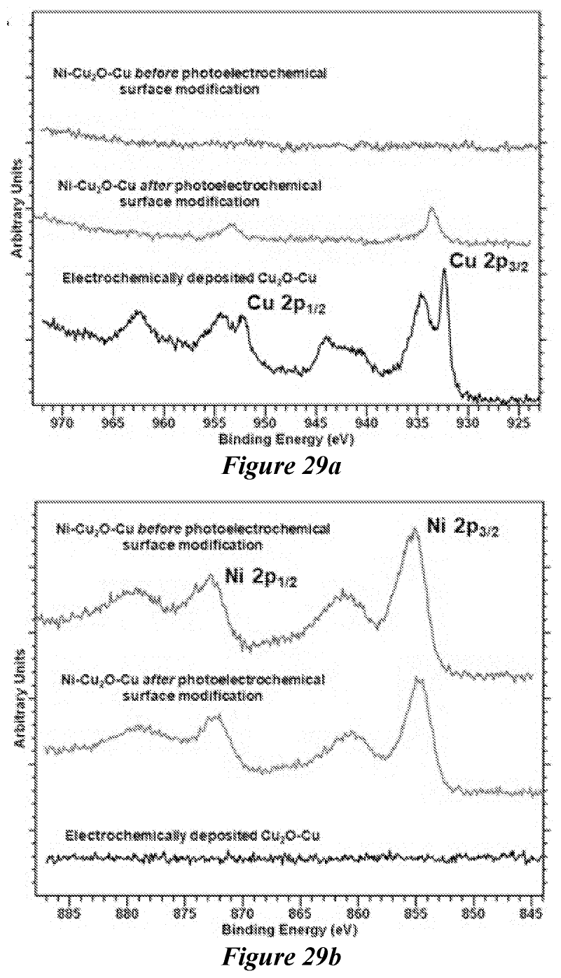

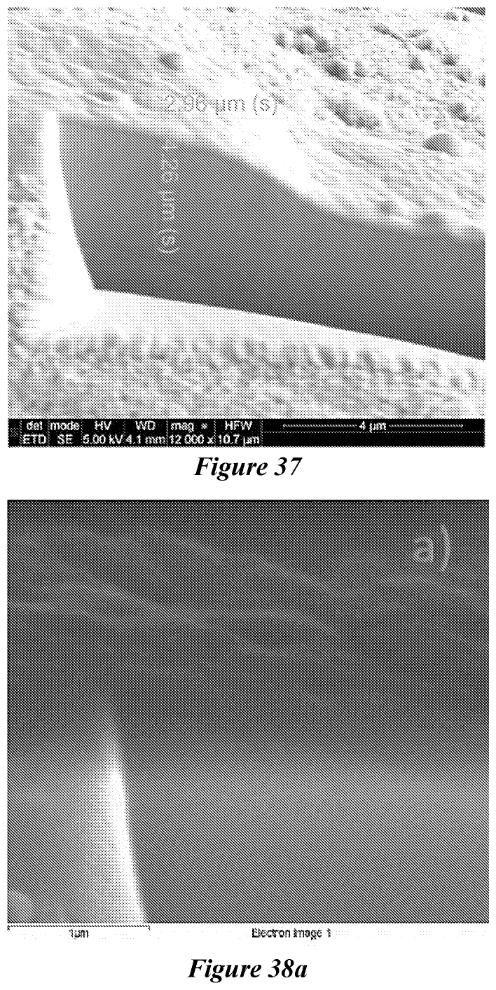

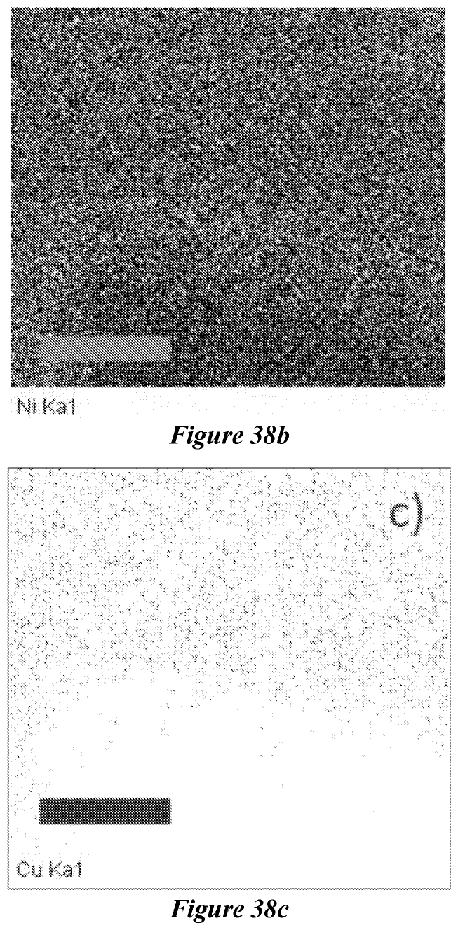

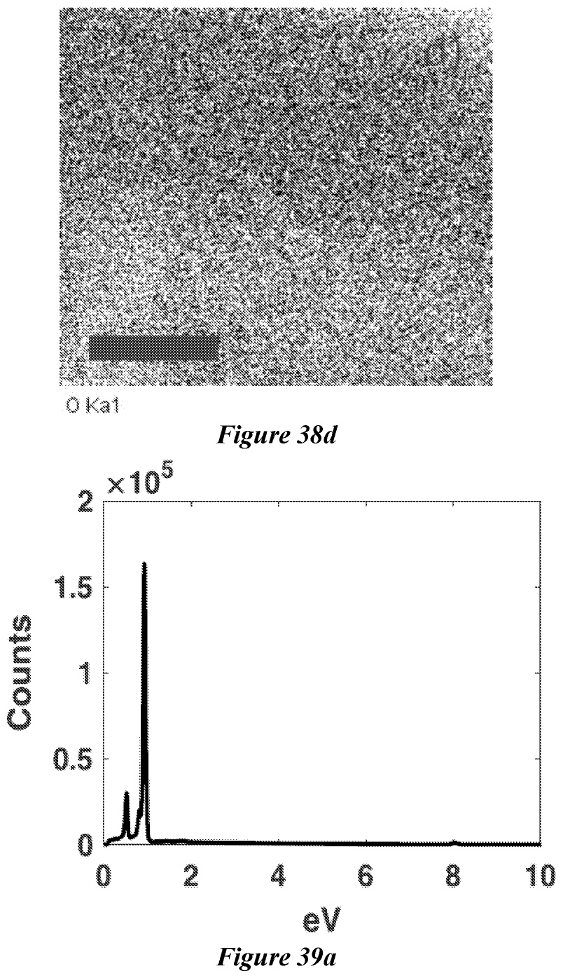

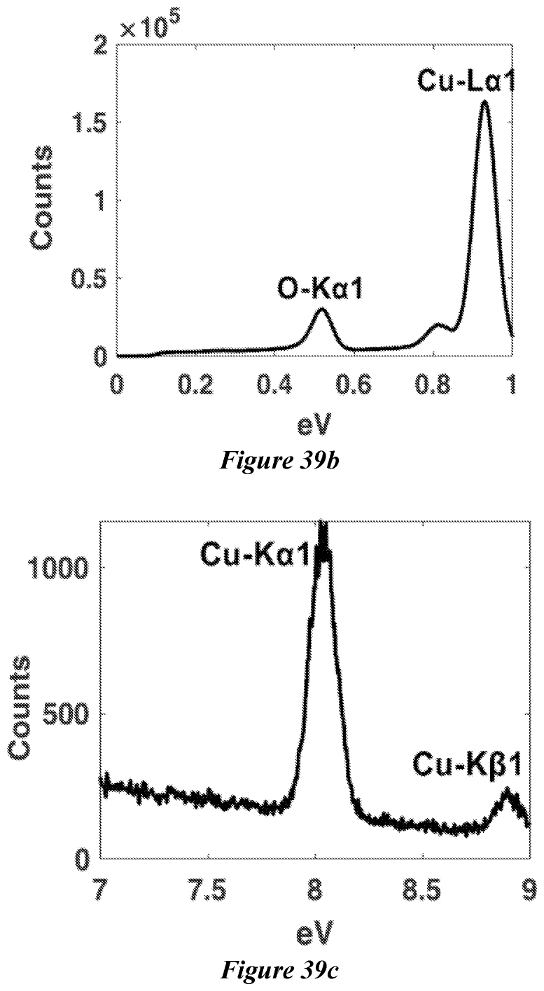

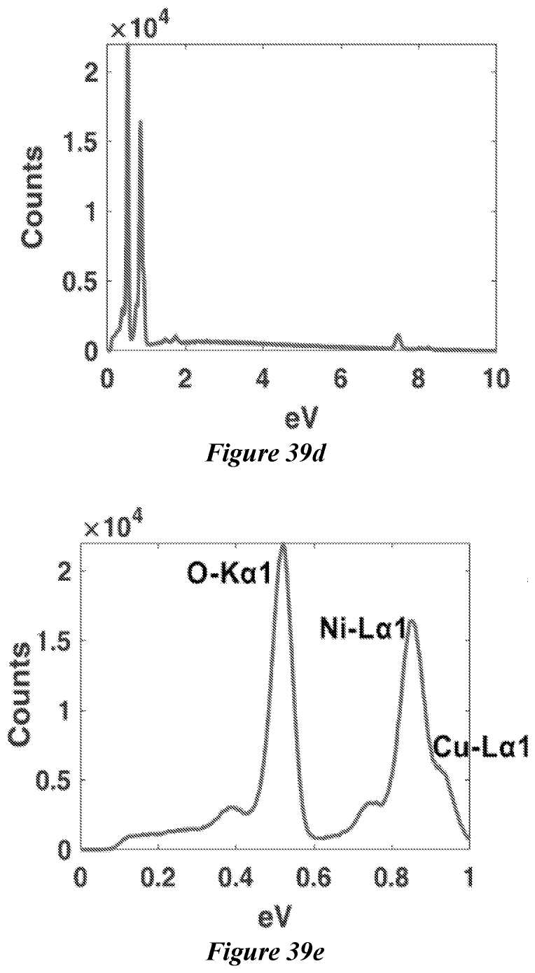

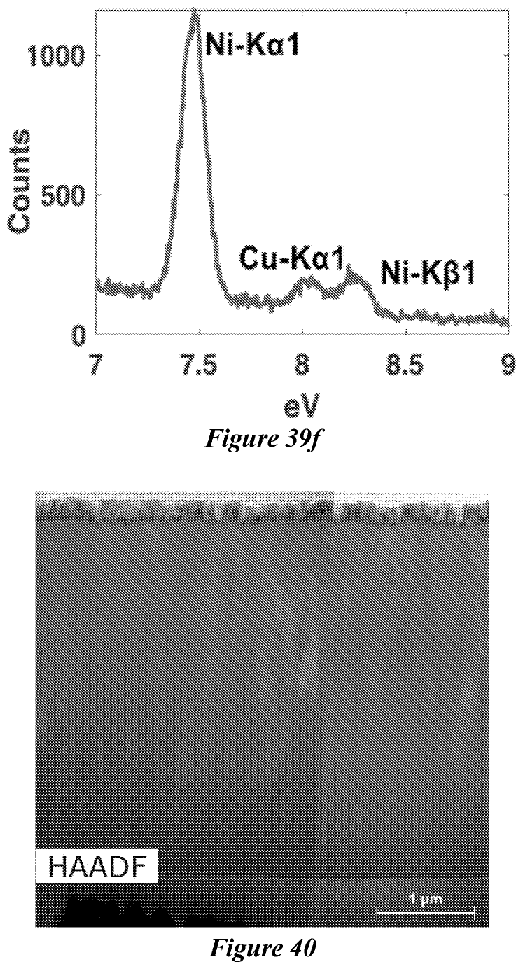

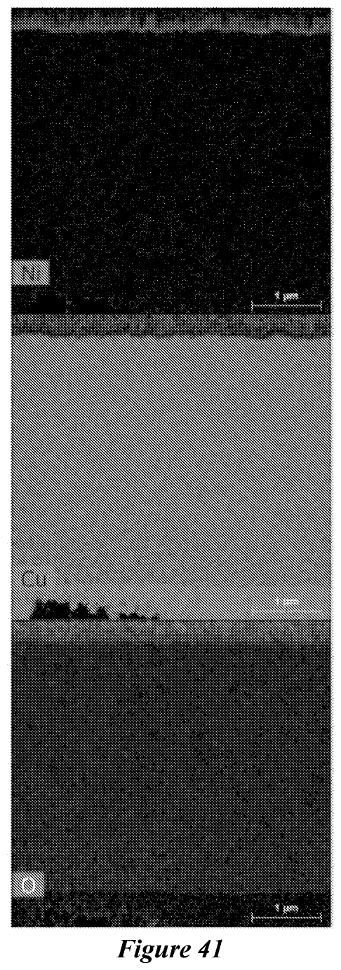

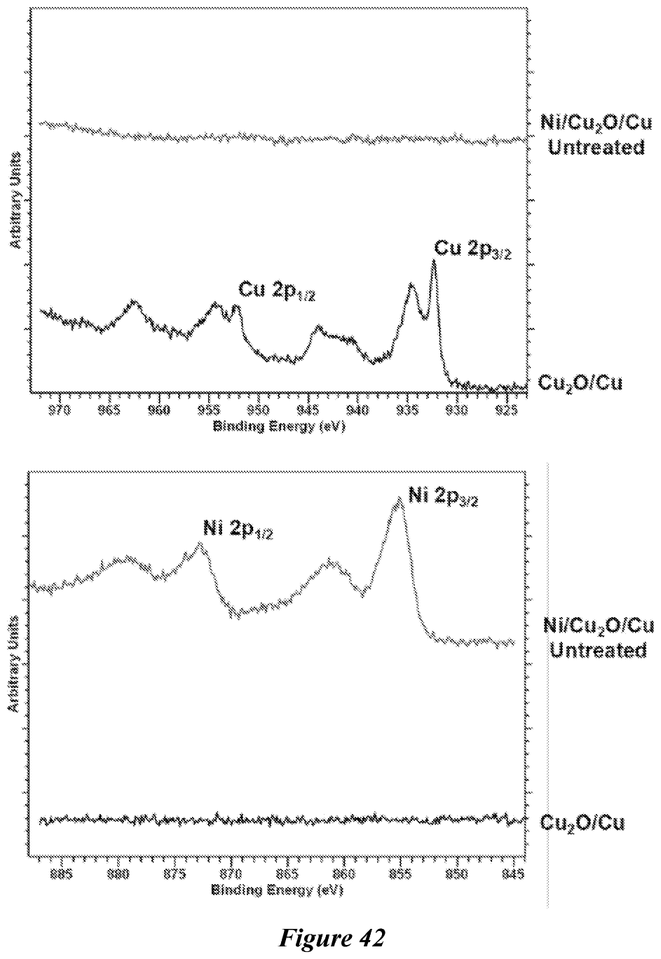

FIG. 28a-FIG. 28c shows scanning electron microscope (SEM) images of the changing surface morphology with each successive step of the electrode fabrication process. Cross-section SEM (FIG. 37) and X-ray Energy Dispersive Spectroscopic (EDS) analysis (FIG. 38a-FIG. 38d, FIG. 39a-FIG. 39f), along with repetition of identical process steps on a copper foil (FIG. 40-FIG. 41), indicate that the electrodeposited copper oxide layer is about 4.6-μm thick and the sputtered Ni nanolayer is ˜50 nm or less. EDS analyses of the surface at various stages of the fabrication process indicate the presence of Cu and O after electrodeposition, with Ni peaks and strong Ni/Cu ratios appearing after sputtering (FIG. 39a-FIG. 39f). Cross-sectional EDS maps of the surface suggest complete coverage of the surface with Ni (FIG. 38a-FIG. 38d). Despite the visible reddish appearance of the electrode, the surface morphology of the nanostructured heterolayer electrode (FIG. 28c) resembles that of CuO prepared by chemical bath deposition (compare with Zhu C et al. Chemistry of Materials, 2014, 26, 2960-2966). Therefore, it is likely that the electrode comprises both Cu₂O and CuO, but that the exposed surface is primarily CuO. X-ray Photoelectron Spectroscopy (XPS) spectra (FIG. 29a-FIG. 29b and FIG. 42) show the presence of both CuO and Cu (and perhaps Cu₂O as well) on the surface after electrodeposition and prior to sputtering (bottom curves in FIG. 29a-FIG. 29b) (Zhu C et al. Chemistry of Materials, 2014, 26, 2960-2966; Biesinger M C et al. Applied Surface Science 2010, 257, 887-898), which disappear upon sputter coating with Ni (top curve in FIG. 29a) displaying only the 2p_{1/2} and 2p_{3/2} peaks of Ni (top curve in FIG. 29b). Note that the morphology resembling CuO appears after sputtering of the Ni nanolayer (FIG. 28c versus FIG. 28b), suggesting that what might have been mostly electrodeposited Cu₂O is converted to CuO after the sputtering step.

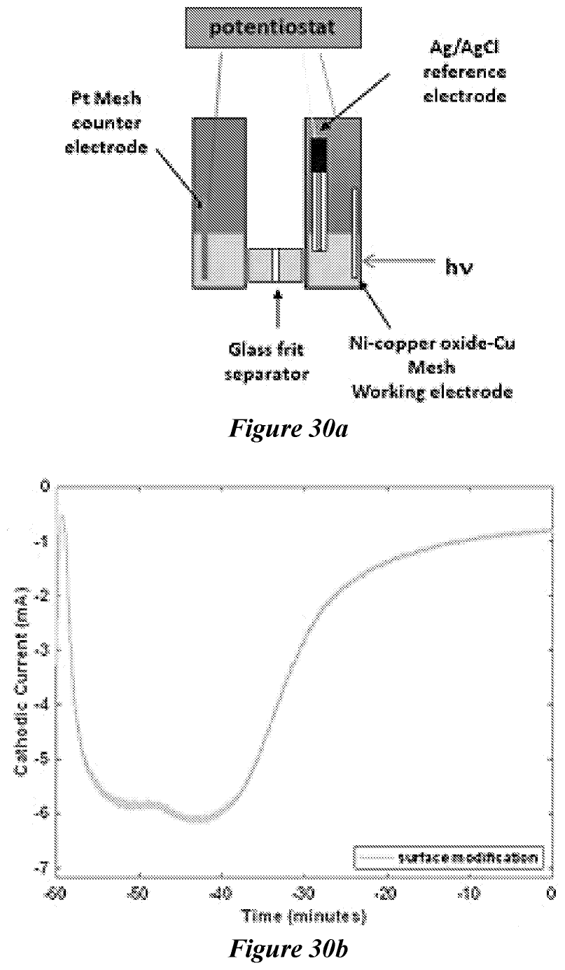

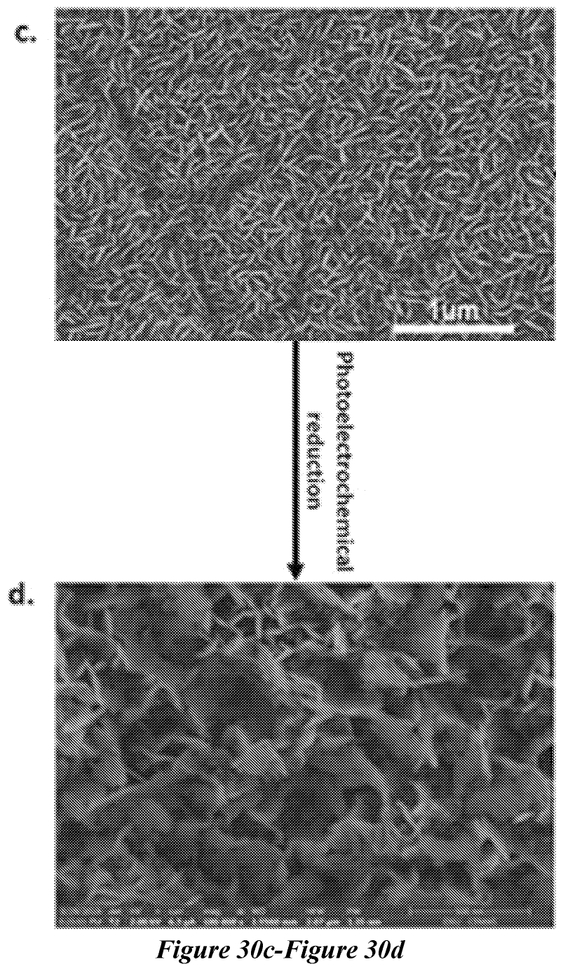

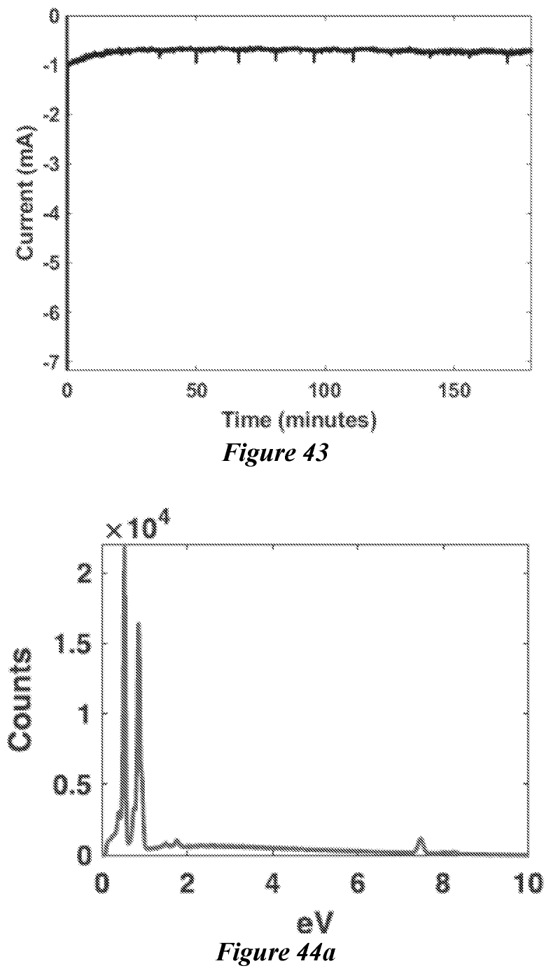

Surface modification of the cathode. In the final step of electrode fabrication, the Ni—Cu₂O—Cu electrode is exposed to 10 mW, 532 nm unfocused laser radiation while immersed in sodium phosphate (0.5 M, pH 8). This process was conducted in a customized quartz H-cell with a glass-frit separator to minimize light attenuation through the walls of the cell (FIG. 30a). A planar, geometric surface area of ˜1 cm² (on the side where Ni was sputtered for 96 h) was illuminated for all cathodes. Potentiostatic electrolysis was performed in conjunction with laser illumination in the same apparatus (Gamry Interface 1000, FIG. 30a) with an Ag/AgCl (3 M NaCl) reference electrode and Pt mesh (Alfa Aesar 10283) counter electrode. FIG. 30b shows the variation of the cathodic current versus time during the earlier stage of photoelectrochemical reduction. After an hour, it can be seen that surface modification via photoelectrochemical reduction is complete (FIG. 43). The accompanying changes in morphology before and after photoelectrochemical surface modification are shown in the SEM images in FIG. 30c and FIG. 30d.

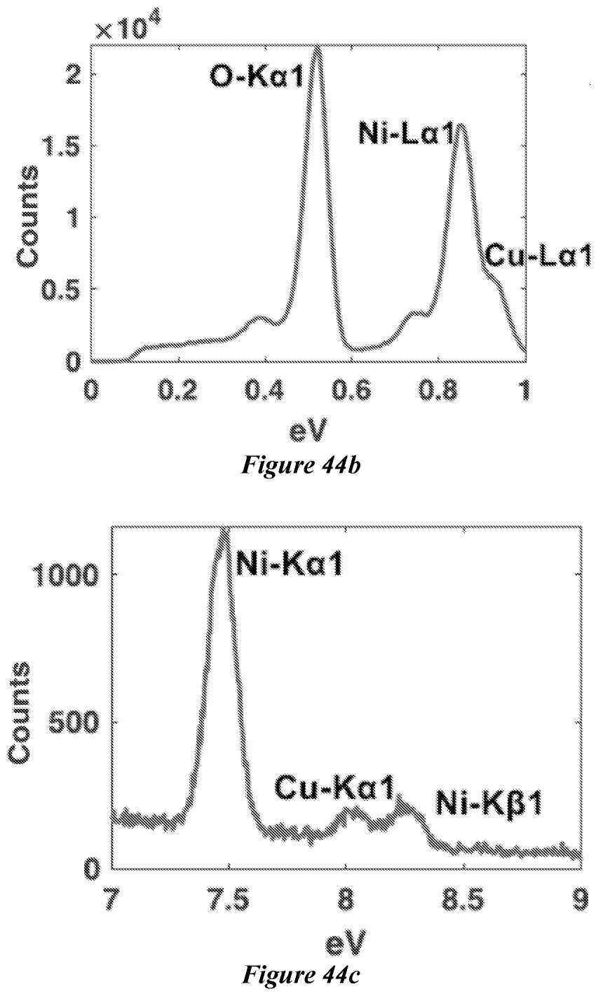

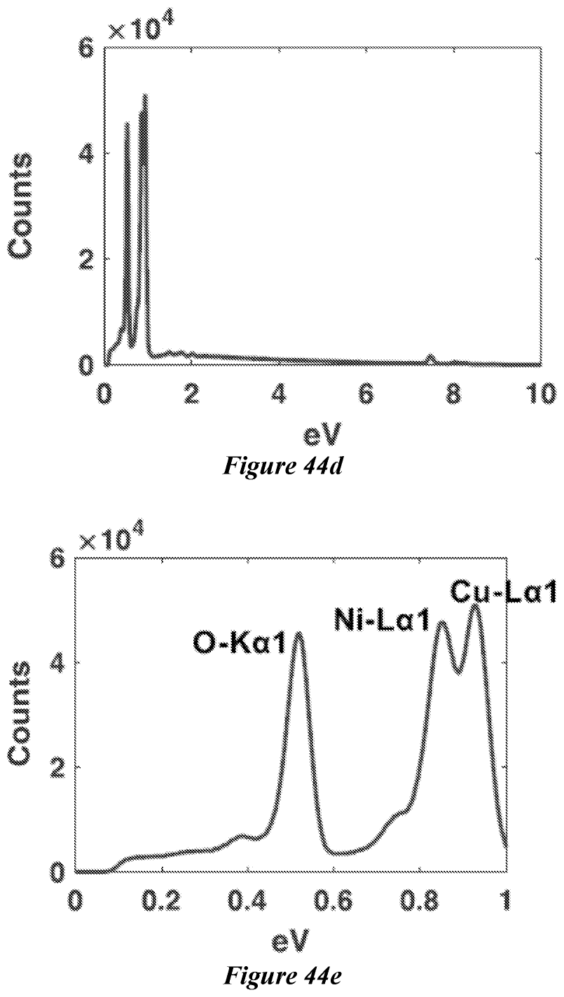

The features characteristic of CuO are evident in FIG. 28c and FIG. 30c and have been previously reported (Zhu C et al. Chemistry of Materials, 2014, 26, 2960-2966). These features have changed after surface modification of the electrode and are still significantly different from their as-deposited form (FIG. 30d versus FIG. 28b and FIG. 30c). EDS analysis (FIG. 44a-FIG. 44f) shows presence of elemental O, Ni, and Cu before and after photoelectrochemical surface modification, but the relative amounts of these elements are changed with O being less prominent compared to Ni and Cu in the surface layers. XPS spectra also reveal that upon photoelectrochemical surface modification, the Ni peaks 2p_{1/2} and 2p_{3/2} peaks still appear prominently (middle curve in FIG. 29b) but only the main 2p_{1/2} and 2p_{3/2} peaks of Cu (middle curve in FIG. 29a) remain, indicating likely conversion of CuO and Cu₂O to Cu on the electrode surface (Biesinger M C et al. Applied Surface Science 2010, 257, 887-898). Thus, after photoelectrochemical surface modification, the Ni—Cu₂O—Cu mesh electrode is devoid of the oxide, likely leaving a Ni—Cu surface.

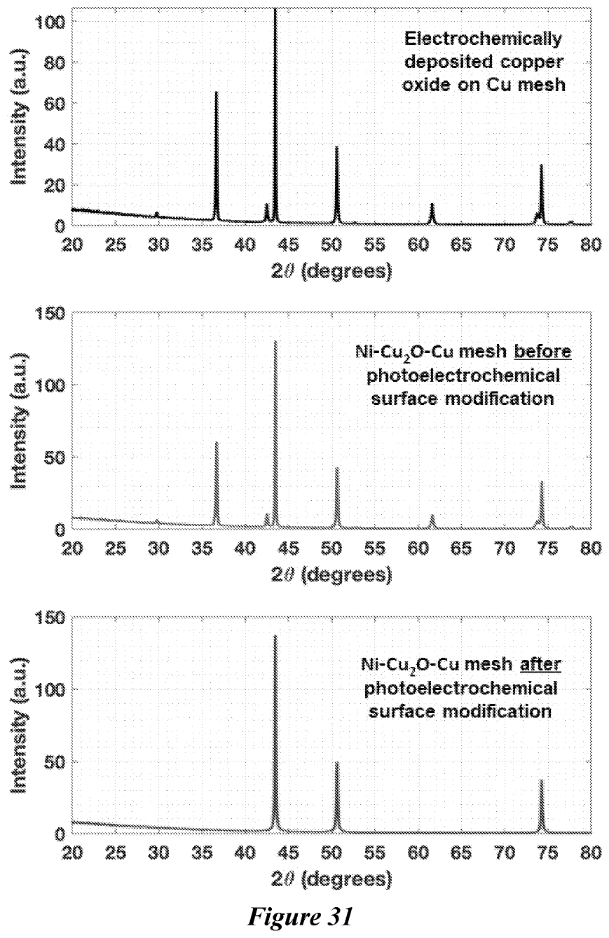

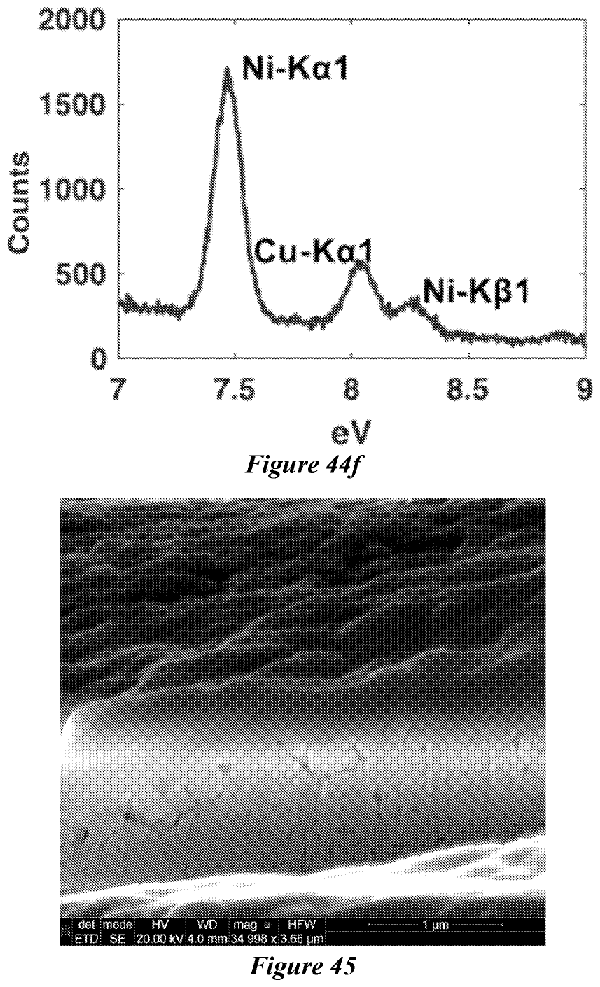

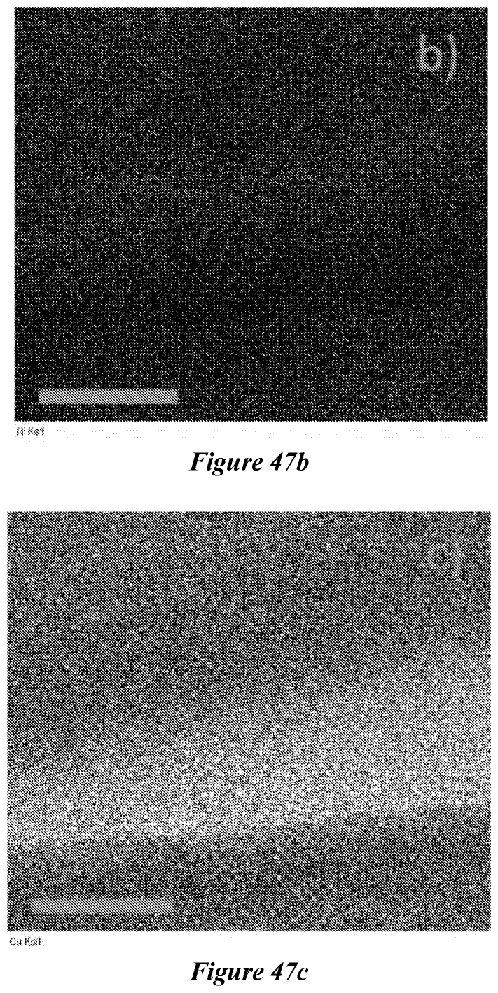

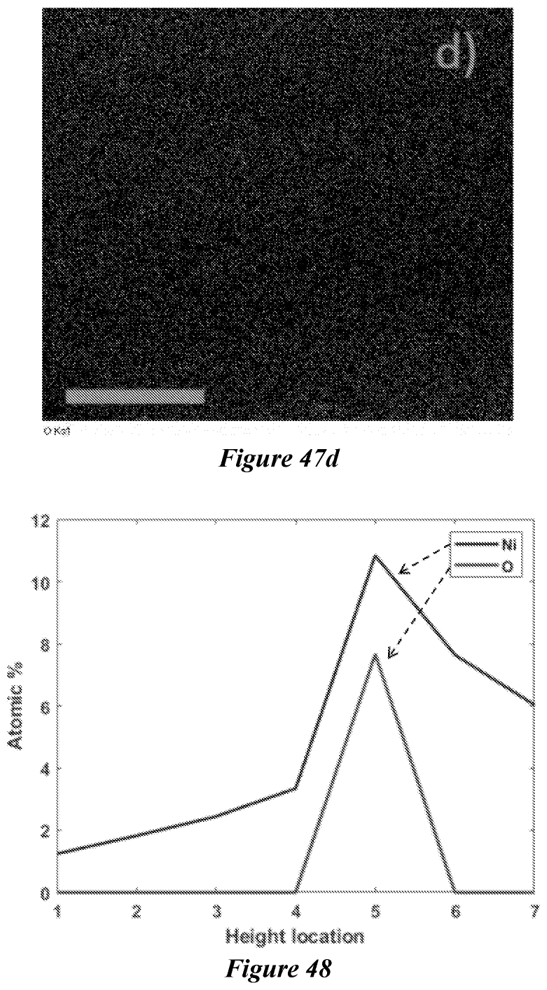

A cross section of the surface-modified electrode was prepared by focused ion beam (FIB) and imaged using the SEM. EDS analysis of the surface layers (FIG. 45-FIG. 48 and Table 5) shows them devoid of elemental oxygen, supporting the idea that what remains of the surface after photoelectrochemical surface modification is Cu with a nanolayer (<50 nm thick) of Ni, i.e. that the Ni—Cu₂O—Cu surface is ultimately converted to Ni—Cu. FIG. 31 shows X-ray Diffraction (XRD) spectra prior to sputtering Ni, after coating with Ni and before photoelectrochemical surface modification, and after photoelectrochemical surface modification. These results confirm photoelectrochemical reduction of the oxide to Cu since only the peaks corresponding to metallic copper remain in the near-surface layers and those corresponding to the oxide(s) of copper disappear (Sen P et al. Proc. Indian Acad. of Sci. (Chem. Sci.) 2003, 115(5 & 6), 499-508).

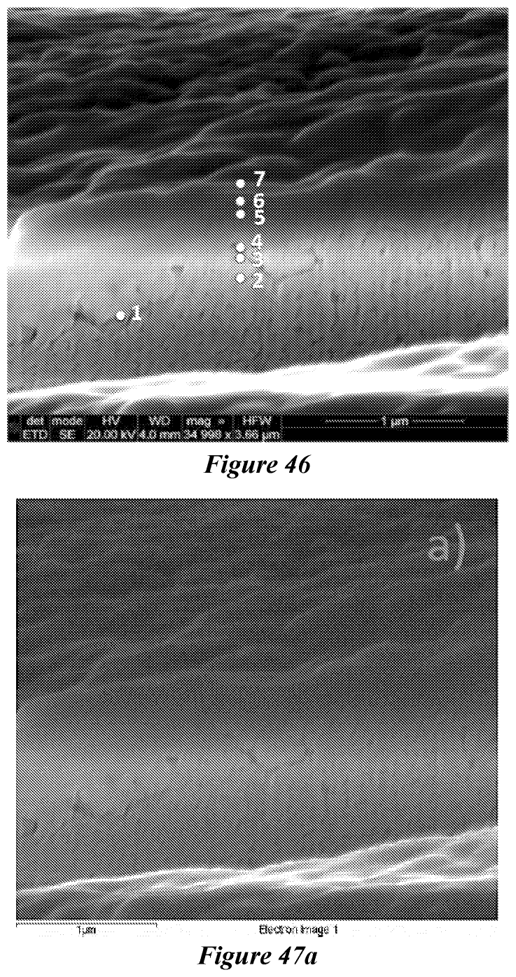

TABLE 5
Elemental O and Ni atomic percentages corresponding
to locations 1-7 in FIG. 46.

| Height | Ni K | O K |
|---|---|---|
| Location | Atomic % | Atomic % |
| 7 | 6.03 | — |
| 6 | 7.64 | — |
| 5 | 10.84 | 7.66 |
| 4 | 3.34 | — |
| 3 | 2.44 | — |
| 2 | 1.82 | — |
| 1 | 1.24 | — |

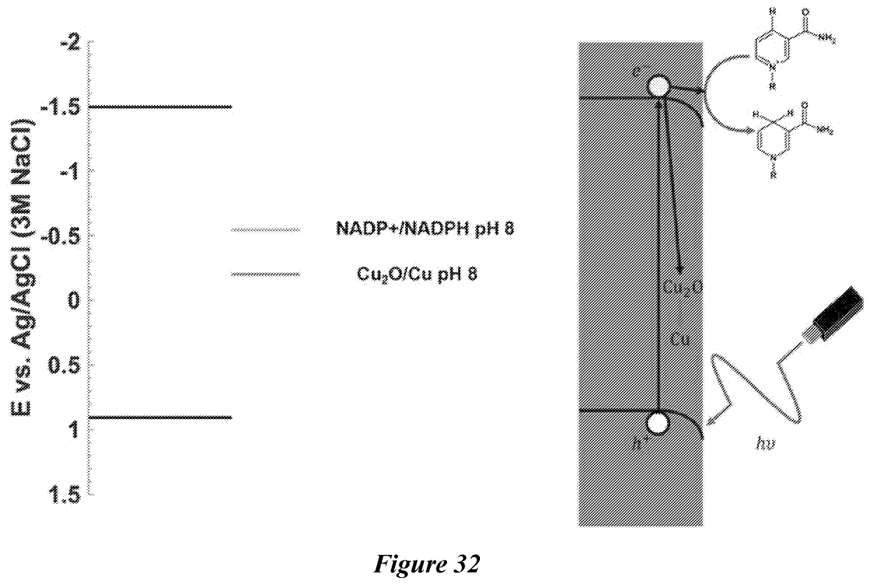

Direct electrochemical regeneration of NADPH at low overpotential. FIG. 32 shows a schematic of the electrochemical process and corresponding band-energy diagram for NADPH regeneration used here. The redox potentials for NADP⁺/NADPH and Cu₂O/Cu at pH 8 are shown (FIG. 32; Equation S2). When photons of sufficient energy are absorbed by the copper oxide, electrons are promoted to the conduction band. These electrons are available for electrochemical reactions subject to an electric field in the depletion layer and provided they do not recombine with holes. Since the redox potential for Cu₂O/Cu is more positive than for NADP⁺/NADPH, the photoelectrochemical reactions occurring during electrode surface modification likely lead to formation of Cu from copper oxide, leaving a Ni—Cu surface from the original Ni—Cu₂O—Cu surface layer. As discussed previously, this is borne out in the characterization of the surface of the cathode. It is shown here that photoelectrochemical processing may be used as surface modification either prior to or in tandem with cofactor regeneration.

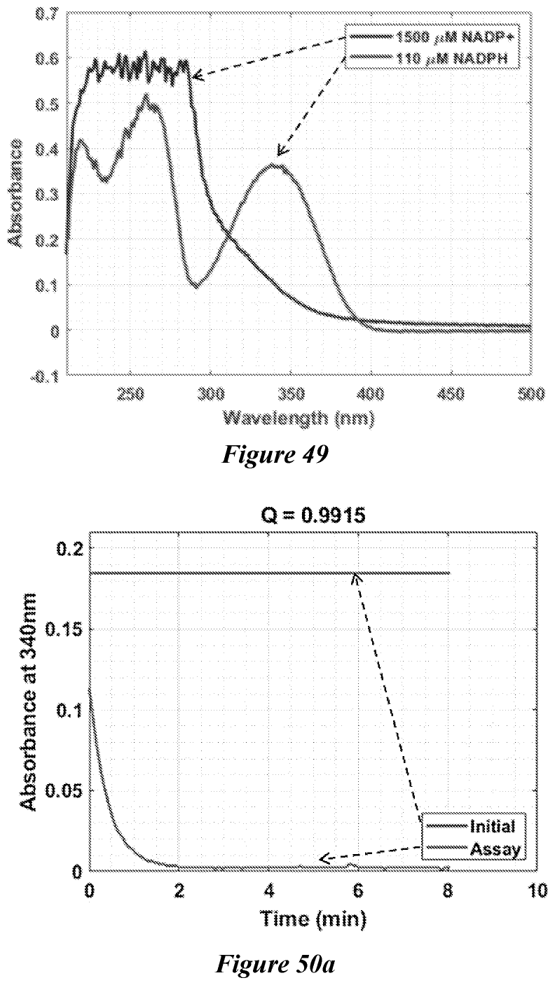

Bulk electrolyses of 1.5 mM NADP⁺ solutions (Sigma 10128031001) were performed in the same apparatus used for photoelectrochemical surface modification of the cathode, and with the same buffer (FIG. 30a). All experiments were conducted by applying a fixed electrode potential of −0.75 V (with respect to Ag/AgCl (3M NaCl)) to the nanostructured heterolayer cathode. The LbADH assay was then used to determine the purity and activity of the reaction products (see Methods below). The enzyme LbADH catalyzes the NADPH-mediated reduction of butyraldehyde to butanol. The enzyme LbADH will only accept the active isomer 1,4-NADPH as a cofactor along with the aldehyde substrate (butyraldehyde). This assay is selective, and the conversion of butyraldehyde to butanol will not proceed with either inactive isomers such as 1,6-NADPH or the dimer (NADP)₂. For determination of utility of the product, 350 μL aliquots were withdrawn from the cathode side of the chamber (FIG. 30a) where the cofactor is regenerated. The characteristic absorbance of NADPH at 340 nm was monitored as the reaction proceeded (see sample absorption spectrum in FIG. 49), to determine the presence of any NADPH derivatives that are produced. Upon initiating the aldehyde reduction, any observed decrease in absorbance at 340 nm is solely due to the consumption of 1,4-NADPH because of the assay's selectivity; any residual absorbance at 340 nm after the reaction stops is then due to enzymatically inactive products (e.g. 1,6-NADPH, (NADP)₂).

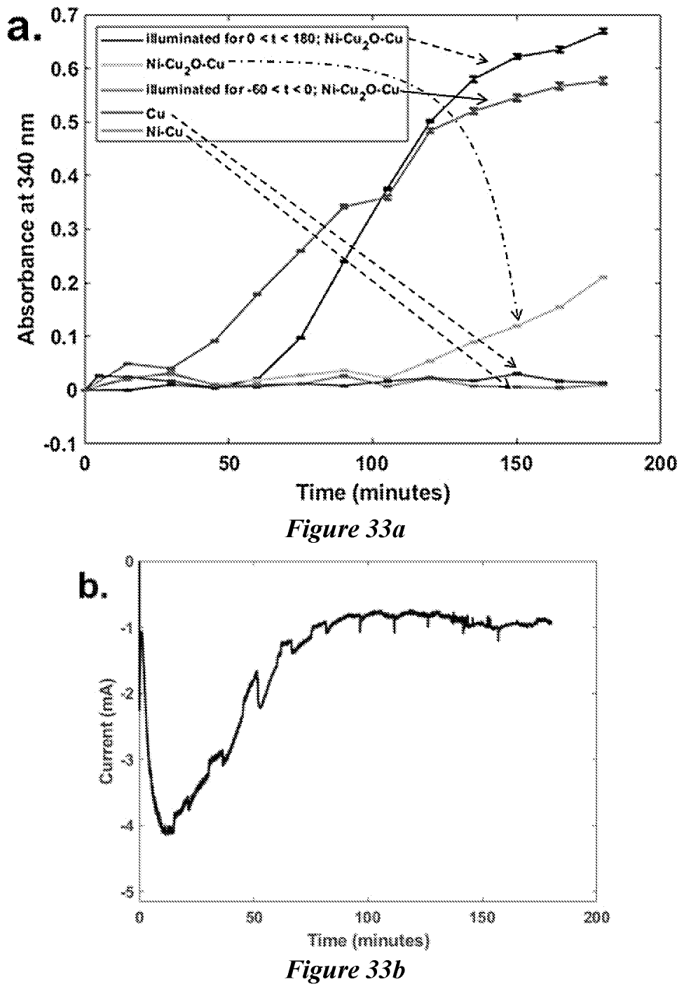

FIG. 33a shows a time-course study of the absorbance of NADPH at 340 nm for various cathodic materials that were subject to illumination and not, where t=0 indicates initiation of electrochemical reduction of NADPH. All time courses were initiated with initial NADP⁺ concentrations of 1.5 mM. It is evident that cofactor regeneration only occurs for the oxide-derived cathodes as no regeneration is observed for either pure Cu cathodes or electrodes with Ni sputtered directly on a Cu substrate. Illumination with a low power (10 mW), 532 nm unfocused laser irradiation accelerates the initiation of cofactor regeneration compared to electrochemical regeneration alone. It can also be inferred based on the incubation periods (FIG. 33a, where there is no absorption at 340 nm indicating absence of NADPH) that laser irradiation only modifies the electrode surface, enabling subsequent cofactor regeneration by electrochemistry (black, red, and green curves in FIG. 33a). Moreover, in the absence of photoelectrochemical surface modification and any illumination, electrochemistry alone supports NADPH regeneration albeit at a much slower rate. It is not possible to determine from the trajectory of the time-course curve for cofactor regeneration by electrochemistry alone (green curve in FIG. 33a), whether or not the level of regeneration will be comparable to the levels attained more quickly in the case of photoelectrochemical regeneration (black and red curves in FIG. 33a).

FIG. 33b shows the variation of current (cathode at −0.75 V with respect to Ag/AgCl reference) for the case where a Ni—Cu₂O—Cu mesh electrode that has not previously undergone photoelectrochemical surface modification, is used to photoelectrochemically regenerate NADPH in the presence of the same 532 nm laser irradiation used for surface modification of other Ni—Cu₂O—Cu cathodes (FIG. 33b). The similarity between FIG. 33b and FIG. 30b indicates that the effect of laser irradiation is exclusively to modify the surface photoelectrochemically as no cofactor regeneration is observed for the first ˜60 min in any of the experiments involving photoelectrochemical conversion (FIG. 33a). In contrast, electrochemical regeneration of NADPH with cathodes that have previously undergone photoelectrochemical surface modification (red curve in FIG. 33a) is just as effective with respect to the amount regenerated compared to those experiments where laser irradiation is simultaneous with electrochemical regeneration. The notable difference is the onset time for the NADPH product.

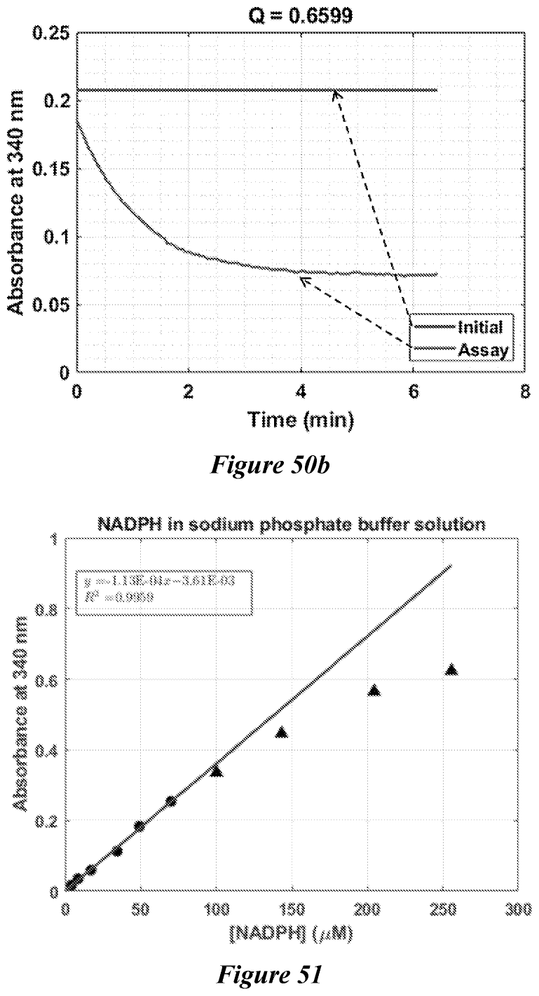

Regenerated NADPH does not contain the inactive dimer. The purity of the product of electrochemical regeneration (NADPH) was investigated using the LbADH enzyme (see Methods below) (Halloum I et al. Fermentation, 2015, 1, 24-37). When this enzyme was added to commercially obtained NADPH (60 μM), near-complete conversion to NADP⁺ was observed (Q>99%, Equation S3-Equation S5, FIG. 50a-FIG. 50b). Direct electrochemical regeneration using the photoelectrochemically surface-modified cathodes, however, showed that only 66% could be converted to NADP⁺. This result suggests that direct cofactor regeneration using the nanostructured heterolayer Ni—Cu₂O—Cu mesh cathodes result in the formation of some inactive NADPH or products. Since it is well established that electrochemical regeneration of NADH from NAD⁺ results in unwanted products such as the inactive dimer (VanLinden M R et al. Biochem. 2015, 37(1), 9-13; Uppada V et al. Current Science, 2014, 106(7), 946-957; Wang X et al. Chem, 2017, 2, 621-654; Damian A et al. Chem. Biochem. Eng. Q. 2007, 21, 21-32; Vuorilehto K et al. Bioelectrochemistry. 2004, 65(1), 1-7; Ali I et al. Journal of Molecular Catalysis A: Chemical. 2014, 387, 86-91), this possibility was further investigated.

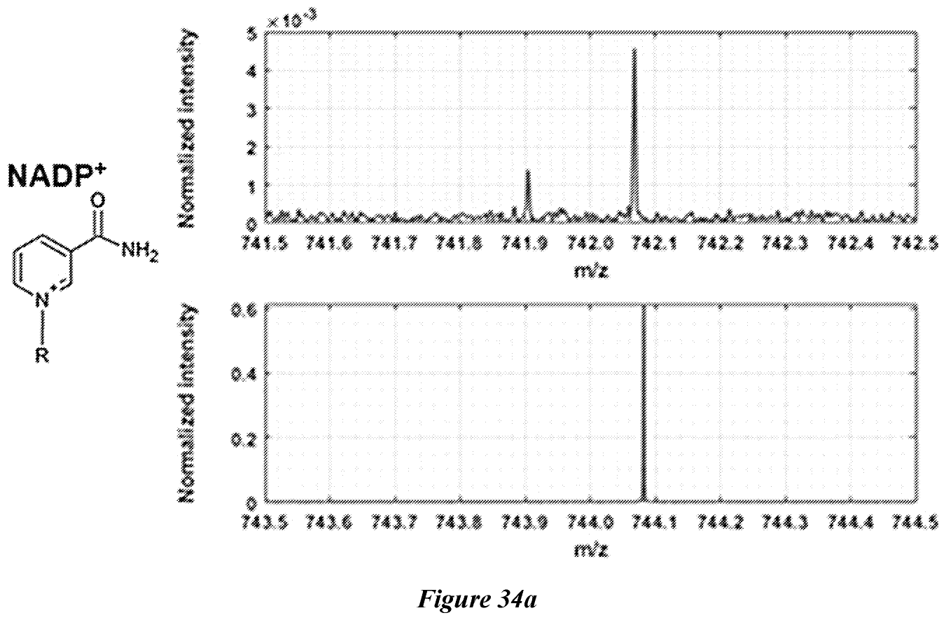

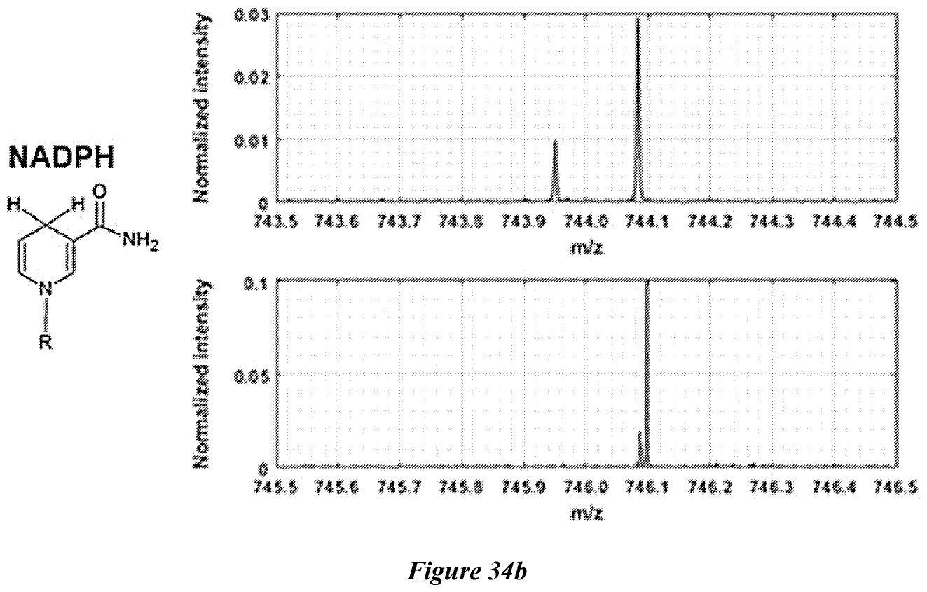

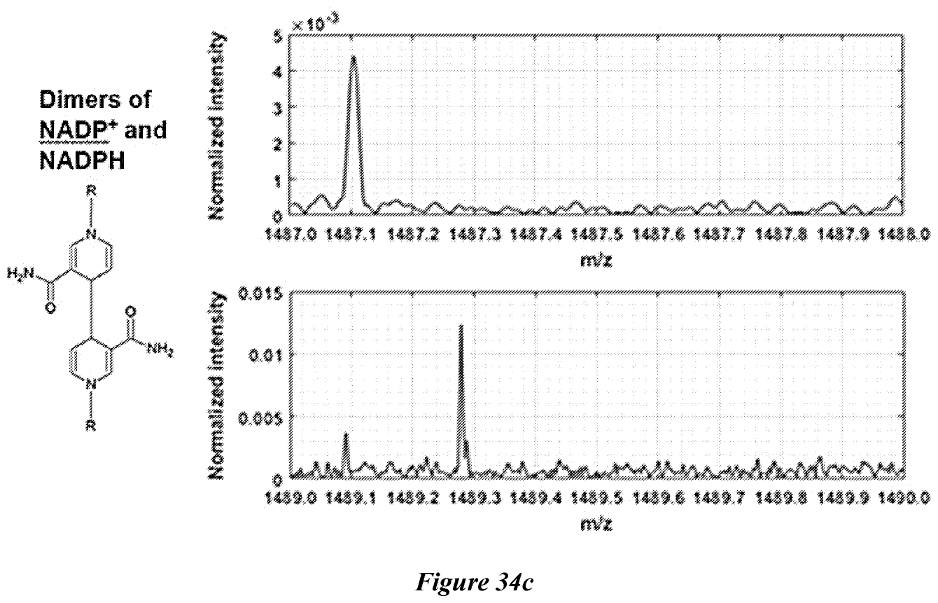

Fourier-transform ion cyclotron resonance mass spectrometry (Bruker 15T FT-ICR MS) with matrix-assisted desorption/ionization (MALDI) in both negative- and positive-ion modes was used to determine the composition of the products of cofactor regeneration. α-cyano-4-hydroxy-cinnamic acid) was used as the matrix. This instrument is capable of ultrahigh resolution (>10⁶) and mass accuracy (<1 ppm). FIG. 34a-FIG. 34c shows FT-ICR MS spectra in both negative ion mode (top figures in FIG. 34a, FIG. 34b, and FIG. 34c) and positive ion mode (bottom figures in FIG. 34a, FIG. 34b, and FIG. 34c). The amplitudes in FIG. 34a-FIG. 34c are qualitative indicators only since the abundance of a compound is determined by its ionization efficiency. It can be seen that singly ionized NADP⁺ and NADPH are present in both positive and negative ion modes. No strong peaks are observed for the singly ionized dimer in either positive or negative ion mode, indicating that its presence is negligible, especially compared to the amounts of both NADP⁺ and NADPH. Together with the results of the LbADH assay, the FT-ICR MS data confirm conversion of NADP⁺ to NADPH. That a negligible amount dimer is formed in this direct electrochemical regeneration of the cofactor is in stark contrast from previous reports (Damian A et al. Chem. Biochem. Eng. Q. 2007, 21, 21-32; Ali I et al. Journal of Molecular Catalysis A: Chemical. 2014, 387, 86-91). The FT-ICR MS MALDI results also suggest that the remaining one-third of the product that cannot support the redox reaction as determined by the LbADH assay could be an inactive isomer (FIG. 35) that cannot be reliably parsed from the active version by FT-ICR MS MALDI.

The above results highlight the favorable cofactor regeneration outcome obtained with the unexpected morphology and properties of the oxide-derived copper-nickel (odCu-Ni) surface, produced by photoelectrochemical surface modification of the nanostructured heterolayer Ni—Cu₂O—Cu cathode. A proposed mechanism based on the results presented here is:

(odCu—Ni)+H₂O+e [symbol] (odCu—Ni)+H_{ads}+OH⁻ (1)

(odCu—Ni)+NADP⁺ [symbol] (odCu—Ni)+NADP_{ads}⁺ (2)

(odCu—Ni)+NADP_{ads}⁺+e⁻ [symbol] (odCu—Ni)+NADP_{ads}⁺ (2)

(odCu—Ni)NADP_{ads}⁺+H_{ads} [symbol] (odCu—Ni)+NADPH_{ads} (4)

(odCu—Ni)+NADPH_{ads} [symbol] (odCu—Ni)+NADPH (5)

where the subscript ads denotes a species adsorbed on the odCu-Ni surface, and the superscript * denotes an excited state. The first step (Equation 1) is simply the commonly observed Volmer-type mechanism for adsorption of H on Ni (Gong M et al. Nano Research! 2016, 9(1), 28-46)]. The steps indicated in Equation 2-Equation 4 represent hydrogenation with an adsorbed H atom, of the adsorbed NADP⁺ which is subsequently radicalized after accepting an electron from the electrode. The resulting NADPH is then desorbed back into the electrolyte (Equation 5). Alternatively, Equation 3-Equation 4 may be replaced by:

(odCu—Ni)+NADP_{ads}⁺+H_{ads} [symbol] (odCu—Ni)+NADPH_{ads}*⁺ (6)

(odCu—Ni)+NADPH_{ads}*⁺+e⁻⇄(dCu—Ni)+NADPH_{ads} (7)

after which NADPH desorbs according to Equation 5. These reaction pathways could all equally lead to formation of the 1,6-NADPH inactive isomer. The inactive dimer was not detected in the FT-ICR MS MALDI spectra. These two results together indicate that the inactive product is likely the isomer which could form adjacent to the cathode sheath where higher electric fields are expected.

CONCLUSIONS. A nanostructured Ni—Cu₂O—Cu heterolayer material was developed and photoelectrochemical regeneration of the important cofactor, NADPH, was demonstrated. Sputtering of nickel on a copper oxide electrode produced an unexpectedly desirable surface morphology leading to high product selectivity. The demonstrated properties of this cathode for direct electrochemical regeneration of NADPH are at the lowest reported overpotential (−0.75 V versus Ag/AgCl (3M NaCl) reference). Materials characterization by SEM, EDS, XPS, and XRD all confirm that sputtering of Ni on the heterolayer Cu₂O—Cu mesh cathode leads additionally to formation of CuO in the surface nanolayers. Furthermore, after photoelectrochemical surface modification, oxygen is depleted from the surface layers of the electrode to generate a Ni—Cu nanolayer. The NADPH product electrochemically regenerated from NADP⁺ using this nanostructured heterolayer cathode is found to be free of any dimers, unlike previously reported with direct electrochemical cofactor regeneration using more expensive and exotic electrode materials or even a Cu mesh electrode with the same sputtered Ni overcoat. The concomitant ability of the cathode to adsorb a hydrogen and donate an electron to NADP⁺ appears to greatly diminish the propensity of the radicalized NADP⁺ to form an inactive (NADP)₂ dimer. Despite the unexpected payoffs from the new electrode, an LbADH enzyme assay revealed the presence of another inactive product, possibly an isomer such as 1,6-NADPH that may be generated in the electrode-adjacent layers in the electrochemical H-cell. Previous work (Damian A et al. Chem. Biochem. Eng. Q. 2007, 21, 21-32), as with the present work utilized static (non-flowing media in their experiments, which can lead to accumulation of inactive products. In practice, production of the unwanted inactive isomer could be suppressed by using a flow cell rather than static or batch processes. Recent work on electrochemical regeneration of the non-phosphorylated cofactor NADH, using multiwalled carbon nanotubes grown on a stainless steel mesh and decorated with nickel nanoparticles, showed a recovery of 98% but at elevated cathode potentials of −1.168 V (vs. Ag/AgCl (3M NaCl)) (Ali I et al. The Canadian Journal of Chemical Engineering. 2018, 96(1), 68-73). A potential higher than −0.75 V used in this work with the nanostructured heterolayer Ni—Cu₂O—Cu electrode, that can produce higher yields of active NADPH may therefore exist, and should be further explored. Beyond significantly advancing cofactor regeneration, the electrode material and associated photoelectrochemical surface modification process reported here could advance processes for water-splitting for hydrogen generation, artificial photosynthesis (Zhang T. Science, 2015, 350(6262), 738), and synthesis of biofuels such as butanol via biofermentation (Agu C V et al. Journal of Industrial Microbiology & Biotechnology. 2016, 43(9), 1215-1226; Ujor V et al. Applied Microbiology and Biotechnology, 2014, 98, 6511-6521; Zhang Y et al. J. of Industrial Microbiology & Biotechnology. 2014, 41, 1505-1516).

### Methods

Spectrophotometric measurements. All spectrophotometric measurements were carried out with a Thermo Scientific Evolution 300 UV-Vis spectrophotometer using the VisionPro software. All measurements were conducted in fixed wavelength mode with an integration time of 3 s and a wavelength bandwidth of 1 nm. Samples were pipetted into 10 mm pathlength micro-quartz cuvettes (Fisher) and mixed by inversion prior to measurement. Errors were determined from the standard deviation of 30 sequential absorbance measurements on the same aliquot, for each time point.

LbADH assay to determine the turnover number. The LbADH activity assay was performed as described elsewhere (Halloum I et al. Fermentation, 2015, 1, 24-37), albeit with some modifications. All assays were carried out at 37° C. in a 30-μl total reaction. Typically, the reaction mix contained 5 mM butyraldehyde, 0.25 mM NADPH in 50 mM sodium phosphate (pH 8). The reaction was initiated by the addition of 1.5 μl of 0.29 μM recombinant ADH to 28.5 μl reaction mix. From the 30-μl reaction that was assembled, 28-μl was immediately transferred to a 384-well microplate and the absorbance at 340 nm was monitored real-time using a SpectraMax M5 (Molecular Devices) Microplate Reader (integration time of 1000 ms; settle time of 300 ms). This continuous spectrophotometric readout enabled calculation of initial velocities. Linear regression analysis of NADPH generated as a function of time was used to calculate the initial velocity (0.97≤r²≤0.99). For each assay, a control assay was performed that included all the assay components except the ADH. Using activities determined from initial velocity measurements with 5 mM butyraldehyde substrate, the k_{cat} was determined to be 214±5 min⁻¹, consistent with the value reported earlier (Halloum I et al. Fermentation, 2015, 1, 24-37).

LbADH assay for detecting electrochemically regenerated NADPH. The LbADH enzyme assay for determination of NADPH selectivity in electrochemical regeneration was performed by first collecting a to aliquot of NADP⁺ solution (1.5 mM, 325 μL) prior to running the experiment. This sample was then mixed with 13 μL 0.25 M butyraldehyde and diluted with sodium phosphate buffer solution (pH 8) to yield a final concentration of 9.3 mM butyraldehyde in a total volume of 350 μL. This butyraldehyde concentration was chosen to ensure adequate amount of substrate for complete turnover of all regenerated 1,4-NADPH. The A₃₄₀ measurement of this sample served as a reference for baseline subtraction (A_{ref}). Three-hundred and twenty-five μL of regenerated cofactor was then collected and mixed with 13 μL 0.25 M butyraldehyde substrate and its initial absorbance at 340 nm (A₀) was recorded. Twelve μL 58 μM LbADH was then added to the regenerated cofactor/butyraldehyde mixture to yield a final concentration of ˜2 μM ADH, and its absorbance at 340 nm was monitored until a steady state was reached (A_{f}). The selectivity, Q, of the sample was calculated according to Equation A1, where the constant, α, represents the factor by which the regenerated cofactor/butyraldehyde mixture is diluted upon addition of LbADH:

$$Q = 1 - \frac{( {A}_{f} - {A}_{ref} )}{α ( {A}_{0} - {A}_{ref} )} \qquad ( A1 )$$

Inclusion of the constant accounts for any decrease in absorbance upon addition of LbADH solely by virtue of dilution. To ensure applicability of Beer's Law, only regenerated cofactor samples with an initial absorbance less than 0.25 (˜70 μM NADPH) were considered (FIG. 51). Below this threshold, the absorbance-concentration behavior of 1,4-NADPH in sodium phosphate buffer was observed to be approximately linear.

### Supplementary Information

Calculation of redox potentials. The electrodeposition reaction used for depositing copper oxide on the copper mesh is given by:

2CuL₂+2OH⁻+2e⁻→Cu₂O+H₂O+4L⁻ (S1)

where L represents the lactate anion. All redox potentials at pH 8 are computed via the Nernst equation:

$$E = {E}^{0} + \frac{2.303 RT}{n F} {log}_{10} \frac{{\prod }_{o x} {c}_{o x}^{{γ}_{o x}}}{{\prod }_{r e d} {c}_{r e d}^{{γ}_{r e d}}} \qquad ( S 2 )$$

where E⁰ is the standard reduction potential of the redox couple, R is the universal gas constant, T is the temperature, n is the number of electrons involved in the half-reaction, F is Faraday's constant, cₒₓ and c_{red} are the concentrations of oxidized and reduced species, respectively, and γₒₓ and γ_{red} are the stoichiometric coefficients of oxidized and reduced species, respectively. All non-pH determining species, e.g. Cu₂O or NAP⁺, are considered to be at unit concentrations. The standard reduction potential of the Cu₂O/Cu couple was taken to be −0.360 V (Standard Hydrogen Electrode) and the formal potential (pH 7) of the NADP⁺/NADPH couple was taken to be −0.320 V (Standard Hydrogen Electrode).

Calculation of selectivity of product, Q. The selectivity, [symbol] , of cofactor regeneration products given by Equation A1 may be re-written as follows.

$$Q = \frac{α ( {A}_{0} - {A}_{r e f} ) - ( {A}_{f} - {A}_{r e f} )}{α ( {A}_{0} - {A}_{r e f} )} \qquad ( S 3 )$$

The numerator in Equation S3 is the decrease in absorbance following the butyraldehyde reduction reaction with lbADH, which is the absorbance due to 1,4-NADPH only. The denominator represents the absorbance of all cofactor regeneration products with non-negligible absorbance at 340 nm excitation, i.e. 1,4-NADPH, (NADP)₂ and isomers such as 1,6-NADPH. Invoking the Beer-Lambert Law and denoting the extinction coefficient as εε and concentrations as [·], Equation S3 takes the following form.

$$Q = \frac{{ε}_{1 , 4 - NADPH} l [ 1 , 4 - NADPH ]}{{ε}_{1 , 6 - NADPH} l [ 1 , 6 - NADPH ] + {ε}_{{( NADP )}_{2}} l [ {NADP}_{2} ] + {ε}_{1 , 4 - NADPH} l [ 1 , 4 - NADPH ]} \qquad ( S 4 )$$

Finally, if the extinction coefficients are taken to be approximately equal, the selectivity is the ratio of the concentration of enzymatically active 1,4-NADPH to the sum total of the concentrations of cofactor regeneration products.

$$Q ≅ \frac{[ 1 , 4 - NADPH ]}{[ 1 , 6 - NADPH ] + [ {NADP}_{2} ] + [ 1 , 4 - NADPH ]} \qquad ( S 5 )$$

Overexpression and purification of LbADH enzyme. Escherichia coli BL-21 (DE3) cells were transformed with pACYC-LbADH. A single bacterial colony was used to inoculate 2.5 mL of LB medium supplemented with 35 μg/ml chloramphenicol and grown overnight at 37° C. with shaking. This overnight seed culture was used to inoculate 250 mL of fresh LB medium containing the appropriate antibiotics as mentioned above. These cells were grown at 37° C. with shaking until the OD₆₀₀ reached 0.6 and were induced with 1 mM IPTG for an additional 3 h. Following IPTG induction, the cells were harvested by centrifugation and the cell pellets were stored at −80° C. until further use.

Purification of LbADH was achieved using immobilized metal-affinity chromatography (IMAC). A 250-mL cell pellet obtained after overexpression, was thawed on ice, re-suspended in 16 mL lysis buffer [95% buffer A, (50 mM Tris-HCl, pH 7.5, 150 mM NaCl, 1 mM DTT); 5% buffer B, (buffer A+500 mM imidazole)] containing 80 μl bacterial protease arrest (G Biosciences, USA) and sonicated (2 s on 5 s off, 50% amplitude). After centrifugation of the crude lysate (24,000 g, 30 min, 4° C.), the supernatant was applied to 1-mL of 50% slurry of nickel-Sepharose resin (50% slurry) (Nickel Sepharose 6 fast flow, GE Healthcare, Sweden) that had been pre-equilibrated with 5 mL equilibration buffer (95% buffer A+5% buffer B, without DTT) and mixed gently by nutating at 24° C. for 10 min. The resin was allowed to settle down and the supernatant was collected and labeled as the flow-through. The unbound proteins were removed by mixing the resin with 10 ml wash buffer [90% buffer A+10% buffer B] for 5 min and allowing the resin to settle. The supernatant was collected and labeled as the wash fraction. After washing, the ADH protein was eluted in five successive elution steps each with 0.5 ml elution buffer with increasing imidazole concentration (100 to 500 mM). At each elution step, the resin was mixed with 0.5 mL elution buffer and the clear supernatant after centrifugation was collected separately to serve as the elution fraction. The purity of each fraction was checked by SDS-PAGE analysis and fractions primarily containing ADH were pooled together. The pooled fractions were passed through a SpinX column to remove any adventitiously co-eluted Ni-Sepharose beads and the flow-through was subjected to dialysis for 16 h at 4° C. 20 mM Tris-HCl (pH 7.5), 150 mM NaCl, and 1 mM DTT. The concentration of the final protein was determined using its molar extinction coefficient (20,065 M⁻¹ cm⁻¹) at 280 nm and the final preparation in 10% glycerol was stored at −80° C. in small aliquots for subsequent biochemical enzyme assays. From a 250-mL culture, ˜13 mg of recombinant ADH was obtained.

Other advantages which are obvious and which are inherent to the invention will be evident to one skilled in the art. It will be understood that certain features and sub-combinations are of utility and may be employed without reference to other features and sub-combinations. This is contemplated by and is within the scope of the claims. Since many possible embodiments may be made of the invention without departing from the scope thereof, it is to be understood that all matter herein set forth or shown in the accompanying drawings is to be interpreted as illustrative and not in a limiting sense.

The methods of the appended claims are not limited in scope by the specific methods described herein, which are intended as illustrations of a few aspects of the claims and any methods that are functionally equivalent are intended to fall within the scope of the claims. Various modifications of the methods in addition to those shown and described herein are intended to fall within the scope of the appended claims. Further, while only certain representative method steps disclosed herein are specifically described, other combinations of the method steps also are intended to fall within the scope of the appended claims, even if not specifically recited. Thus, a combination of steps, elements, components, or constituents may be explicitly mentioned herein or less, however, other combinations of steps, elements, components, and constituents are included, even though not explicitly stated.

1-12. (canceled)

13. The nanostructured electrode of claim 20, wherein the active layer comprises metallic copper and metallic nickel.

14. (canceled)

15. (canceled)

16. The nanostructured electrode of claim 20, wherein the active layer is substantially free of copper oxide.

17. (canceled)

18. (canceled)

19. (canceled)

20. A nanostructured electrode comprising a photoelectrochemically modified product of a nanostructured precursor electrode, wherein:
the nanostructured precursor electrode comprises a copper substrate, a nanostructured copper oxide layer disposed on the copper substrate, and a nickel layer disposed on the nanostructured copper oxide layer; and
the nanostructured electrode comprises the copper substrate, the nanostructured copper oxide layer disposed on the copper substrate, and an active layer disposed on the nanostructured copper oxide layer, wherein the active layer comprises copper and nickel and is formed by photoelectrochemically modifying the precursor nanostructured electrode.

21. The nanostructured electrode of claim 20, wherein the copper substrate has an average surface area of from 1 μm² to 100 m².

22. (canceled)

23. The nanostructured electrode of claim 20, wherein the nanostructured copper oxide layer has an average thickness of from 50 nanometers (nm) to 1000 micrometers (microns, μm).

24. (canceled)

25. The nanostructured electrode of claim 20, wherein the nickel layer has an average thickness of from 1 nm to 500 nm, wherein the active layer has an average thickness of from 1 nm to 500 nm, or a combination thereof.

26. (canceled)

27. (canceled)

28. The method of claim 70, wherein making the nanostructured precursor electrode comprises depositing the nanostructured copper oxide layer on the copper mesh and subsequently depositing the nickel layer on the nanostructured copper oxide layer.

29-58. (canceled)

59. A method of making the nanostructured electrode of claim 20, the method comprising photoelectrochemically modifying the nanostructured precursor electrode.

60. The method of claim 59, wherein photoelectrochemically modifying the nanostructured precursor electrode comprises irradiating the nanostructured precursor electrode in conjunction with performing potentiostatic electrolysis on the nanostructured precursor electrode.

61. The method of claim 60, wherein irradiating comprises exposing the nanostructured precursor electrode to electromagnetic radiation, wherein the nanostructured precursor electrode has a bandgap energy and at least a portion of the electromagnetic radiation has an energy greater than or equal to the bandgap energy.

62-68. (canceled)

69. The method of claim 59, wherein the photoelectrochemical modification is performed while the nanostructured precursor substrate is submersed in a sodium phosphate buffer.

70. The method of claim 59, further comprising making the nanostructured precursor electrode.

71-74. (canceled)

75. A nanostructured electrode for the direct regeneration of NADH, NADPH, or combination thereof using photoelectrochemistry or photochemistry with a low overpotential, wherein the nanostructured electrode comprises a high surface area substrate, a nanostructured layer comprising a p-type semiconductor disposed on the high surface area substrate, and an active layer comprising a hydrogen capture material disposed on the nanostructured layer.

76. The nanostructured electrode of claim 75, wherein the high surface area substrate, the nanostructured layer, the active layer, or a combination thereof comprise an inexpensive and/or abundant material.

77. (canceled)

78. A method of use of the nanostructured electrode of claim 20, the method comprising using the nanostructured electrode to directly regenerate NADH, NADPH, or a combination thereof photochemically or photoelectrochemically.

79. (canceled)

80. The method of claim 78, wherein the method comprises applying a low overpotential to the nanostructured electrode in the presence of a solution comprising NAD(P)⁺ to electrochemically regenerate NAD(P)H.

81. (canceled)

82. (canceled)

83. (canceled)

84. The method of claim 80, wherein the method further comprises irradiating the nanostructured electrode concurrently with applying the overpotential.

85-89. (canceled)

90. The method of claim 78, wherein the method produces 1,4-NAD(P)H with a purity of 90% or more.

91. The method of claim 78, wherein the method produces a product that is substantially free of (NAD(P)H)₂, 1,6-NAD(P)H, or a combination thereof.

92. (canceled)

93. (canceled)

94. A method of making a biofuel, the method comprising synthesizing the biofuel via biofermentation of a biomass concurrently with regeneration of NAD(P)H, wherein the NAD(P)H is regenerated using the method of claim 78.

95-98. (canceled)
